(19) United States
(12) Patent Application Publication
(10) Pub. No.: US 2025/0232634 A1
(43) Pub. Date: Jul. 17, 2025

(54) NON-TRANSITORY COMPUTER READABLE MEDIUM, INFORMATION PROCESSING METHOD, AND GAME APPARATUS

(71) Applicant: CYGAMES, INC., Tokyo (JP)

(72) Inventors: Satoru Okada, Tokyo (JP); Masayuki Nagata, Tokyo (JP); Kohei Momiyama, Tokyo (JP); Masaya Nakajima, Tokyo (JP); Naoki Nishikawa, Tokyo (JP)

(73) Assignee: CYGAMES, INC., Tokyo (JP)

(21) Appl. No.: 19/096,230

(22) Filed: Mar. 31, 2025

Related U.S. Application Data
(63) Continuation of application No. PCT/JP2023/036842, filed on Oct. 11, 2023.

(30) Foreign Application Priority Data
Oct. 14, 2022 (JP) 2022-165806

(51) Int. Cl. G07F 17/32

(52) U.S. Cl. CPC G07F 17/3211; G07F 17/3244

(57) ABSTRACT

A non-transitory computer readable medium stores a program causing a computer to execute: processing of executing a piece of specific content with a satisfied start condition from among a plurality of pieces of specific content with a set elapsed time as an end condition for clearing a game without requiring an operation by a player for game progress and activation of the game; processing of granting the player a reward predetermined for each of the pieces of specific content based on satisfying the end condition of the piece of specific content; and processing of displaying a specific screen that enables identification of a type of the piece of specific content in which a predetermined reward can be obtained by the player as the reward and that enables identification of at least one of the start condition or the end condition set for the type of the piece of specific content.

### CROSS REFERENCE TO RELATED APPLICATIONS

This application is a continuation application of International Application No. PCT/JP2023/036842, filed on Oct. 11, 2023, which claims priority to Japanese Patent Application No. 2022-165806, filed on Oct. 14, 2022, the entire contents of which are incorporated by reference herein.

### BACKGROUND ART

### Technical Field

The present invention relates to an information processing program, an information processing method, and a game apparatus.

As described in Patent Document 1, for example, a game of the genre referred to as idle game has been proposed. In idle games, after a player issues an instruction to execute the game, the game automatically progresses, and when a predetermined period elapses, the user is notified of a result of the automatic progress.

### CITATION LIST

### Patent Literature

Patent Document 1: JP 6748838

### SUMMARY OF INVENTION

### Technical Problem

In general, a decrease in user-friendliness for players involved in the game may problematically deter the players to play the game.

An object of the present invention is to provide an information processing program, and information processing method, and a game apparatus that can motivate a player to play the game by improving player-friendliness.

### Solution to Problem

To solve the problem described above, an information processing program causes a computer to execute:
processing of executing a piece of specific content with a satisfied start condition from among a plurality of the pieces of specific content with a set elapsed time as an end condition for clearing a game without requiring an operation by a player for game progress and activation of the game;
processing of granting the player a reward predetermined for each of the pieces of specific content based on satisfying the end condition of the piece of specific content; and
processing of displaying a specific screen that enables identification of a type of the piece of specific content in which a predetermined reward can be obtained by the player as the reward and that enables identification of at least one of the start condition or the end condition set for the type of the piece of specific content.

The computer may be further caused to execute:
processing of allowing a start of execution of the piece of specific content based on an operation of a first operation portion by the player on a start screen displaying the first operation portion for starting execution of the piece of specific content;
processing of displaying a second operation portion for starting execution of the piece of specific content on the specific screen; and
processing of allowing a start of execution of the piece of specific content without displaying the start screen, based on an operation of the second operation portion by the player.

To solve the problem described above, an information processing method executed by one or more computers includes:
processing, by the one or more computers, of executing a piece of specific content with a satisfied start condition from among a plurality of the pieces of specific content with a set elapsed time as an end condition for clearing a game without requiring an operation by a player for game progress and activation of the game;
processing, by the one or more computers, of granting the player a reward predetermined for each of the pieces of specific content based on satisfying the end condition of the piece of specific content; and
processing, by the one or more computers, of displaying a specific screen that enables identification of a type of the piece of specific content in which a predetermined reward can be obtained by the player as the reward and that enables identification of at least one of the start condition or the end condition set for the type of the piece of specific content.

To solve the problem described above, a game apparatus including one or more computers executes:
processing, by the one or more computers, of executing a piece of specific content with a satisfied start condition from among a plurality of the pieces of specific content with a set elapsed time as an end condition for clearing a game without requiring an operation by a player for game progress and activation of the game;
processing, by the one or more computers, of granting the player a reward predetermined for each of the pieces of specific content based on satisfying the end condition of the piece of specific content; and
processing, by the one or more computers, of displaying a specific screen that enables identification of a type of the piece of specific content in which a predetermined reward can be obtained by the player as the reward and that enables identification of at least one of the start condition or the end condition set for the type of the piece of specific content.

### Effects of Disclosure

According to the present invention, players can be motivated to play the game.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an ally character confirmation screen.

FIG. 4A is a diagram for describing an example of a story screen. FIG. 4B is a diagram for describing an example of a quest screen.

FIG. 5A is a diagram for describing an example of a main quest screen. FIG. 5B is a diagram for describing an example of a main quest selection screen. FIG. 5C is a diagram for describing an example of a party selection screen.

FIG. 6A is a diagram for describing an example of a battle game screen. FIG. 6B is a diagram for describing an example of a first result screen. FIG. 6C is a diagram for describing an example of a second result screen.

FIG. 7A is a diagram for describing an example of an expedition top screen. FIG. 7B is a diagram for describing an example of a dispatch destination selection screen.

FIG. 8A is a diagram for describing an example of a menu screen. FIG. 8B is a first diagram for describing an example of a notification setting screen. FIG. 8C is a second diagram for describing an example of the notification setting screen.

FIG. 9A is a diagram for describing an example of an expedition completion notification. FIG. 9B is a first diagram for describing an example of a priority setting screen. FIG. 9C is a second diagram for describing an example of the priority setting screen.

FIG. 10A is a first diagram for describing an example of a first change priority screen. FIG. 10B is a first diagram for describing an example of a second change priority screen.

FIG. 11A is a second diagram for describing an example of the second change priority screen. FIG. 11B is a second diagram for describing an example of the first change priority screen.

FIG. 12A is a first diagram for describing an example of an automatic formation setting screen. FIG. 12B is a second diagram for describing an example of the automatic formation setting screen.

FIG. 13A is a first diagram for describing an example of a formation screen. FIG. 13B is a second diagram for describing an example of the formation screen. FIG. 13C is a third diagram for describing an example of the formation screen.

FIG. 14A is a diagram for describing an example of the formation screen when a first automatic formation function is used. FIG. 14B is a diagram for describing an example of the formation screen when a second automatic formation function is used.

FIG. 15A is a fourth diagram for describing an example of the formation screen. FIG. 15B is a first diagram for describing an example of a time reduction screen. FIG. 15C is a fifth diagram for describing an example of the formation screen.

FIG. 16A is a diagram for describing an example of a confirmation screen. FIG. 16B is a diagram for describing an example of an expedition start animation screen. FIG. 16C is a first diagram for describing an example of a time reduction animation screen.

FIG. 17A is a diagram for describing an example of the dispatch destination selection screen during execution of an expedition game. FIG. 17B is a diagram for describing an example of the time reduction screen during execution of the expedition game.

FIG. 18A is a diagram for describing an example of a confirmation screen for a player to confirm use of a reduction function during execution of the expedition game.

FIG. 18B is a diagram for describing an example of the dispatch destination selection screen in a case where the reduction function is used during execution of the expedition game.

FIG. 19A is a diagram for describing an example of a withdraw confirmation screen. FIG. 19B is a diagram for describing an example of an expedition withdraw screen.

FIG. 20A is a diagram for describing an example of the dispatch destination selection screen when an expedition is completed. FIG. 20B is a diagram for describing an example of an expedition completion screen.

FIG. 21 is a diagram for describing an example of a redispatch screen.

FIG. 22A is a diagram for describing an example of the expedition top screen when an expedition is completed. FIG. 22B is a diagram for describing an example of an expedition collective completion screen.

FIG. 23 is a diagram for describing an example of a redispatch screen.

FIG. 24A is a first diagram for describing an example of a batch expedition screen. FIG. 24B is a second diagram for describing an example of the batch expedition screen.

FIG. 25 is a diagram for describing an example of a batch expedition confirmation screen.

FIG. 26A is a diagram for describing an example of an in-expedition party list screen. FIG. 26B is a diagram for describing an example of an add round completion screen.

FIG. 27A is a first diagram illustrating an example of an ally character details screen. FIG. 27B is a second diagram illustrating an example of an ally character details screen.

FIG. 28 is a diagram for describing categories of EX equipment.

FIG. 29A is a diagram illustrating an example of an auto-equip EX equipment settings screen. FIG. 29B is a diagram illustrating an example of a priority stats screen.

FIG. 30A is a diagram illustrating an example of an auto-equip EX equipment confirmation screen. FIG. 30B is a diagram illustrating an example of a switch EX equipment details screen.

FIG. 31A is a diagram illustrating an example of a change EX equipment screen. FIG. 31B is a diagram illustrating an example of a reset EX equipment confirmation screen. FIG. 31C is a diagram illustrating an example of a switch EX equipment confirmation screen.

FIG. 32A is a diagram illustrating an example of an EX equipment limit break screen. FIG. 32B is a diagram for describing enhancing and limit breaking of EX equipment. FIG. 32C is a diagram illustrating an example of an item details screen.

FIG. 33A is a diagram illustrating an example of an EX equipment limit break confirmation screen. FIG. 33B is a diagram illustrating an example of an enhance equipment item return screen.

FIG. 34A is a diagram illustrating an example of an enhance EX equipment screen. FIG. 34B is a diagram illustrating an example of a use enhancement points settings screen. FIG. 34C is a diagram illustrating an example of an enhance EX equipment confirmation screen.

FIG. 35 is a diagram illustrating an example of an auto-enhance settings screen.

FIG. 36A is a first diagram illustrating an example of an item list screen. FIG. 36B is a second diagram illustrating an example of an item list screen.

FIG. 37A is a diagram illustrating an example of a disassemble confirmation screen. FIG. 37B is a diagram illustrating an example of a disassembly results screen.

FIG. 38 is a diagram illustrating an example of an auto-disassemble settings screen.

FIG. 39A is a diagram illustrating an example of an acquisition location screen. FIG. 39B is a diagram illustrating an example of a launch expedition screen. FIG. 39C is a diagram illustrating an example of an expedition results screen. FIG. 39D is a diagram illustrating an example of an expedition confirmation screen.

FIG. 40 is a diagram illustrating an example of an automatic disassembly settings screen.

FIG. 41 is a diagram for describing a configuration of a memory in the player terminal and a function thereof as a computer.

FIG. 42 is a diagram for describing a configuration of a memory in the server and a function thereof as a computer.

FIG. 43 is a flowchart for describing EX equipment management processing in the player terminal.

FIG. 44 is a flowchart for describing EX equipment acquisition location processing in the player terminal.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In the present description and the drawings, elements having substantially the same function and configuration are denoted by the same reference numerals, and redundant description thereof will be omitted, and elements not directly relating to the present invention will not be illustrated.

### Overall Configuration of Information Processing System S

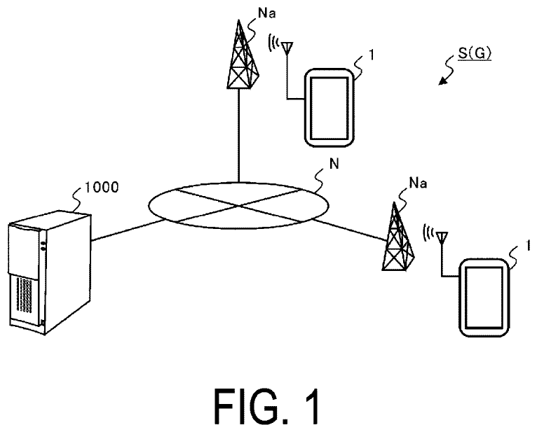

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of a game, and the game can progress via cooperation between the player terminal 1 and the server 1000.

The player terminal 1 can establish communication with the server 1000 via the communication network N. The player terminal 1 includes various electronic devices capable of establishing a wireless or wired communication connection with the server 1000. Examples of the player terminal 1 include a smartphone, a mobile phone, a tablet device, a personal computer, and a game console, and the like. In the present embodiment, a case where a smartphone is used as the player terminal 1 will be described.

The server 1000 is communicatively connected to a plurality of the player terminals 1. The server 1000 accumulates various types of information for each player who plays the game. In addition, the server 1000 performs processing such as updating the accumulated information and downloading images and various types of information to the player terminal 1 based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and realizes a wireless or wired communication connection between the player terminal 1 and the server 1000.

### Hardware Configuration of Player Terminal 1 and Server 1000

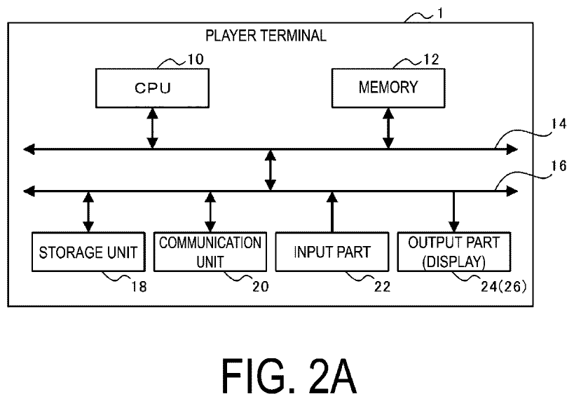

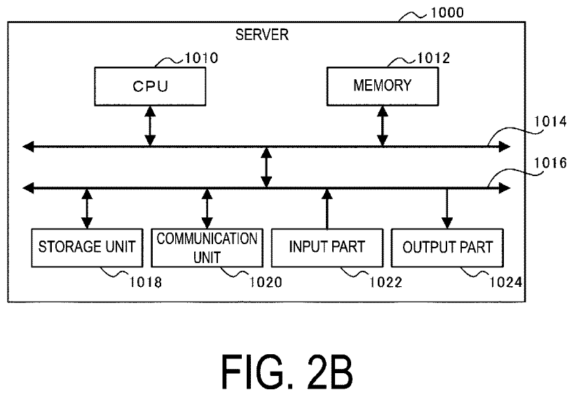

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various types of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various types of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various types of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects speech from the player. That is, the input part 22 widely includes apparatuses capable of input that can identify the intention of the player.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Game Content

Next, content of a game provided by the information processing system S (game apparatus G) of the present embodiment will be described using an example. In the present embodiment, a so-called battle game is provided in which one or more ally characters form a party and fight against an enemy character. Further, in the present embodiment, separate from the battle game described above, a game of the genre referred to as an idle game is provided in which one or more ally characters in a party are dispatched (in the present embodiment, referred to as an “expedition game”). In the game of the present embodiment, a plurality of ally characters are provided from the management side of the game to the player. For example, the player can own a plurality of ally characters obtained through a lottery called a gacha or distributed from the management side.

In the battle game, the player can select one or more ally characters owned by the player to form a party. The player can play the battle game using the formed party. The object of the battle game is for the ally characters in the party to obtain rewards by defeating (clearing) enemy characters. Various types of battle games with different enemy characters and different difficulty levels can be played by the player.

In addition, in the expedition game, the player can select one or more ally characters owned by the player to form a party. The player can play the expedition game using the formed party. In the expedition game, an “expedition” is performed in which ally characters formed into a party are dispatched for a preset required time. When the required time has elapsed, the expedition game is completed (cleared), and the player can obtain a reward. In other words, in order to start the expedition game, it is necessary for the player to perform a player operation and activate the game. However, the started expedition game (specific content) does not require a player operation for game progress and activation of the game and has a game property in which the game progresses as time elapses.

The purpose of the expedition game is to obtain a reward by dispatching the ally characters formed into a party for a predetermined required time. As will be described in detail below, in the present embodiment, for example, a plurality of types of expedition games can be played. The difficulty level based on the required time, power of the party, and similar conditions vary depending on the type of the expedition game.

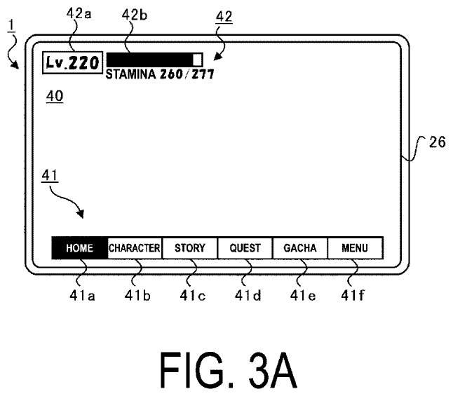

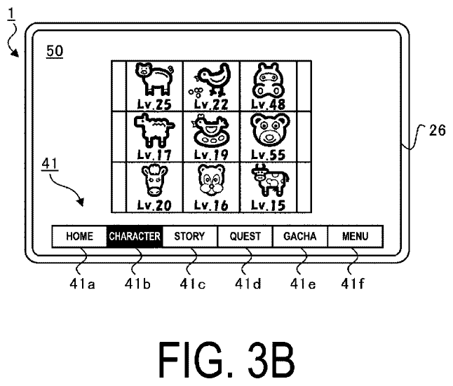

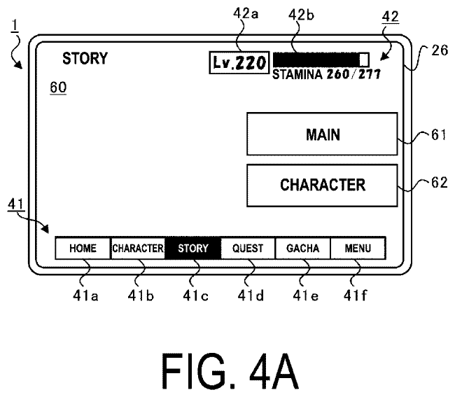

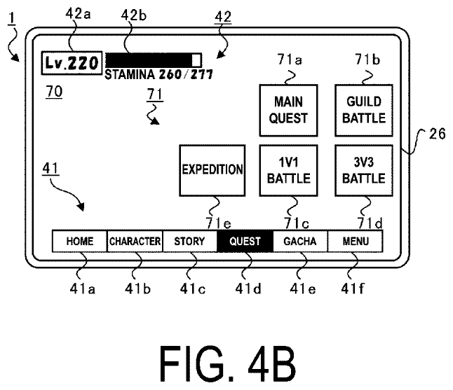

FIG. 3A is a diagram illustrating an example of a home screen 40. FIG. 3B is a diagram illustrating an example of an ally character confirmation screen 50. FIG. 4A is a diagram illustrating an example of a story screen 60. FIG. 4B is a diagram illustrating an example of a quest screen 70.

The home screen 40 illustrated in FIG. 3A is a screen that is first displayed after the player performs a tap operation on the display 26 on a title screen (not illustrated) (that is, after the game is started). As illustrated in FIG. 3A, on the home screen 40, a menu bar 41 is displayed at a lower portion of the display 26. The menu bar 41 is displayed at the lower portion of the display 26 on normal screens other than the title screen (not illustrated).

The menu bar 41 is provided with a plurality of operation portions that can be operated (tapped) by the player. The menu bar 41 is provided with a home screen selection operation portion 41a denoted by “HOME”, an ally character confirmation screen selection operation portion 41b denoted by “CHARACTERS”, a story screen selection operation portion 41c denoted by “STORY”, a quest screen selection operation portion 41d denoted by “QUEST”, a gacha screen selection operation portion 41e denoted by “GACHA”, and a menu screen selection operation portion 41f denoted by “MENU”. In the menu bar 41, the operation portion corresponding to the screen being displayed is highlighted so that each screen on the display 26 can be identified.

When the home screen selection operation portion 41a is tapped, the home screen 40 illustrated in FIG. 3A is displayed on the display 26. When the ally character confirmation screen selection operation portion 41b is tapped, the ally character confirmation screen 50 illustrated in FIG. 3B is displayed on the display 26. When the story screen selection operation portion 41c is tapped, the story screen 60 illustrated in FIG. 4A is displayed on the display 26. When the quest screen selection operation portion 41d is tapped, the quest screen 70 illustrated in FIG. 4C is displayed on the display 26.

When the gacha screen selection operation portion 41e is tapped, a gacha screen (not illustrated) is displayed on the display 26. When the menu screen selection operation portion 41f is tapped, a menu screen (not illustrated) is displayed on the display 26. Although detailed description is omitted, on the gacha screen, it is possible to perform a gacha lottery in which an ally character can be obtained through a lottery. On the menu screen, game settings and various types of information can be checked.

A header display area 42 is provided in an upper portion of the home screen 40. At least a part of player information associated with a player ID is displayed in the header display area 42. For example, level information 42a indicating the player level and a stamina display bar 42b indicating the stamina of the player are displayed in the header display area 42. Further, as illustrated in FIG. 3A, the stamina of the player is displayed by a numerical value at a lower portion of the stamina display bar 42b.

The player information includes a player ID, ally character identification information (hereinafter referred to as an ally character ID) for identifying an ally character owned by the player, the level information 42a, stamina information displayed on the stamina display bar 42b, story progress information to be described below, battle game clear information, in-game currency information indicating the amount of in-game currency owned by the player, item information indicating the type and the number of items owned by the player, expedition game information indicating the progress status of the expedition game, and expedition game setting information indicating various types of play information set for each expedition game and the various types of items that can be obtained.

The stamina is a parameter necessary for the player to play the battle game. In the present embodiment, a plurality of types of battle games are provided, and a stamina consumption value required to play, a maximum number of play times per day, and the like are set for each battle game. When a battle game in which the stamina consumption value necessary for play is set is played, a player consumes stamina to play the battle game. Thus, when the stamina is insufficient, the player cannot play the battle game.

Although detailed description is omitted, when the player wins in the battle game, the player can obtain a predetermined value as player experience. Each time the player experience reaches a certain value, the player level increases. For player levels, an upper limit value for stamina is set. As the player level increases, the upper limit value for stamina increases. Stamina is recovered by a predetermined value (for example, one point) at regular time intervals (for example, five minutes) within the range of the upper limit value. In the stamina display bar 42b, the current remaining amount of stamina is displayed so as to be visually recognizable with respect to the upper limit value of stamina. The numerical value of stamina displayed at the lower portion of the stamina display bar 42b is “260/277” in the example of FIG. 3A, where “277” is the upper limit value of stamina displayed as the denominator, and “260” is the current stamina of the player displayed as the numerator.

However, in the present embodiment, the player can play the expedition game without consuming stamina. That is, for example, even when stamina is exhausted by playing the battle game, it is possible to execute the expedition game. However, it may be necessary to consume stamina in order to play the expedition game.

When the ally character confirmation screen selection operation portion 41b of the menu bar 41 is tapped, the ally character confirmation screen 50 illustrated in FIG. 3B is displayed on the display 26. On the ally character confirmation screen 50, all images of the ally characters corresponding to the ally character IDs associated with the player ID are displayed.

In other words, all the ally characters possessed by the player are displayed on the ally character confirmation screen 50. Note that a different ally character ID is assigned to each ally character. When the player obtains a new ally character via, for example, a gacha lottery or the like, the ally character ID of the obtained ally character is associated with the player ID of the player.

Stars (rank), experience, and level are stored in association with the ally character. The experience increases when a player wins in a battle game described below or when a predetermined item is used. The level is set corresponding to the experience, and the level increases each time the experience reaches a predetermined value. An upper limit value of the level is set for each ally character, and the level increases only within a range up to the upper limit value.

In addition, base values of the power of the ally character such as life points, attack power, and defense power are set for the ally character based on the stars (rank) and the level. The player can advantageously progress through the battle game as the power of the ally character increases. Each base value set for the ally character increases as the stars (rank) increase and as the level increases.

On the ally character confirmation screen 50, it is possible to equip (set) the ally character with equipment such as weapons, armor, accessories, and the like. An additional value for attack power, defense power, and/or the like is set for each piece of equipment. When the equipment is equipped, the additional value of each piece of equipment is added to the base values, and the power of the ally character can be enhanced. The information relating to equipment such as weapons, armor, accessories, and the like is also associated with the ally character ID and is configured as a part of the player information.

In the present embodiment, the equipment is roughly classified into normal equipment and EX equipment. Normal equipment can be obtained as a reward when completing a battle game or an expedition game to be described below. EX equipment can be obtained as a reward when completing an expedition game to be described below. In the present embodiment, it is not possible to obtain EX equipment as a reward when completing a battle game described below. In other words, it can be said that the EX equipment is equipment that is difficult to obtain and has a higher rarity compared to normal equipment.

In addition, in the present embodiment, the additional value set for the EX equipment is set to be relatively larger than the additional value set for the normal equipment. In other words, it can be said that the EX equipment is equipment relatively advantageous to the player as compared to the normal equipment.

As described above, in the present embodiment, the EX equipment has a higher difficulty level for obtaining than the normal equipment and is relatively advantageous to the player. Accordingly, the player is motivated to play an expedition game in which a piece of EX equipment, for advantageously progressing through the battle games, can be obtained.

The player may be able to obtain normal equipment or EX equipment as a reward distributed from the management side or from various events. Further, the player may be able to obtain normal equipment and EX equipment though a lottery called a gacha. In this case, the probability of winning a piece of EX equipment in the predetermined gacha may be set to be lower than the probability of winning a piece of normal equipment in the predetermined gacha. EX equipment will be described in detail below.

In the present embodiment, a special item for increasing the number of stars (rank) of the ally character is provided. On the ally character confirmation screen 50, the player can increase the number of stars (rank) of the ally character by consuming the special item for the ally character whose number of stars (rank) is to be increased. The player can obtain a special item as a reward when completing a battle game or an expedition game to be described below.

When the story screen selection operation portion 41c of the menu bar 41 is tapped, the story screen 60 illustrated in FIG. 4A is displayed on the display 26. As illustrated in FIG. 4A, the menu bar 41, the header display area 42, a main story selection operation portion 61, and a character story selection operation portion 62 are displayed in the story screen 60.

When the main story selection operation portion 61 in the story screen 60 is tapped, a main story screen (not illustrated) is displayed on the display 26. On the main story screen, a plurality of main stories unlock in accordance with the degree of progress of a “main quest” described below are displayed. When a new main story is unlocked as a result of the player proceeding with the main quest described below, the player can view the unlocked main story from a main story screen (not illustrated).

When the character story selection operation portion 62 in the story screen 60 illustrated in FIG. 4A is operated, a character story (not illustrated) unlocked in accordance with the friendship level of the ally character is displayed on the display 26.

Note that the friendship level of the ally character increases when the ally character wins a battle game described below or when a predetermined item is used. Each time the friendship level reaches a predetermined value, the friendship level rank increases. Note that an upper limit value of the friendship level rank is set for the ally character, and the rank increases only in a range up to the upper limit value. When the friendship level of the ally character increases to the upper limit value, all the character stories for the ally character are unlocked. When a new character story is unlocked, the player can view the unlocked character story from a character story screen (not illustrated).

Returning to FIG. 3A, when the quest screen selection operation portion 41d of the menu bar 41 is tapped, the quest screen 70 illustrated in FIG. 4B is displayed on the display 26. On the quest screen 70, the menu bar 41, the header display area 42, and a plurality of game type selection operation portions 71 displaying the game types provided are displayed. Here, five types of games are provided, and five game type selection operation portions 71 are displayed.

The game type selection operation portion 71 includes a main quest selection operation portion 71a denoted by “MAIN QUEST”, a guild battle selection operation portion 71b denoted by “GUILD BATTLE”, a 1V1 battle selection operation portion 71c denoted by “1V1 BATTLE”, a 3V3 battle selection operation portion 71d denoted by “3V3 BATTLE, and an expedition selection operation portion 71e denoted by “EXPEDITION”.

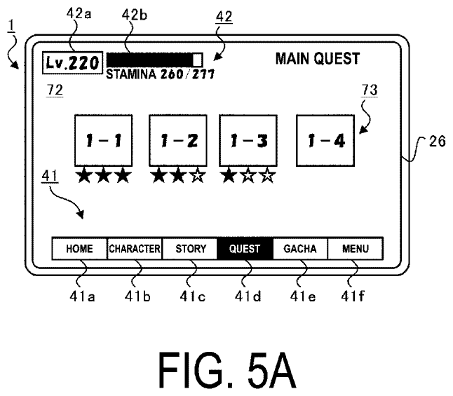

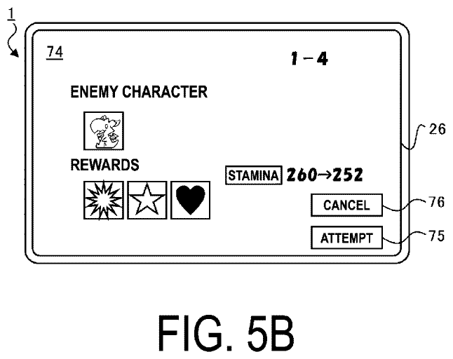

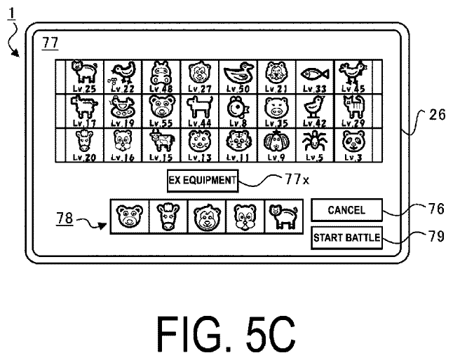

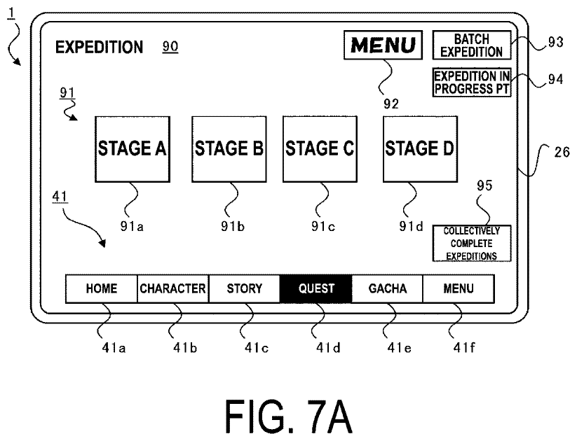

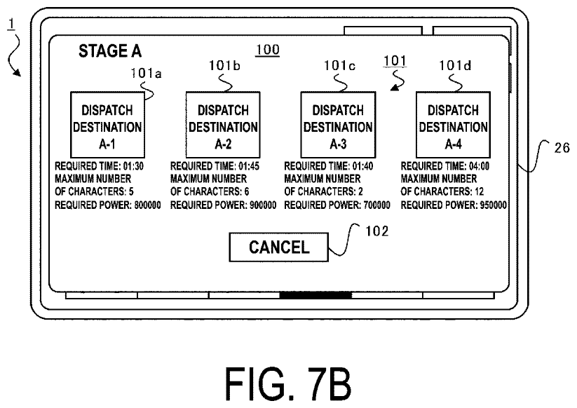

When the main quest selection operation portion 71a is tapped, a main quest screen 72 (FIG. 5A) to be described below is displayed on the display 26. When the guild battle selection operation portion 71b is tapped, a guild battle screen (not illustrated) is displayed on the display 26. Similarly, when the 1V1 battle selection operation portion 71c is tapped, a 1V1 battle screen (not illustrated) is displayed on the display 26. When the 3V3 battle selection operation portion 71d is tapped, a 3V3 battle screen (not illustrated) is displayed on the display 26. In addition, when the expedition selection operation portion 71e is tapped, an expedition top screen 90 (FIG. 7A) described below is displayed on the display 26.

Depending on the game type, an unlock condition may be set. Examples of unlock conditions include the player level being equal to or greater than a predetermined value, another predetermined game being completed, and the like. In addition, each game type includes a plurality of games (stages or rounds). An unlock condition is set for each of these games. When the unlock condition is satisfied, game unlock information included in the player information is updated.

In the player terminal 1, it is determined whether the game is unlocked based on the game unlock information, and only the game type selection operation portion 71 of the game satisfying the unlock condition may receive a player operation. Thus, the player can play only games satisfying the unlock condition.

When the main quest selection operation portion 71a in the quest screen 70 illustrated in FIG. 4B is tapped, the main quest screen 72 illustrated in FIG. 5A is displayed on the display 26.

FIG. 5A is a diagram for describing an example of the main quest screen 72. FIG. 5B is a diagram for describing an example of a main quest selection screen 74. FIG. 5C is a diagram for describing an example of a party selection screen 77.

On the main quest screen 72, the menu bar 41, the header display area 42, and a main quest operation portion 73 for selecting a plurality of battle games (stages) belonging to the main quest are displayed.

Clear information of each battle game is also displayed in the main quest operation portion 73. The clear information is indicated using three stars, for example. In a battle game belonging to the main quest, when the battle game is completed, stars are obtained in accordance with the number of ally characters whose life points are 0 when the battle game is completed. For example, three stars are obtained when there is no ally character whose life points are 0, two stars are obtained when there is one ally character whose life points are 0, and one star is obtained when there are two or more ally characters whose life points are 0.

In the example of FIG. 5A, three stars have been obtained in the battle game “1-1”, two stars have been obtained in the battle game “1-2”, and one star has been obtained in the battle game “1-3”. In addition, for the battle game “1-4”, no stars have been obtained, notifying that the battle game has not been completed.

In the main quest, completion of the previous battle game is set as a unlock condition. For example, in the example of FIG. 5A, the battle game “1-3” is completed, unlocking the battle game “1-4”, but the subsequent battle games (“1-5” and subsequent battle games (not illustrated)) are not unlocked.

In the main quest screen 72, for example, when the main quest operation portion 73 of the battle game “1-4” is operated, the main quest selection screen 74 illustrated in FIG. 5B is displayed on the display 26. On the main quest selection screen 74, an enemy character appearing in the battle game and an item (reward) obtainable in the battle game are displayed.

In addition, on the main quest selection screen 74, stamina after consumption in a case where stamina is consumed to attempt the battle game is displayed. Here, a change in the current stamina from 260 to 252 after consumption is displayed.

In addition, on the main quest selection screen 74, an attempt operation portion 75 denoted by “Attempt” for attempting the battle game and a cancel operation portion 76 denoted by “Cancel” for canceling the processing corresponding to the currently displayed screen are displayed.

When the cancel operation portion 76 is operated, the main quest screen 72 illustrated in FIG. 5A is displayed on the display 26 and the attempt of the selected battle game “1-4” is canceled.

On the other hand, when the attempt operation portion 75 is operated, the party selection screen 77 illustrated in FIG. 5C is displayed on the display 26. All ally characters possessed by the player are displayed in the party selection screen 77. Below that, on the party selection screen 77, a selected ally character display area 78 for displaying the selected ally character is displayed.

In addition, on the party selection screen 77, an EX equipment operation portion 77x denoted by “EX EQUIPMENT”, the cancel operation portion 76, and a battle start operation portion 79 denoted by “START BATTLE” are displayed.

When the player operates the displayed ally character on the party selection screen 77, the operated ally character is displayed in the selected ally character display area 78. That is, here, an ally character ID to be used in the battle game (to determine a party) is selected from among a plurality of ally character IDs associated with the player ID. When the player selects a plurality of ally characters, a party is formed. In the party formation, the same ally character cannot be set more than once.

When the player taps the EX equipment operation portion 77x on the party selection screen 77, the player can set the EX equipment to be equipped for each of all the ally characters displayed in the selected ally character display area 78 using an automatic equip function described below. However, it may be possible to set the EX equipment of each ally character by using a manual equip function.

When the EX equipment is set, the party formation is completed, and the battle start operation portion 79 is operated, the battle game is started and a battle game screen 80 is displayed on the display 26. It is not essential to equip the ally character with EX equipment, and the player can start (execute) the battle game without equipping the ally characters with EX equipment.

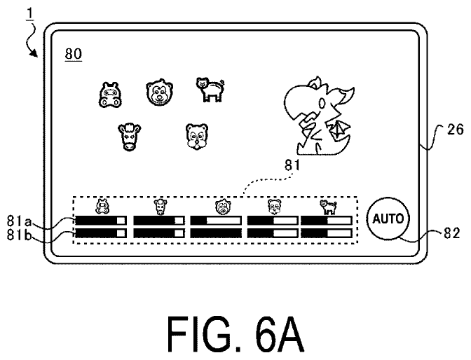

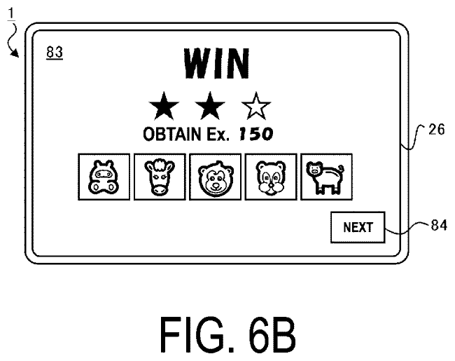

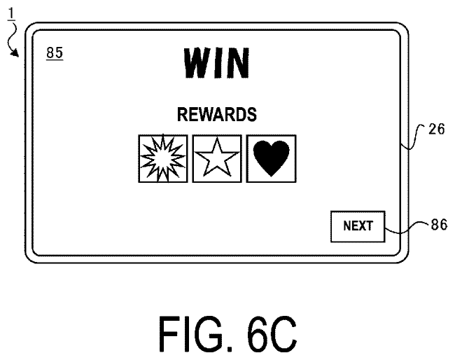

FIG. 6A is a diagram for describing an example of the battle game screen 80. FIG. 6B is a diagram for describing an example of a first result screen 83. FIG. 6C is a diagram for describing an example of a second result screen 85. During the battle game, as illustrated in FIG. 6A, the battle game screen 80 is displayed. In the battle game screen 80, the ally character and the enemy character are displayed on the display 26. The ally characters are operated under computer control to damage the enemy character and receive damage from the enemy character. The enemy character operates under computer control to damage the ally characters or receive damage from the ally characters.

When damage points are given to the enemy character, the damage points are subtracted from the life points of the enemy character. Similarly, when damage points are given to the ally character, the damage points are subtracted from the life points of the ally character. When the life points of all the enemy characters become 0, the player wins (clears), and when the life points of all the ally characters become 0 (loses), the player loses.

Here, at a lower portion of the battle game screen 80, as illustrated in FIG. 6A, an ally character display area 81 is provided. In the ally character display area 81, life points 81a and a special skill gauge 81b for each ally character are displayed. The special skill gauge 81b rises when the ally character receives damage from the enemy character and when the ally character causes damage to the enemy character. When the special skill gauge 81b reaches a predetermined maximum value, the ally character can use the special skill. With the special skill, the damage points given to the enemy character are larger than that of a normal attack, life points of the ally character are recovered, or a special effect is given to the enemy character.

Here, two patterns are provided for a method of using the special skill. One is a method in which the player operates the ally character displayed in the ally character display area 81 with the special skill gauge 81b at the maximum value. The other is a method in which the ally character uses the special skill under computer control when the special skill gauge 81b reaches the maximum value in an automatic activation state. An automatic selection operation portion 82 is displayed on the battle game screen 80, and the player can switch between the automatic activation state and a manual activation state by operating the automatic selection operation portion 82. When the automatic selection operation portion 82 is operated in the manual activation state, the automatic activation state in which the special skill is automatically used is set. In addition, when the automatic selection operation portion 82 is operated in the automatic activation state, the manual activation state in which the special skill is manually used is set. Even in the automatic activation state, when the player operates the ally character in a state where the special skill gauge 81b has reached the maximum value and the special skill has not been used by computer control, the special skill can be used.

When the battle game ends normally (normal end), the first result screen 83 is displayed on the display 26 as illustrated in FIG. 6B. As an example, FIG. 6B illustrates the first result screen 83 when the ally characters win.

At least a portion of game result information of the battle game is displayed on the first result screen 83. Further, on the first result screen 83, a next operation portion 84 denoted by “Next” is displayed.

When the next operation portion 84 is operated, the second result screen 85 illustrated in FIG. 6C is displayed on the display 26.

At least a portion of the game result information of the battle game is displayed on the second result screen 85. In addition, on the second result screen 85, a next operation portion 86 denoted by “Next” is displayed. When the next operation portion 86 is operated, the display of the display 26 is switched from the battle screen to the normal screen. That is, the first result screen 83 and the second result screen 85 are a part of the battle screen. In the present embodiment, when the next operation portion 86 is operated, the main quest screen 72 illustrated in FIG. 5A is displayed on the display 26.

The game result information includes an ally character ID (party) of the ally character, an enemy character ID of the enemy character, remaining status information of the ally characters and the enemy character at the end of the battle (whether the life points are 0 at the end of the battle game), damage points dealt (total value), player operation information (manual activation state or automatic activation state), a battle log ID, battle game type information (main quest, guild battle, or the like), information associated with each type of battle game (clear information, battle game stage, and the like), the given item information, and the like.

When the battle game is in the automatic activation state from the start to the end of the battle game and the player does not manually use the special skill, the battle game is in the automatic activation state. Otherwise, the battle game is in the manual activation state. Further, the battle log ID is uniquely assigned to each battle game. The information associated with each type of the battle game has different content for each type of the battle game.

Next, an expedition game according to the present embodiment will be described. The expedition game according to the present embodiment has the following game properties. First, the player selects at least one dispatch destination from among any dispatch destination set in advance. Further, the player selects one or more ally characters from among the ally characters owned by the player to form a party. Then, the player dispatches the formed party to the selected dispatch destination. Then, when the required time set for each dispatch destination elapses, the expedition game is completed, and the player can obtain a reward.

As described above, when the player operates the expedition selection operation portion 71e of the quest screen 70 (FIG. 4B), the expedition top screen 90 (FIG. 7A) is displayed on the display 26. FIG. 7A is a diagram for describing an example of the expedition top screen 90. In the present embodiment, the expedition game is provided with a plurality of stages to which a plurality of dispatch destinations belong. Specifically, the plurality of stages include four stages, “Stage A”, “Stage B”, “Stage C”, and “Stage D”. However, the number of stages is not limited thereto.

As illustrated in FIG. 7A, a plurality of expedition stage selection operation portions 91 corresponding to the plurality of stages are displayed at a central portion of the expedition top screen 90. Specifically, as illustrated in FIG. 7A, four operation portions are displayed: a first expedition stage selection operation portion 91a denoted by “Stage A”, a second expedition stage selection operation portion 91b denoted by “Stage B”, a third expedition stage selection operation portion 91c denoted by “Stage C”, and a fourth expedition stage selection operation portion 91d denoted by “Stage D”.

When the player operates any one of the first expedition stage selection operation portion 91a to the fourth expedition stage selection operation portion 91d, a corresponding dispatch destination selection screen 100 (FIG. 7B) described below is displayed on the display 26.

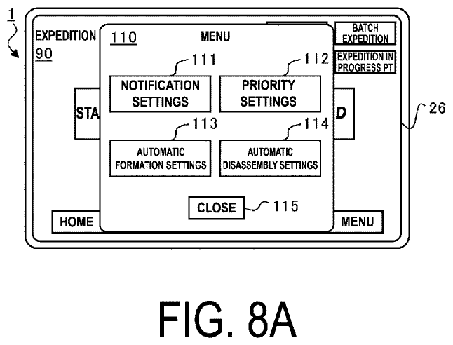

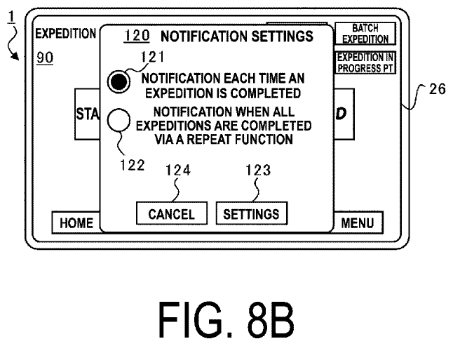

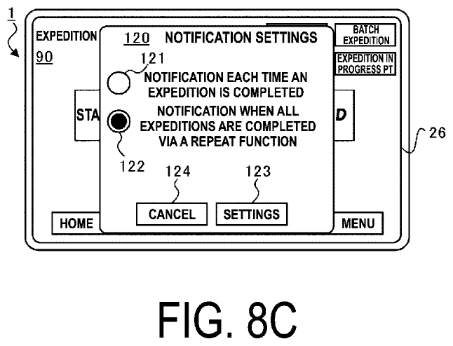

In addition, a menu screen selection operation portion 92 for displaying a menu screen 110 (FIG. 8A) described below is displayed in an upper portion of the expedition top screen 90.

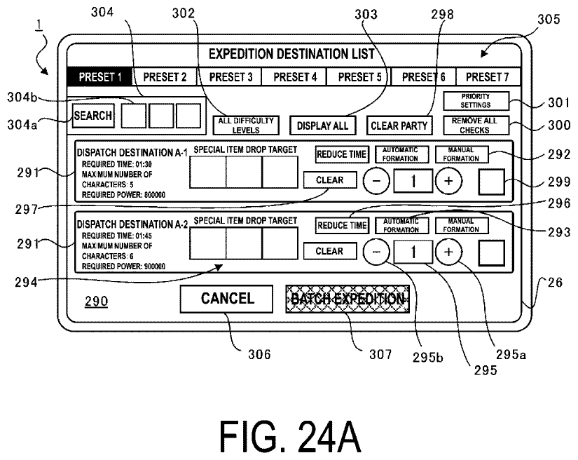

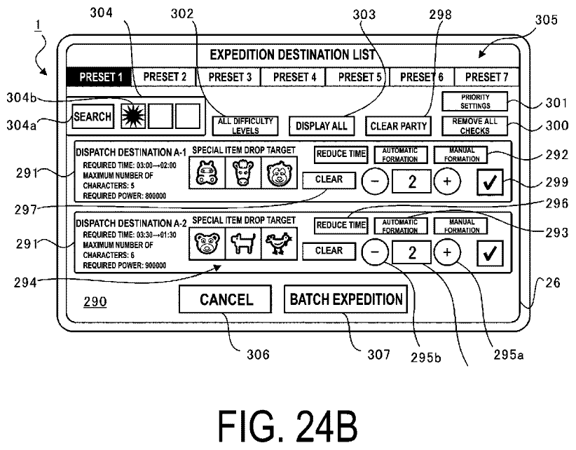

In addition, in the upper portion of the expedition top screen 90, a batch expedition selection operation portion 93 displaying a batch expedition screen 290 (FIG. 24A), which will be described below, is displayed.

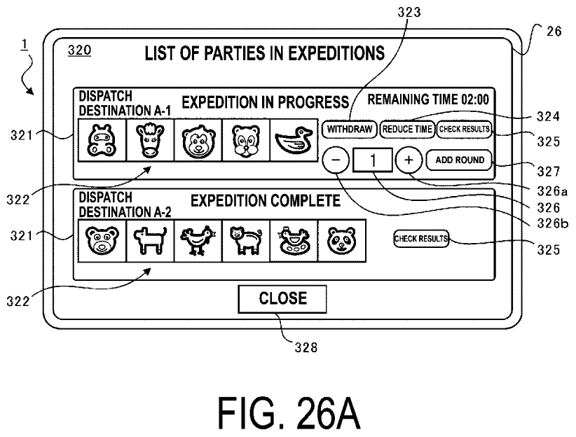

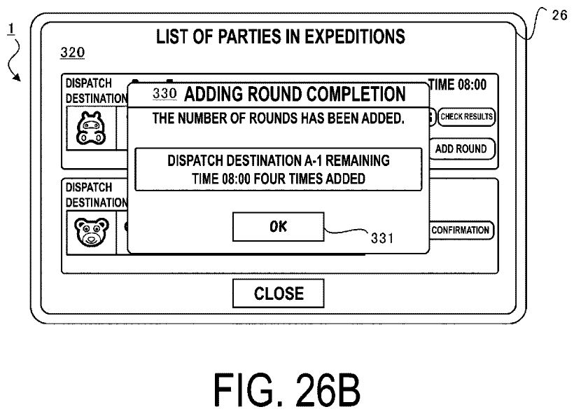

In addition, an in-expedition PT selection operation portion 94 for displaying an in-expedition party list screen 320 (FIG. 26A) described below is displayed in the upper portion of the expedition top screen 90. On the in-expedition party list screen 320 (FIG. 26A), a list is displayed of formed parties for expedition games for which reception of a reward is not complete or for in-progress expedition games. This is described below in more detail. In addition, it may be possible to confirm the result of the expedition game corresponding to each dispatch destination, that is, to receive a reward, on the in-expedition party list screen 320 (FIG. 26A).

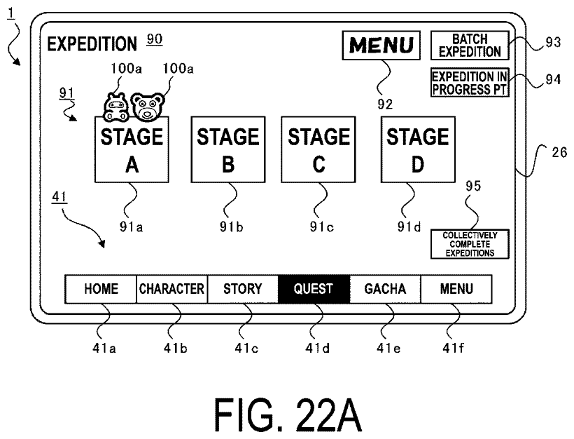

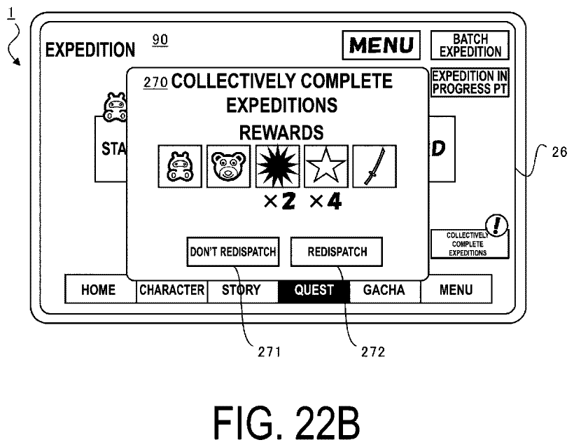

In addition, in a lower portion of the expedition top screen 90, an expedition collective completion operation portion 95 for displaying an expedition collective completion screen 270 (FIG. 22B) described below is displayed.

As described above, when the player operates the expedition stage selection operation portion 91 of the expedition top screen 90, the corresponding dispatch destination selection screen 100 (FIG. 7B) is displayed on the display 26. FIG. 7B is a diagram for describing an example of the dispatch destination selection screen 100. Note that FIG. 7B illustrates the dispatch destination selection screen 100 displayed on the display 26 when the player operates the first expedition stage selection operation portion 91a of the expedition top screen 90 (FIG. 7A).

In the present embodiment, the dispatch destinations belonging to “Stage A” include four dispatch destinations: “Dispatch destination A-1”, “Dispatch destination A-2”, “Dispatch destination A-3”, and “Dispatch destination A-4”. Similarly, “Stage B” to “Stage D” also each include four dispatch destinations. However, the number of dispatch destinations belonging to each stage is not limited thereto, and the number of dispatch destinations belonging to each stage may be the same or different.

As illustrated in FIG. 7B, a plurality of dispatch destination selection operation portions 101 corresponding to the plurality of dispatch destinations are displayed at a central portion of the dispatch destination selection screen 100. Specifically, as illustrated in FIG. 7B, four operation portions are displayed: a first dispatch destination selection operation portion 101a denoted by “Dispatch destination A-1”, a second dispatch destination selection operation portion 101b denoted by “Dispatch destination A-2”, a third dispatch destination selection operation portion 101c denoted by “Dispatch destination A-3”, and a fourth dispatch destination selection operation portion 101d denoted by “Dispatch destination A-4”.

In the present embodiment, a difficulty level is set in advance for each dispatch destination in the expedition game. In the present embodiment, three play conditions, namely required power, maximum number of characters, and required time are set in advance for each dispatch destination.

The required power indicates a minimum condition of the power of the party, that is, a total value of the power of the ally characters forming the party. That is, when the power of the party is equal to or greater than the required power, the party can be dispatched to the dispatch destination. On the other hand, if the power of the party is less than the required power, the party cannot be dispatched to the dispatch destination. That is, it can be considered that the higher the required power, the higher the difficulty level.

In other words, it can be considered that when set formation information (party formation) satisfies the minimum condition (required power), progression to specific content (expedition game) is allowed, and when the set formation information (party formation) does not satisfy the minimum condition (required power), progression to the specific content (expedition game) is not allowed.

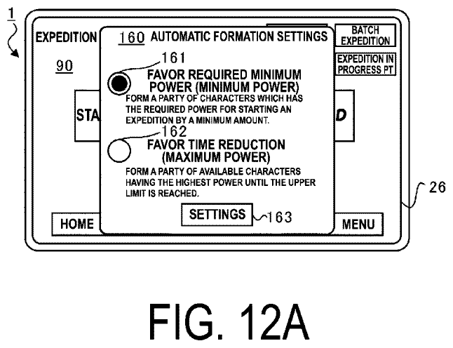

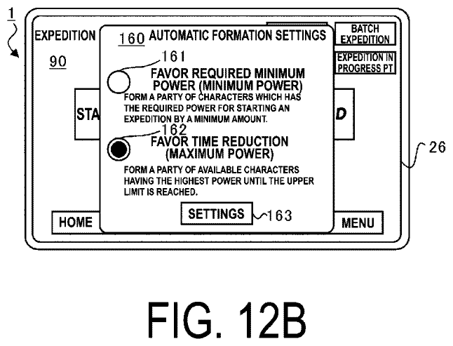

The required time indicates the time required for completion when the party is dispatched to the dispatch destination. In the present embodiment, the required time is reduced as the power of the party dispatched to the dispatch destination increases. That is, it is possible to increase the power of the party and reduce the required time by forming a party of ally characters having relatively high power among the possessed ally characters. However, the conditions for reducing the required time are not limited to the above. For example, the required time may be reduced by the number of party members, the level of the ally characters, or the like instead of the power. These may be set as setting targets in an automatic formation setting screen 160 (FIG. 12A) described below.

In other words, formation information including one or more game media (ally characters) and with a predetermined parameter (power) calculated based on the game medium (ally characters) that satisfies the minimum condition is required, and the formation information (party formation) is set based on a player operation relating to the specific content (expedition game) with the degree of advantage increasing (required time decreasing) the further the predetermined parameter (power) exceeds the minimum condition. In addition, it is possible to reduce an amount of time until the progress of the specific content (the expedition game) ends in accordance with a degree of the predetermined parameter (power of the party) exceeding the minimum condition (required power).

The maximum number of characters indicates the maximum number of ally characters that can be put into a party to be dispatched to the dispatch destination. It can be considered that the difficulty level increases as the maximum number of characters decreases. The minimum number of ally characters put into a party to be dispatched to the dispatch destination may be further set as a play condition.

Specifically, for “Dispatch destination A-1”, the required time is set to 1 hour and 30 minutes, the maximum number of characters is set to 5, and the required power is set to 800000 as the play conditions, as illustrated in FIG. 7B for example. For “Dispatch destination A-2”, the required time is set to 1 hour and 45 minutes, the maximum number of characters is set to 6, and the required power is set to 900000 as the play conditions. For “Dispatch destination A-3”, the required time is set to 1 hour and 40 minutes, the maximum number of characters is set to 2, and the required power is set to 700000 as the play conditions. For “Dispatch destination A-4”, the required time is set to 4 hours, the maximum number of characters is set to 12, and the required power is set to 950000 as the play conditions.

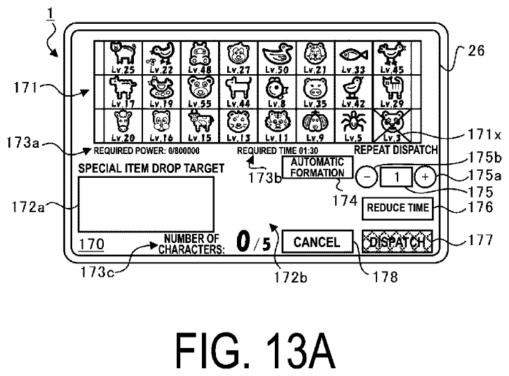

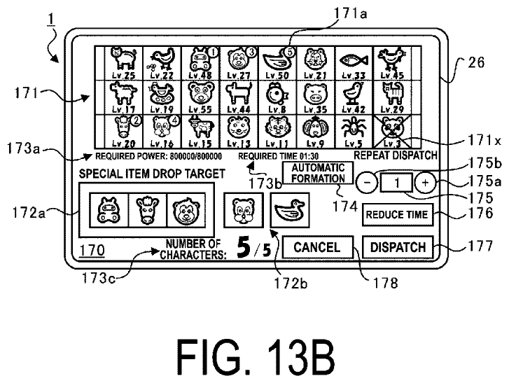

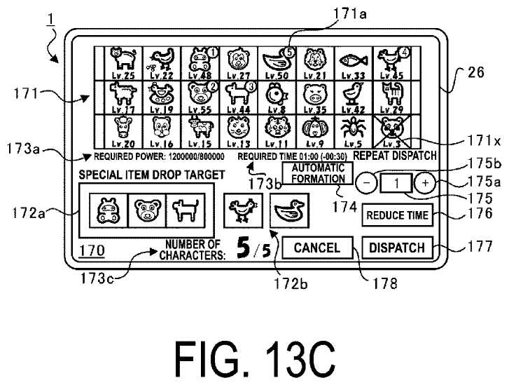

When any one of the first dispatch destination selection operation portion 101a to the fourth dispatch destination selection operation portion 101d is operated by the player, a formation screen 170 (FIG. 13A) described below for forming a party to be dispatched to the corresponding type of dispatch destination is displayed on the display 26.

Further, as illustrated in FIG. 7B, a cancel operation portion 102 denoted by “Cancel” is displayed in a lower portion of the dispatch destination selection screen 100. When the player operates the cancel operation portion 102, the display of the dispatch destination selection screen 100 is ended, and the expedition top screen 90 (FIG. 7A) is displayed on the display 26.

As described above, when the player operates the menu screen selection operation portion 92 of the expedition top screen 90 (FIG. 7A), the menu screen 110 (FIG. 8A) is displayed on the display 26. FIG. 8A is a diagram for describing an example of the menu screen 110.

As illustrated in FIG. 8A, a notification setting operation portion 111 denoted by “Notification settings” is displayed on the menu screen 110. When the notification setting operation portion 111 is operated by the player, a notification setting screen 120 (FIG. 8B) described below is displayed on the display 26.

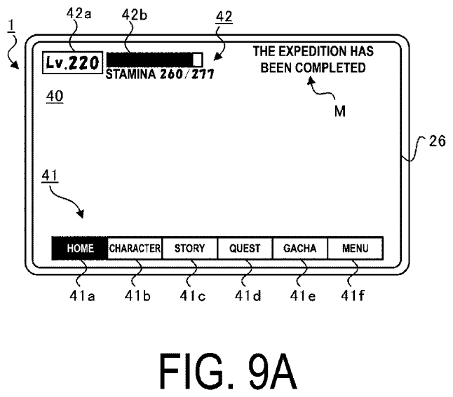

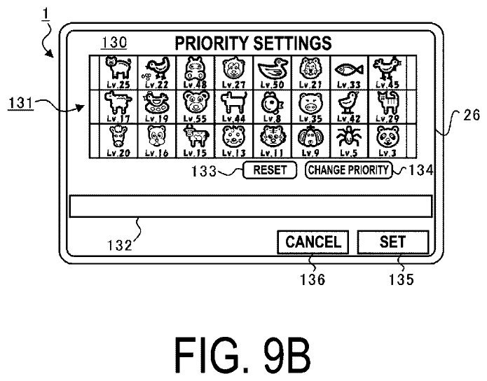

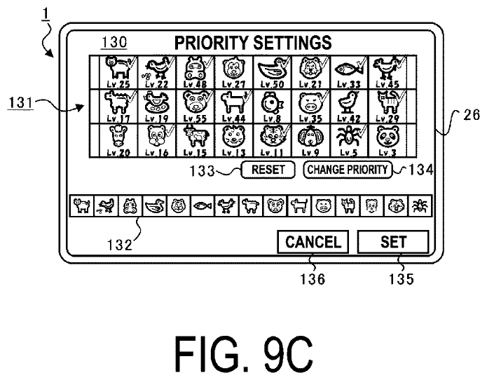

Further, as illustrated in FIG. 8A, a priority setting operation portion 112 denoted by “Priority settings” is displayed on the menu screen 110. When the priority setting operation portion 112 is operated by the player, a priority setting screen 130 (FIG. 9B) described below is displayed on the display 26.

As illustrated in FIG. 8A, an automatic formation setting operation portion 113 denoted by “Automatic formation settings” is displayed in the menu screen 110. When the automatic formation setting operation portion 113 is operated by the player, the automatic formation setting screen 160 (FIG. 12A) described below is displayed on the display 26.

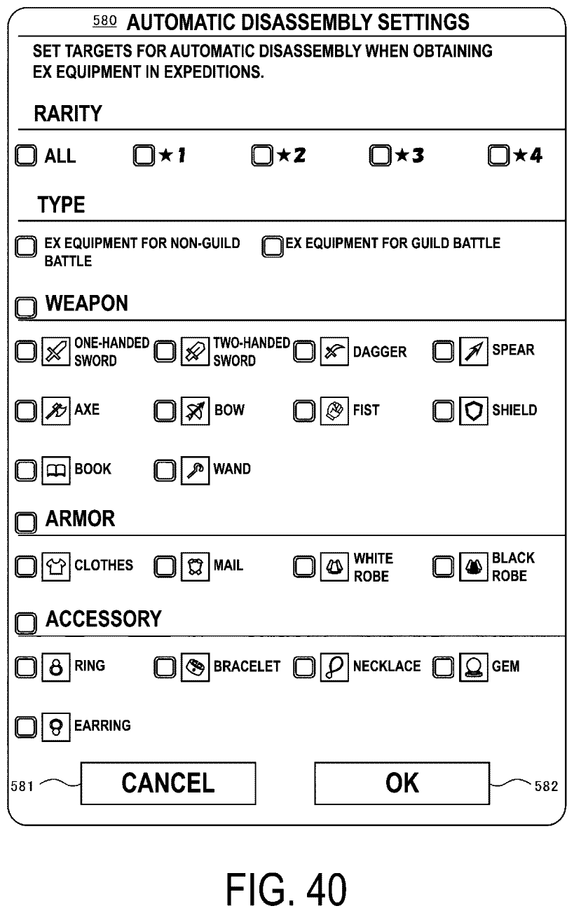

As illustrated in FIG. 8A, the menu screen 110 displays an automatic disassembly setting operation portion 114 denoted by “AUTOMATIC DISASSEMBLY SETTINGS”. When the automatic disassembly setting operation portion 114 is operated by the player, an automatic disassembly settings screen (FIG. 40) for setting settings relating to an automatic disassembly function described below is displayed on the display 26.

Further, as illustrated in FIG. 8A, a close operation portion 115 denoted by “CLOSE” is displayed on the menu screen 110. When the player operates the close operation portion 115, the display of the menu screen 110 is ended, and the expedition top screen 90 (FIG. 7A) is displayed on the display 26.

As described above, when the notification setting operation portion 111 is operated by the player, the notification setting screen 120 (FIG. 8B) is displayed. FIG. 8B is a first diagram for describing an example of the notification setting screen 120. FIG. 8C is a second diagram for describing an example of the notification setting screen 120. FIG. 9A is a diagram for describing an example of an expedition completion notification.

As will be described in detail below, a repeat dispatch function is provided in the present embodiment. In the repeat dispatch function, the player can designate any number of times that the formed party is dispatched to the dispatch destination (hereinafter referred to as the number of dispatches). In other words, for the expedition game (specific content), the number of times selected by the player from among one time and a predetermined number of two times or more can be set as the number of executions. Thus, it is possible to improve player-friendliness. A limit may be placed on the number of executions that can be set. For example, the number of times one type of expedition game can be executed may be limited to 10 times per day. In this case, the number of times within a range not exceeding the maximum number of times can be designated as the number of executions by the repeat dispatch function.

Further, in the present embodiment, when the expedition game is completed, the player can receive a notification indicating that the expedition game has been completed (hereinafter referred to as an expedition completion notification). Specifically, in the case illustrated in FIG. 9A, a message M stating “Expedition complete” is displayed in the upper portion of the home screen 40. The text displayed in the expedition completion notification is not limited thereto. Further, the screen where the message M is displayed is not limited to the home screen 40. That is, while the game application is running, the message M is displayed at an upper portion of the display 26 regardless of the type of the screen being displayed.

On the notification setting screen 120 illustrated in FIGS. 8B and 8C, the player can set a trigger for executing the expedition completion notification to any trigger. In other words, it is possible to set the execution trigger of the notification indicating that the progress of the expedition game (specific content) has ended based on a player operation.

Specifically, regarding the execution trigger of the expedition completion notification, the player can set the completion of one expedition game as the execution trigger of the expedition completion notification (hereinafter, referred to as a first execution trigger) regardless of the designated number of dispatches. Also, regarding the execution trigger of the expedition completion notification, the player can set the completion of all of the designated number of dispatches/expedition games as the execution trigger of the expedition completion notification (hereinafter, referred to as a second execution trigger) regardless of the designated number of dispatches.

In other words, it is possible to set, as an execution trigger (second execution trigger), a case where all the progress of the expedition game (specific content) of the set number of executions has ended. In addition, in a case where the second execution trigger is set and the designated number of dispatches is one, the expedition completion notification (notification) is executed based on the progress of one expedition game (specific content) having ended. In addition, in a case where the second execution trigger is set and the designated number of dispatches is a plurality of times (for example, three times), the expedition completion notification (notification) is executed based on the progress of the expedition game (specific content) having been ended a plurality of times (for example, three times). In addition, in a case where the second execution trigger is set and the designated number of dispatches is a plurality of times (for example, three times), the expedition completion notification (notification) is not executed based on the progress of the expedition game (specific content) having been ended less than the designated number of dispatches (for example, one or two times).

As illustrated in FIGS. 8B and 8C, a first execution trigger selection portion 121 corresponding to the first execution trigger and a second execution trigger selection portion 122 corresponding to the second execution trigger are displayed at a central portion of the notification setting screen 120. When the player operates the first execution trigger selection portion 121, the first execution trigger selection portion 121 is highlighted as illustrated in FIG. 8B. When the player operates the second execution trigger selection portion 122, the second execution trigger selection portion 122 is highlighted as illustrated in FIG. 8C. FIGS. 8B and 8C illustrate a case where a black circle is displayed in the first execution trigger selection portion 121 or the second execution trigger selection portion 122 in accordance with a player operation as a highlighted display. However, the content of the highlighted display is not limited thereto. For example, a check mark may be displayed in the first execution trigger selection portion 121 or the second execution trigger selection portion 122 in accordance with a player operation as a highlighted display.

In addition, as illustrated in FIGS. 8B and 8C, a setting operation portion 123 denoted by “Set” is displayed at a lower portion of the notification setting screen 120. When the player operates the setting operation portion 123 in a case where the first execution trigger selection portion 121 is highlighted (FIG. 8B), the first execution trigger is set as the execution trigger of the expedition completion notification. When the player operates the setting operation portion 123 in a case where the second execution trigger selection portion 122 is highlighted (FIG. 8C), the second execution trigger is set as the execution trigger of the expedition completion notification.

In addition, as illustrated in FIGS. 8B and 8C, a cancel operation portion 124 denoted by “Cancel” is displayed at the lower portion of the notification setting screen 120. When the player operates the cancel operation portion 124, the display of the notification setting screen 120 is ended, and the menu screen 110 (FIG. 8A) is displayed on the display 26.

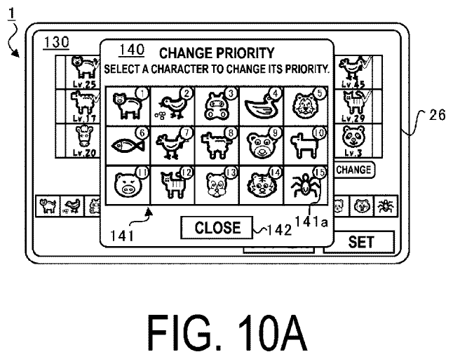

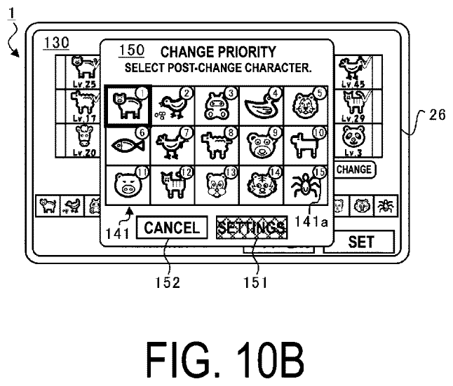

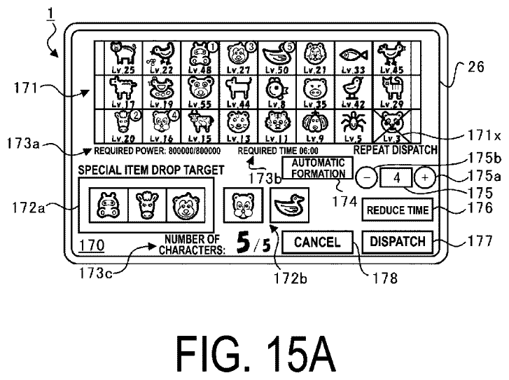

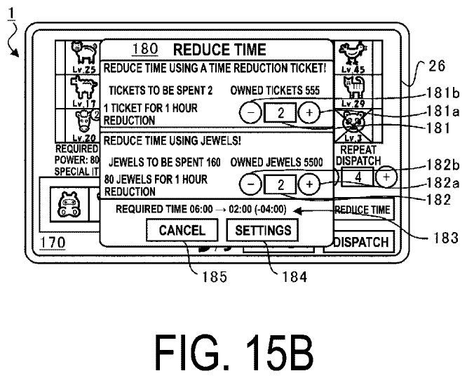

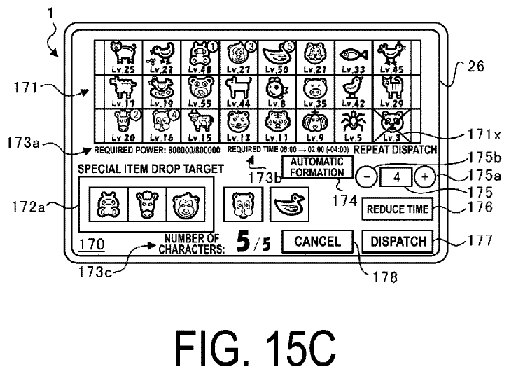

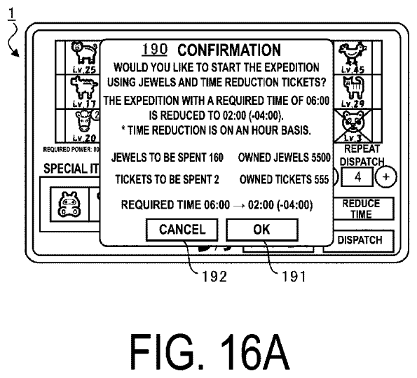

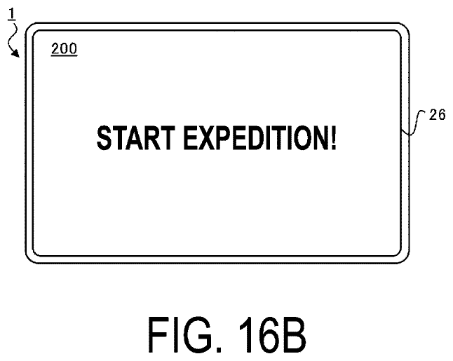

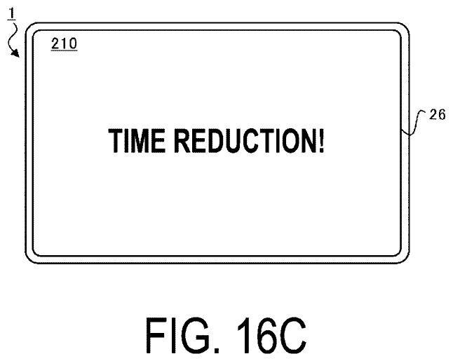

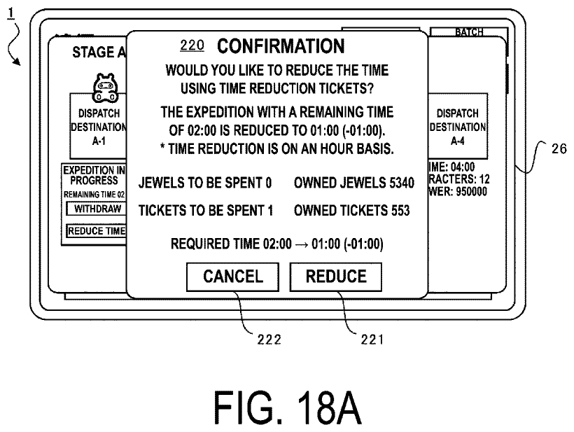

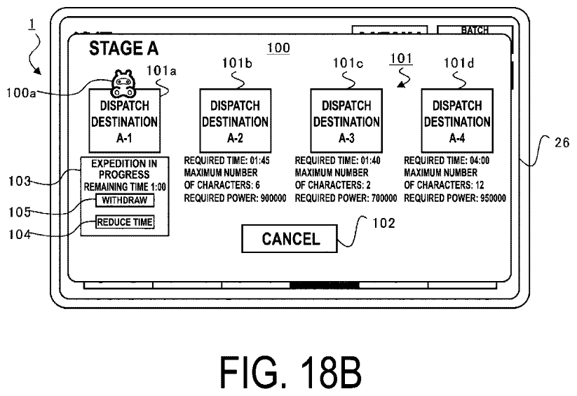

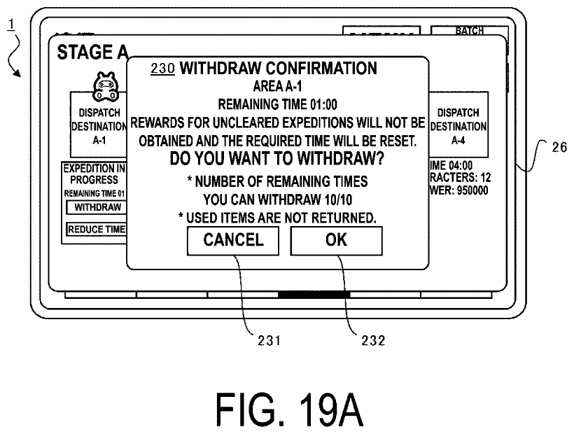

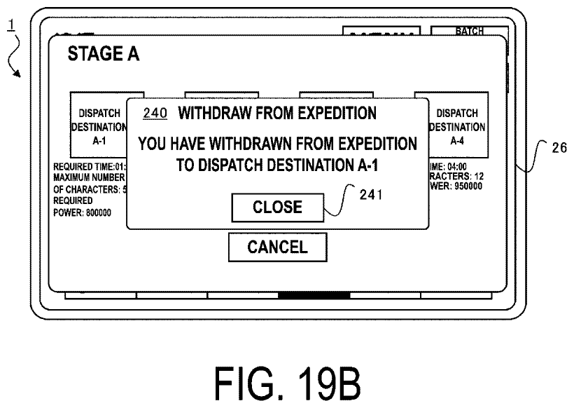

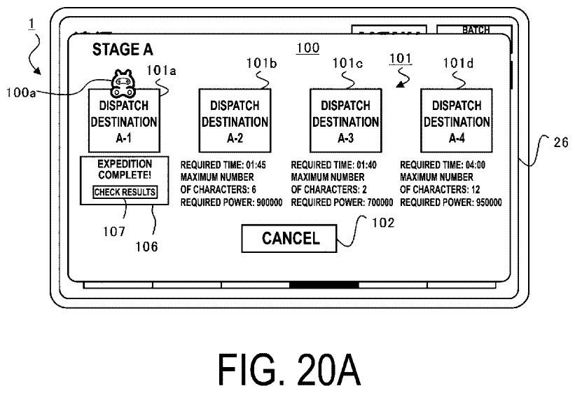

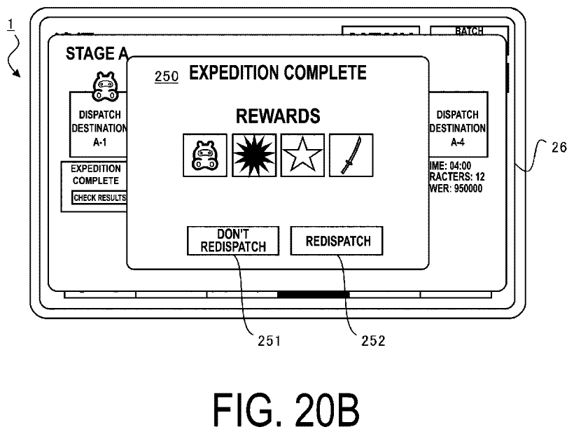

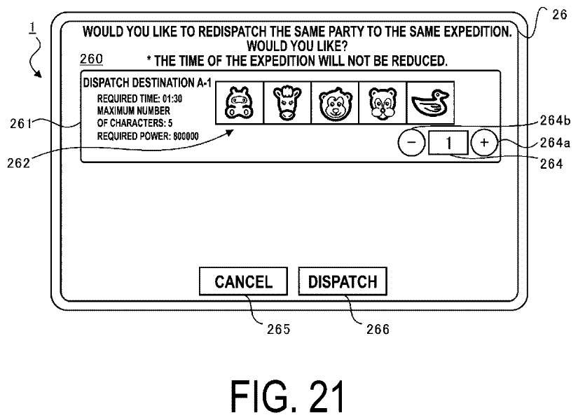

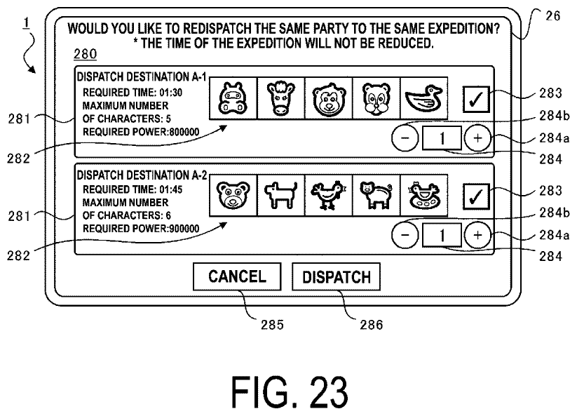

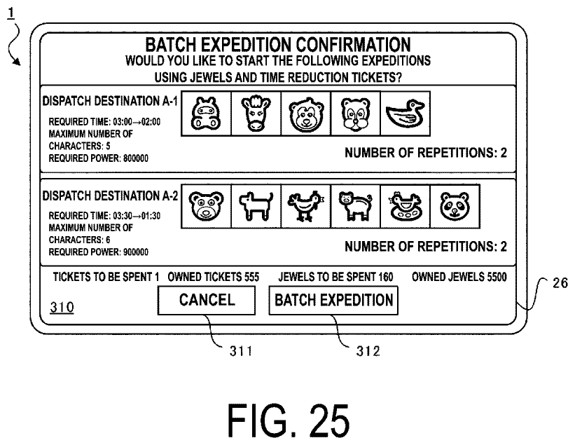

Although the case where the message M is displayed when the home screen 40 is displayed on the display 26 is illustrated in FIG. 9A, the message M is displayed when the execution trigger set by the player is established while the game application is running. That is, when the execution trigger set by the player is established while the game application is running, the message M is displayed at the upper portion of the display 26 regardless of the type of the screen being displayed. For example, when the ally character confirmation screen 50 (FIG. 3B) is displayed on the display 26, the message M is displayed at a top portion of the ally character confirmation screen 50 if the execution trigger set by the player is established. Similarly, when the story screen 60 (FIG. 4A), the quest screen 70 (FIG. 4B), the main quest screen 72 (FIG. 5A), the main quest selection screen 74 (FIG. 5B), the party selection screen 77 (FIG. 5C), the battle game screen 80 (FIG. 6A), the first result screen 83 (FIG. 6B), the second result screen 85 (FIG. 6C), the expedition top screen 90 (FIG. 7A), the dispatch destination selection screen 100 (FIG. 7B), the menu screen 110 (FIG. 8A), the notification setting screen 120 (FIG. 8B), the priority setting screen 130 (FIG. 9B), a first change priority screen 140 (FIG. 10A), a second change priority screen 150 (FIG. 10B), the automatic formation setting screen 160 (FIG. 12A), the formation screen 170 (FIG. 13A), a time reduction screen 180 (FIG. 15B), a confirmation screen 190 (FIG. 16A), an expedition start animation screen 200 (FIG. 16B), time reduction animation screen 210 (FIG. 16C), a confirmation screen 220 (FIG. 18A), a withdraw confirmation screen 230 (FIG. 19A), an expedition withdraw screen 240 (FIG. 19B), an expedition completion screen 250 (FIG. 20B), a redispatch screen 260 (FIG. 21), the expedition collective completion screen 270 (FIG. 22B), a redispatch screen 280 (FIG. 23), the batch expedition screen 290 (FIG. 24A), or a batch expedition confirmation screen 310 (FIG. 25) are displayed on display 26, the message M is displayed at the top portion of each screen being displayed if the execution trigger set by the player is established.

In a case where the execution trigger set by the player is established while the game application is not running the message M may be displayed when the game application is run for the first time after the execution trigger set by the player has been established.

Further, the message M may be displayed when the execution trigger set by the player is established while the game application is not running. In this case, the message M may be displayed in a predetermined notification area on the display 26 of the player terminal 1.

As described above, when the priority setting operation portion 112 of the menu screen 110 (FIG. 8A) is operated by the player, the priority setting screen 130 is displayed on the display 26. FIG. 9B is a first diagram for describing an example of the priority setting screen 130. FIG. 9C is a second diagram for describing an example of the priority setting screen 130.

As described above, in the present embodiment, it is possible to obtain a special item as a reward when completing an expedition game. Specifically, it is possible to obtain a special item corresponding to an ally character who, from among the ally characters forming the party dispatched to a completed expedition game, is set as the special item drop target that can obtain the special item at a predetermined probability.

In addition, in the present embodiment, a normal item that can also be obtained when the battle game is completed can be obtained as a reward when the expedition game is completed. In the present embodiment, EX equipment that cannot be obtained when the battle game is completed can be obtained at a predetermined probability as a reward when the expedition game is completed. The player can equip (set) a desired ally character with EX equipment. Accordingly, it is possible to motivate the player to play the expedition game.

Note that icon images indicating EX equipment that can be obtained at a dispatch destination may be displayed in association with the corresponding dispatch destination selection operation portions 101. This allows the player to visually comprehend the EX equipment that can be obtained, improving user-friendliness.

In the present embodiment, the player can form a party of ally characters up to a maximum number (for example, five) set for each dispatch destination. Among the ally characters in the party, a predetermined number of ally characters (three in the present embodiment) can be set as special item drop targets.

In other words, in the present embodiment, the player cannot obtain a special item corresponding to an ally character who, from among the ally characters forming the party dispatched to a completed expedition game, is not set as the special item drop target. However, the probability of being able to obtain a special item corresponding to an ally character not set as the special item drop target may be set to be lower than the probability of being able to obtain a special item corresponding to an ally character set as the special item drop target.

Further, as will be described in detail below, in the present embodiment, the automatic formation function is provided for automatically forming a party to be dispatched to the dispatch destination. On the priority setting screen 130, when the automatic formation function is used, the player can set the type of one or more ally characters (hereinafter referred to as priority targets) to be preferentially set as the special item drop target and the priority (priority order) thereof.

As illustrated in FIGS. 9B and 9C, a list display portion 131 is displayed at a central portion of the priority setting screen 130. All ally characters possessed by the player are displayed in the list display portion 131. The player can set desired ally characters (up to 15 characters in the present embodiment) as priority targets by operating the ally characters displayed in the list display portion 131.

FIGS. 9B and 9C illustrate an example in which the levels of the ally characters displayed in the list display portion 131 are displayed. However, the power of each ally character displayed in the list display portion 131 may be displayed.

As illustrated in FIGS. 9B and 9C, a priority target display portion 132 for displaying a list of ally characters set as priority targets is displayed in a lower portion of the priority setting screen 130. When the player operates an ally character displayed in the list display portion 131, the operated ally character is highlighted as illustrated in FIG. 9C.

FIG. 9C illustrates an example in which the ally character operated by the player is grayed out as a highlighted display. However, the content of the highlighted display is not limited thereto. For example, as the highlighted display, the border of the ally character operated by the player may be thickened.

Then, the ally characters are displayed in a left-aligned manner in the priority target display portion 132 in the operated order. At this time, the priority of the ally character displayed on the left side of the priority target display portion 132 is set to be the highest, and the priority of the ally character displayed on the right side of the priority target display portion 132 is set to be the lowest.

As illustrated in FIGS. 9B and 9C, a reset operation portion 133 denoted by “Reset” is displayed at the central portion of the priority setting screen 130. When the reset operation portion 133 is operated by the player, the ally character set as the priority target is reset, and the ally character is highlighted in the list display portion 131 illustrated in FIG. 9C and the ally character displayed in the priority target display portion 132 is hidden.

Further, as illustrated in FIGS. 9B and 9C, a setting operation portion 135 denoted by “Set” and a cancel operation portion 136 denoted by “Cancel” are displayed in a lower right portion of the priority setting screen 130.

When the cancel operation portion 136 is operated by the player, the content displayed on the priority setting screen 130 immediately before the cancel operation portion 136 is operated is discarded. In addition, the display of the priority setting screen 130 ends, and the menu screen 110 (FIG. 8A) is displayed on the display 26.

In addition, when the setting operation portion 135 is operated by the player, the priority of the ally character is set to the contents displayed on the priority setting screen 130 immediately before the operation. In addition, the display of the priority setting screen 130 ends, and the menu screen 110 (FIG. 8A) is displayed on the display 26.

As illustrated in FIGS. 9B and 9C, a change priority operation portion 134 denoted by “Change priority” is displayed at the central portion of the priority setting screen 130. When the player operates the change priority operation portion 134, the first change priority screen 140 (FIG. 10A) described below is displayed on the display 26.

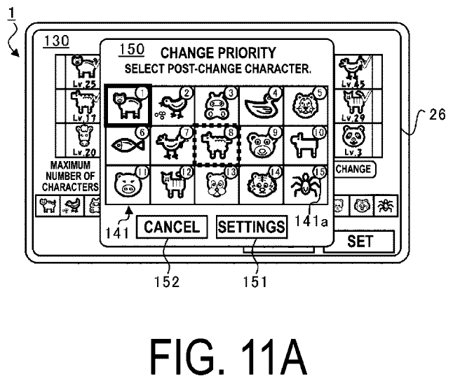

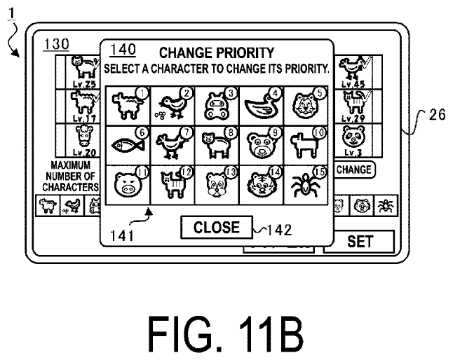

The player can change the priority of priority target ally character by performing a predetermined operation on the first change priority screen 140 (FIG. 10A) and the second change priority screen 150 (FIGS. 10B and 11A) described below. Specifically, the priority of the priority target ally character can be changed by switching the priorities of two ally characters (hereinafter referred to as a pre-change ally character and a post-change ally character) selected by the player from among the priority target ally characters.

FIG. 10A is a first diagram for describing an example of the first change priority screen 140. FIG. 10B is a first diagram for describing an example of the second change priority screen 150. FIG. 11A is a second diagram for describing an example of the second change priority screen 150. FIG. 11B is a second diagram for describing an example of the first change priority screen 140.

As illustrated in FIG. 10A, a priority target display portion 141 is displayed in a central portion of the first change priority screen 140. In the priority target display portion 141, the ally characters set as the priority targets, that is, the ally characters displayed in the priority target display portion 132, are listed in descending order of priority. Further, as illustrated in FIG. 10A, in the priority target display portion 141, an identification display 141a that enables identification of the priority is attached to each ally character set as a priority target. FIG. 10A illustrates an example in which numbers (“1” to “15”) corresponding to the priority are attached as the identification display 141a. That is, smaller numerical values represent a higher priority. However, the content of the identification display 141a is not limited thereto. For example, a symbol corresponding to the priority may be displayed.

Further, as illustrated in FIG. 10A, a close operation portion 142 denoted by “Close” is displayed on the first change priority screen 140. When the player operates the close operation portion 142, the first change priority screen 140 is hidden, and the priority setting screen 130 is displayed on the display 26.

Further, as illustrated in FIG. 10A, an explanatory display stating “Select a character to change its priority” for prompting the player to perform an operation to select a pre-change ally character to be targeted for priority change is displayed at an upper portion of the first change priority screen 140.

When the player operates any one of the ally characters displayed in the priority target display portion 141 of the first change priority screen 140, the operated ally character is set as the pre-change ally character. Further, on the display 26, the display is switched to the second change priority screen 150 illustrated in FIG. 10B.

As illustrated in FIG. 10B, the priority target display portion 141 is continuously displayed on the second change priority screen 150. As illustrated in FIG. 10B, the pre-change ally character is highlighted in the priority target display portion 141 of the second change priority screen 150. FIG. 10B illustrates an example in which the border of the pre-change ally character is thickened as the highlighted display. However, the content of the highlighted display is not limited thereto. For example, as the highlighted display, the display size of the pre-change ally character may be increased.

Further, as illustrated in FIG. 10B, an explanatory display stating “Select a post-change character” for prompting the player to perform an operation to select a post-change ally character to be targeted for priority change is displayed at the upper portion of the second change priority screen 150.

When the player operates any one of the ally characters other than the pre-change ally characters displayed in the priority target display portion 141 of the second change priority screen 150, the operated ally character is set as the post-change ally character. Further, on the display 26, the display of the second change priority screen 150 is updated as illustrated in FIG. 11A.

Note that although FIG. 9C illustrates a case where the maximum number (15) of ally characters that can be set are set as priority targets, a number (for example, 3) of ally characters equal to or less than the maximum number (15) that can be set may be set as priority targets. Further, in the present embodiment, it is not essential to set an ally character as the priority target. That is, the player is allowed to not particularly set an ally character as the priority target.

As illustrated in FIG. 11A, in the priority target display portion 141 of the second change priority screen 150, both the pre-change ally character and the post-change ally character are distinguishably highlighted. In FIG. 11A, as the highlighted display, the border of the pre-change ally character is thickened and the border of the post-change ally character is thickened and displayed with a broken line. However, the content of the highlighted display is not limited thereto. For example, as the highlighted display, the display size of the pre-change ally character and the post-change ally character may be increased.

As illustrated in FIGS. 10B and 11A, a setting operation portion 151 denoted by “Set” is displayed in a lower portion of the second change priority screen 150. As illustrated in FIG. 10B, before the post-change ally character is set, the setting operation portion 151 is displayed in an inoperable state. On the other hand, as illustrated in FIG. 11A, after the post-change ally character is set, the setting operation portion 151 is displayed in an operable state.

As illustrated in FIGS. 10B and 11A, a cancel operation portion 152 denoted by “Cancel” is displayed in the lower portion of the second change priority screen 150. When the player operates the cancel operation portion 152, the second change priority screen 150 is hidden, and the first change priority screen 140 is displayed on the display 26.

When the player operates the setting operation portion 151, the priority of the ally character set as the pre-change ally character and the priority of the ally character set as the post-change ally character are switched. In addition, on the display 26, the display is switched to the first change priority screen 140 illustrated in FIG. 11B, and the player is notified that the priority of the ally character set as the pre-change ally character and the priority of the ally character set as the post-change ally character have been switched.

As described above, the difficulty level is set in advance for the expedition game. In the present embodiment, three conditions of required power, maximum number of characters, and required time are set in advance for each dispatch destination as the difficulty level.

In the present embodiment, parties can be dispatched to a plurality of dispatch destinations. At this time, the same ally character cannot be put in parties dispatched to different dispatch destinations.

For example, when the player intends to simultaneously dispatch parties to many dispatch destinations, the player needs to form the parties by distributing ally characters having relatively high power to many parties so that the power of each party satisfies the required power by a minimum amount. In this case, although a significant reduction in the time required for each dispatch destination cannot be expected, parties can be simultaneously dispatched to many dispatch destinations.

Further, for example, in a case where the purpose is to reduce the required time at a dispatch destination, the player concentrates ally characters having relatively high power into a small number of parties. Accordingly, the power of each party greatly exceeds the required power. In this case, instead of narrowing down the dispatch destinations to be simultaneously dispatched to, the required time for each dispatch destination can be reduced.

As described above, when the automatic formation setting operation portion 113 of the menu screen 110 (FIG. 8A) is operated by the player, the automatic formation setting screen 160 (FIG. 12A) is displayed. FIG. 12A is a first diagram for describing an example of the automatic formation setting screen 160. FIG. 12B is a second diagram for describing an example of the automatic formation setting screen 160.

As described above, the automatic formation function is provided for automatically forming a party of ally characters to be dispatched to a dispatch destination selected by a player. In the present embodiment, a first automatic formation function and a second automatic formation function are provided as automatic formation functions.

The first automatic formation function is a function of automatically forming a party of the ally characters with priority given to satisfying the required power with the power of the party by a minimum amount. The player can simultaneously dispatch parties to a relatively large number of dispatch destinations by using the first automatic formation function.

The second automatic formation function is a function of automatically forming a party of the ally characters with priority given to making the power of the party the highest possible. The player can reduce the required time at the dispatch destination by using the second automatic formation function.

In other words, the formation information (party formation) can be generated based on the automatic formation function selected by the player from among the first automatic formation function that prioritizes satisfying the minimum condition (party power minimum condition) by the minimum amount and the second automatic formation function that prioritizing satisfying the minimum condition (the party power being equal to or greater than the required power) and increasing the degree of advantage (making the party power greater than the required power to reduce the required time at the dispatch destination), which are automatic formation functions of automatically generating the formation information (party formation).

On the automatic formation setting screen 160, the player can set which of the first automatic formation function and the second automatic formation function is to be used as the automatic formation function. As illustrated in FIGS. 12A and 12B, a first automatic formation function selection portion 161 corresponding to the first automatic formation function and a second automatic formation function selection portion 162 corresponding to the second automatic formation function are displayed at a central portion of the automatic formation setting screen 160. When the player operates the first automatic formation function selection portion 161, the first automatic formation function selection portion 161 is highlighted as illustrated in FIG. 12A. When the player operates the second automatic formation function selection portion 162, the second automatic formation function selection portion 162 is highlighted as illustrated in FIG. 12B. FIGS. 12A and 12B illustrate a case where a black circle is displayed in the first automatic formation function selection portion 161 or the second automatic formation function selection portion 162 in accordance with a player operation as a highlighted display. However, the content of the highlighted display is not limited thereto. For example, a check mark may be displayed in the first automatic formation function selection portion 161 or the second automatic formation function selection portion 162 in accordance with a player operation as a highlighted display.

In addition, as illustrated in FIGS. 12A and 12B, a setting operation portion 163 denoted by “Set” is displayed at a lower portion of the automatic formation setting screen 160. When the setting operation portion 163 is operated by the player in the case where the first automatic formation function selection portion 161 is highlighted (FIG. 12A), the first automatic formation function is set as the automatic formation function. When the setting operation portion 163 is operated by the player in the case where the second automatic formation function selection portion 162 is highlighted (FIG. 12B), the second automatic formation function is set as the automatic formation function. When the player operates the setting operation portion 163, the display of the automatic formation setting screen 160 is ended, and the menu screen 110 (FIG. 8A) is displayed on the display 26.

When any one of the dispatch destination selection operation portions 101 of the dispatch destination selection screen 100 (FIG. 7B) is operated by the player, the formation screen 170 (FIG. 13A) for forming a party to be dispatched to the corresponding type of dispatch destination is displayed on the display 26.

FIG. 13A is a first diagram for describing an example of the formation screen 170. FIG. 13B is a second diagram for describing an example of the formation screen 170. Note that FIG. 13B illustrates a case where the power of the party formed by the player is the same as the required power. FIG. 13C is a third diagram for describing an example of the formation screen 170. Note that FIG. 13C illustrates a case where the power of the party formed by the player is greater than the required power.

Hereinafter, a case where the first dispatch destination selection operation portion 101a corresponding to “Dispatch destination A-1” is operated and the formation screen 170 is displayed will be described. For “Dispatch destination A-1” the required time is set to 1 hour and 30 minutes, the maximum number of characters is set to 5, and the required power is set to 800000 as the play conditions, as described above.

As illustrated in FIG. 13A, a list display portion 171 in which ally characters that can be put in the party are displayed in a list in the formation screen 170. The player can form a party of the desired ally characters by operating the ally characters displayed in the list display portion 171.

FIG. 13A illustrates an example in which the levels of the ally characters displayed in the list display portion 171 are displayed. However, the power of each ally character displayed in the list display portion 171 may be displayed.

As described above, in the present embodiment, the same ally character cannot be put in a party for a plurality of dispatch destinations. Thus, in a case where an ally character put in a party dispatched to another dispatch destination (hereinafter referred to as an unavailable character) is already present, an unavailable display 171x is attached to the unavailable character. In other words, it is possible to notify the player of an unavailable character via the unavailable display 171x.

Further, as illustrated in FIG. 13A, a drop target display portion 172a and a non-drop target display portion 172b are displayed on the formation screen 170. In the drop target display portion 172a, ally characters in the party as special item drop targets that can obtain special items are displayed. In the non-drop target display portion 172b, ally characters in the party that are not special item drop targets that can obtain special items are displayed.

When the player operates an ally character displayed in the list display portion 171, the operated ally character is highlighted as illustrated in FIGS. 13B and 13C. FIGS. 13B and 13C illustrates an example in which the ally character operated by the player is grayed out as a highlighted display. However, the content of the highlighted display is not limited thereto. For example, as the highlighted display, the border of the ally character operated by the player may be thickened.

Then, the ally characters are displayed in a left-aligned manner in the drop target display portion 172a and the non-drop target display portion 172b in the operated order.

In addition, as illustrated in FIGS. 13B and 13C, an identification display 171a that enables identification of the operated order is attached to the ally characters of the list display portion 171 that are highlighted. In FIGS. 13B and 13C, numbers (“1” to “15”) corresponding to the operated order are assigned as the identification display 171a. That is, smaller numerical values represent an earlier operated order. However, the content of the identification display 171a is not limited thereto. For example, a symbol corresponding to the operated order may be displayed.

In addition, the player can exclude the operated ally character from the party being formed by operating the ally character in the highlighted list display portion 171 again.

Further, a required power display portion 173a is displayed on the formation screen 170. In the required power display portion 173a, the required power set for the dispatch destination (here, “Dispatch destination A-1”) is displayed as the denominator, and the power of the party being formed is displayed as the numerator. Specifically in the case of FIG. 13B, 800000 is the power of the party formed by the player displayed as the numerator in the required power display portion 173a, and 800000 is the required power displayed as the denominator in the required power display portion 173a, for example. In the case of FIG. 13C, 1200000 is the power of the party formed by the player displayed as the numerator in the required power display portion 173a, and 800000 is the required power displayed as the denominator in the required power display portion 173a.

Further, a required time display portion 173b is displayed on the formation screen 170. In the required time display portion 173b, the required time set for the dispatch destination (here, “Dispatch destination A-1”) is displayed. Specifically in the case of FIG. 13B, a required time of 1 hour 30 minutes is displayed in the required time display portion 173b, for example. When the required time is reduced according to the power of the formed party, the post-reduction required time (for example, one hour) and the amount of time reduced from the pre-reduction required time (for example, −30 minutes) are displayed in the required time display portion 173b as illustrated in FIG. 13C.

Further, a maximum number of characters display portion 173c is displayed on the formation screen 170. In the maximum number of characters display portion 173c, the maximum number of characters set for the dispatch destination (here, “Dispatch destination A-1”) is displayed as the denominator, and the number of characters in the party being formed is displayed as the numerator. Specifically, before the player forms a party of the ally characters, as illustrated in FIG. 13A, “0” is the number of ally characters put in the party by the player displayed as the numerator in the maximum number of characters display portion 173c, and “5” is the maximum number of characters displayed as the denominator in the maximum number of characters display portion 173c, for example. Also, when the player has formed a party of five ally characters, as illustrated in FIGS. 13B and 13C, “5” is the number of ally characters put in the party by the player displayed as the numerator in the maximum number of characters display portion 173c, and “5” is the maximum number of characters displayed as the denominator in the maximum number of characters display portion 173c.

As described above, in the present embodiment, the automatic formation function is provided for automatically forming a party to be dispatched to the dispatch destination. As illustrated in FIG. 13A, an automatic formation operation portion 174 for using the automatic formation function is displayed on the formation screen 170. When the automatic formation operation portion 174 is operated by the player, the automatic formation function (the first automatic formation function or the second automatic formation function) of the type set by the player on the automatic formation setting screen 160 (FIGS. 12A and 12B) is used, and the party is automatically formed.

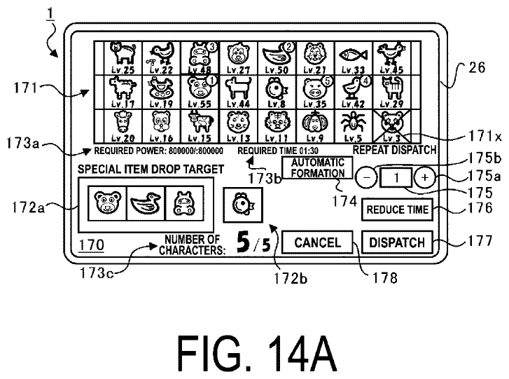

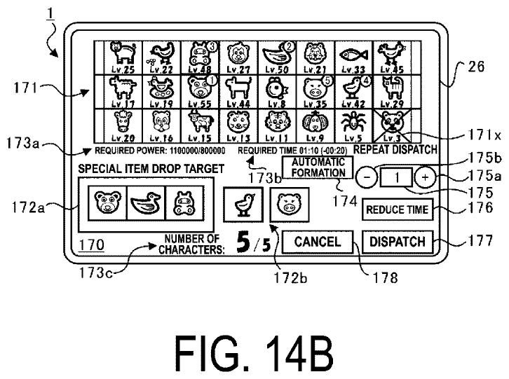

FIG. 14A is a diagram for describing an example of the formation screen 170 when the first automatic formation function is used. When the first automatic formation function is used, as illustrated in FIG. 14A three ally characters with high priority are preferentially put into the party and displayed in the drop target display portion 172a from among the ally characters set as priority targets by the player. When there is a party that has already been dispatched to another dispatch destination, three ally characters with high priority excluding the unavailable characters are preferentially put into the party from among the ally characters set as priority targets.

Further, as illustrated in FIG. 14A, the ally characters not set as the priority targets are put in the party so that the power of the party satisfies the required power by a minimum amount and are displayed in the non-drop target display portion 172b. When there is a party that has already been dispatched to another dispatch destination, the priority targets and the ally characters other than the unavailable characters are put into the party so that the power of the party satisfies the required power by a minimum amount.

In the case illustrated in FIG. 14A, a party is formed of three ally characters displayed in the drop target display portion 172a and one ally character displayed in the non-drop target display portion 172b.

In the present embodiment, specifically, three ally characters with high priority excluding unavailable characters are first preferentially put into a party, when the first automatic formation function is used. In a case where the total power of the three ally characters is equal to or greater than the required power, the party formed by the first automatic formation function includes only these three ally characters.

On the other hand, in a case where the total power of the three ally characters is less than the required power, ally characters not set as priority targets are further put into the party. Specifically, from among the ally characters that are not set as priority targets and that are available, the ally characters having a high power are put into the party in order until the power of the party satisfies the required power. That is, the total number of ally characters put into the party using the first automatic formation function corresponds to an indeterminate value (a value between three and the maximum number of characters).

However, the present invention is not limited thereto, and in a case where the first automatic formation function is used ally characters with high priority excluding unavailable characters may be put in the party in order until the power of the party satisfies the required power. That is, when the required power is reached with one or two characters as a result of putting ally characters with high priority excluding unavailable characters into the party in order, a party may be formed of only one or two ally characters.

FIG. 14B is a diagram for describing an example of the formation screen 170 when the second automatic formation function is used. When the second automatic formation function is used, as illustrated in FIG. 14B three ally characters with high priority are preferentially put into the party and displayed in the drop target display portion 172a from among the ally characters set as priority targets by the player. When there is a party that has already been dispatched to another dispatch destination, three ally characters with high priority excluding the unavailable characters are preferentially put into the party from among the ally characters set as priority targets.

Further, as illustrated in FIG. 14B, the ally characters not set as the priority targets are put in the party so that the power of the party is the highest possible and are displayed in the non-drop target display portion 172b. When there is a party that has already been dispatched to another dispatch destination, the priority targets and the ally characters other than the unavailable characters are put into the party so that making the power of the party greater than the required power is prioritized.

In other words, in the case illustrated in FIG. 14B, a party is formed of three ally characters displayed in the drop target display portion 172a and two ally character displayed in the non-drop target display portion 172b.

In the present embodiment, specifically three ally characters with high priority excluding unavailable characters are first preferentially put into a party, when the second automatic formation function is used. Further, ally characters not set as priority targets are further put into the party. Specifically, from among the ally characters that are not set as priority targets and that are available, the ally characters having a high power are put into the party until the maximum number of characters that can fit in the party is reached. In other words, by forming a party using the second automatic formation function, a party of the maximum number of ally characters is formed.

As described above, in the present embodiment, it is not essential to set an ally character as the priority target. In a case where the ally character is not set as the priority target, when the first automatic formation function is used, a party of the ally characters is formed such that the power of the party satisfies the required power by a minimum amount. Specifically, from among the available ally characters the ally characters having a high power may be put into the party in order until the power of the party satisfies the required power, for example. In this case, the total number of ally characters in the party is an indeterminate value. In a case where the power of the party is equal to or greater than the required power at the stage where three ally characters with high power have been put in the party from among the available ally characters, the party formed by the first automatic formation function includes only these three ally characters.

In a case where the ally character is not set as the priority target, a party of the ally characters is formed such that making the power of the party as high as possible is prioritized, when the second automatic formation function is used. Specifically, from among the ally characters that are available, the ally characters having a high power are put into the party until the maximum number of characters that can fit in the party is reached. In other words, by forming a party using the second automatic formation function, a party of the maximum number of ally characters is formed.

As described above, in the present embodiment, a repeat dispatch function is provided which enables the player to freely designate the number of times to dispatch the formed party to the dispatch destination. FIG. 15A is a fourth diagram for describing an example of the formation screen 170. As illustrated in FIG. 15A, a number of repeated dispatches display portion 175, an increase number of repeated dispatches operation portion 175a, and a decrease number of repeated dispatches operation portion 175b are displayed in the formation screen 170.

The currently set number of dispatches is displayed in the number of repeated dispatches display portion 175. When the player operates the increase number of repeated dispatches operation portion 175a, the number of dispatches is increased by one, and the display of the number of repeated dispatches display portion 175 is updated. When the player operates the decrease number of repeated dispatches operation portion 175b, the number of dispatches is decreased by one, and the display of the number of repeated dispatches display portion 175 is updated. In the present embodiment, the minimum value of the number of dispatches displayed in the number of repeated dispatches display portion 175 is one.

When the number of dispatches is set to a plurality of times, the required time displayed in the required time display portion 173b is updated according to the set number of dispatches as illustrated in FIG. 15A. For example, in the case where the required time required for one dispatch is 1 hour and 30 minutes, when the number of dispatches is set to 4, the display is updated to 6 hours as illustrated in FIG. 15A.

As described above, in the expedition game, the required time required for one dispatch is set to be relatively longer than the time required for one battle game. Thus, in the present embodiment, a time reduction function is provided for reducing the required time for the expedition game in addition to increasing the power of the party and reducing the required time. That is, in the present embodiment, it is possible to simultaneously use both the time reduction function and the reducing of the required time by increasing the power of the party.

As illustrated in FIG. 15A, a time reduction operation portion 176 is displayed on the formation screen 170. When the player operates the time reduction operation portion 176, the time reduction screen 180 described below is displayed on the display 26.

FIG. 15B is a first diagram for describing an example of the time reduction screen 180. In the present embodiment, a first time reduction function is provided as a time reduction function of reducing the required time by using a predetermined item (time reduction ticket) owned by the player. Specifically, the player can reduce the required time by one hour by spending one time reduction ticket. Note that a limit may be placed on the number of time reduction tickets that can be spent within a preset period. For example, up to 99 time reduction tickets may be spent per day. In this case, in one day, the required time can be reduced up to a maximum of 99 hours by spending time reduction tickets.

As illustrated in FIG. 15B, a reduction number display portion 181, an increase reduction number operation portion 181a, and a decrease reduction number operation portion 181b relating to the first time reduction function are displayed on the time reduction screen 180.

The number of time reduction ticket to be spent is displayed in the reduction number display portion 181. When the player operates the increase reduction number operation portion 181a, the number of time reduction ticket to be spent increases by one, and the display of the reduction number display portion 181 is updated. When the player operates the decrease reduction number operation portion 181b, the number of time reduction ticket to be spent decreases by one, and the display of the reduction number display portion 181 is updated. In the present embodiment, the minimum value of the number of time reduction tickets to be spent displayed in the reduction number display portion 181 is 0.

In the present embodiment, a second time reduction function is provided as a time reduction function of reducing the required time by using predetermined in-game currency (jewels) owned by the player. Specifically, the player can reduce the required time by one hour by spending a predetermined number of jewels at one time. The number of jewels required for one hour reduction is not a fixed value and may be varied. For example, the number of required jewels may be increased as the number of times used increases, such as 80 jewels for the first time, 100 jewels for the second time, and 120 jewels for the third time.

Note that a limit may be placed on the number of times that the required time can be reduced by spending a predetermined number of jewels within a preset period. For example, up to 99 times per day, a predetermined number of jewels may be spent to reduce the required time. In this case, in one day, the required time can be reduced up to a maximum of 99 hours by spending jewels.

As illustrated in FIG. 15B, a reduction number display portion 182, an increase reduction number operation portion 182a, and a decrease reduction number operation portion 182b relating to the second time reduction function are displayed on the time reduction screen 180.

The number of times a predetermined number of jewels is to be spent is displayed in the reduction number display portion 182. When the player operates the increase reduction number operation portion 182a, the number of times to spend a predetermined number of jewels increases by one, and the display of the reduction number display portion 182 is updated. When the player operates the decrease reduction number operation portion 182b, the number of times to spend a predetermined number of jewels decreases by one, and the display of the reduction number display portion 182 is updated. In the present embodiment, the number of times a predetermined number of jewels is to be spent displayed in the reduction number display portion 182 is 0.

A required time display portion 183 is displayed on the time reduction screen 180. As illustrated in FIG. 15B, when the player has input to spend two time reduction tickets and to spend the predetermined number of jewels twice, the pre-reduction required time (for example, 6 hours), the post-reduction required time (for example, 2 hours), and the amount of time reduced from the pre-reduction required time (for example, −4 hours) are displayed on the required time display portion 183.

Further, as illustrated in FIG. 15B, a setting operation portion 184 denoted by “Set” and a cancel operation portion 185 denoted by “Cancel” are displayed in the time reduction screen 180.

When the cancel operation portion 185 of the time reduction screen 180 is operated by the player, the content displayed on the time reduction screen 180 immediately before the operation is discarded. In addition, the display of the time reduction screen 180 ends, and the formation screen 170 (FIG. 15A) displayed immediately before the operation of the time reduction operation portion 176 is displayed on the display 26.

When the setting operation portion 184 is operated by the player, the time reduction function is set with the content displayed on the time reduction screen 180 immediately before the operation. In addition, the display of the time reduction screen 180 ends, and the formation screen 170 (FIG. 15C) is displayed on the display 26.

FIG. 15C is a fifth diagram for describing an example of the formation screen 170. FIG. 15C illustrates the formation screen 170 displayed on the display 26 when the player operates the setting operation portion 184 of the time reduction screen 180 illustrated in FIG. 15B. As illustrated in FIG. 15C, in the required time display portion 173b of the formation screen 170, the pre-reduction required time (for example, 6 hours), the post-reduction required time (for example, 2 hours), and the amount of time reduced from the pre-reduction required time (for example, −4 hours) are displayed according to the content of the time reduction function set as described above.

Further, as illustrated in FIG. 15C, a dispatch operation portion 177 denoted by “Dispatch” and a cancel operation portion 178 denoted by “Cancel” are displayed in the formation screen 170.

When the cancel operation portion 178 is operated by the player, the content displayed on the formation screen 170 immediately before the operation is discarded. In addition, the display of the formation screen 170 ends, and the dispatch destination selection screen 100 (FIG. 7B) is displayed on the display 26.

When the power of the party is less than the required power, the dispatch operation portion 177 is displayed in an inoperable state on the formation screen 170 as illustrated in FIG. 13A. On the other hand, when the power of the party is equal to or greater than the required power, the dispatch operation portion 177 is displayed in an operable state on the formation screen 170 as illustrated in FIGS. 13B, 13C, 14A, 14B, 15A, and 15C.

As illustrated in FIG. 15C, when the use of the time reduction function is set and the dispatch operation portion 177 in an operable state in the formation screen 170 is operated by the player, the confirmation screen 190 (FIG. 16A) is displayed on the display 26. In a case where the use of the time reduction function is not set and the dispatch operation portion 177 in an operable state in the formation screen 170 is operated by the player, the confirmation screen 190 (FIG. 16A) is not displayed on the display 26, and the expedition start animation screen 200 (FIG. 16B) described below is displayed on the display 26 for a predetermined amount of time to notify the player of the start of the expedition game.

FIG. 16A is a diagram for describing an example of the confirmation screen 190. As illustrated in FIG. 16A, on the confirmation screen 190, the player is notified that time reduction tickets and jewels will be spent by using the time reduction function.

In the case illustrated in FIG. 16A, the required time required for one dispatch to the “Dispatch destination A-1” is 1 hour and 30 minutes and the number of dispatches is set to 4, making the total required time displayed 6 hours. The expedition time being reduced by 4 hours by using the time reduction function is displayed. When the expedition game is started under this condition, the first two dispatches are immediately completed by the time reduction function. Then, the third dispatch is reduced by 1 hour, and the remaining required time becomes 30 minutes. In addition, the required time for the fourth dispatch is not reduced and is 1 hour and 30 minutes. That is, when the time reduction function is used, the time is reduced in ascending order of the order the dispatches that are repeatedly executed.

Further, as illustrated in FIG. 16A, an OK operation portion 191 denoted by “OK” and a cancel operation portion 192 denoted by “Cancel” are displayed in the confirmation screen 190. When the cancel operation portion 192 is operated by the player, the display of the confirmation screen 190 is finished, and the formation screen 170 (FIG. 15C) displayed immediately before the operation of the dispatch operation portion 177 is displayed on the display 26.

When the OK operation portion 191 is operated by the player, the expedition game is started. Then, the expedition start animation screen 200 (FIG. 16B) described below is displayed on the display 26 for a predetermined amount of time, and the player is notified of the start of the expedition game.

FIG. 16B is a diagram for describing an example of the expedition start animation screen 200. As illustrated in FIG. 16B, a predetermined animation image for notifying the player that the expedition game has started is displayed for a predetermined amount of time (for example, 3 seconds) on the expedition start animation screen 200. The ally characters to be dispatched in the expedition are displayed on the expedition start animation screen 200. Specifically, for example, all of the ally characters in the party or a predetermined number of ally characters from among the ally characters in the party are displayed on the expedition start animation screen 200.

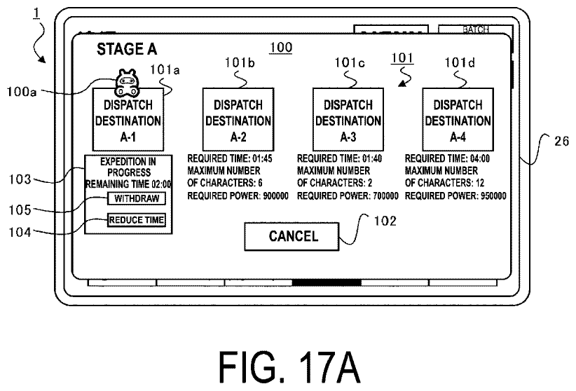

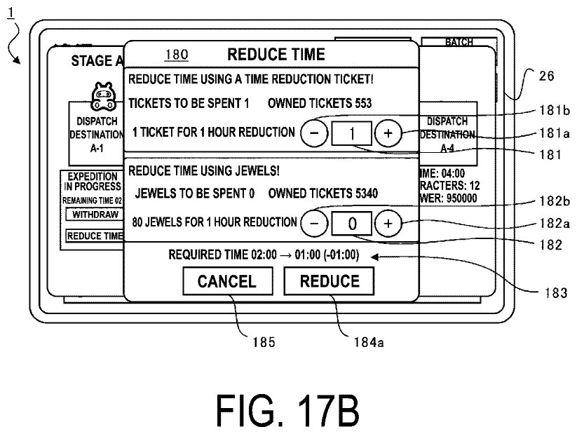

When a predetermined amount of time (for example, 3 seconds) has elapsed, the display of the expedition start animation screen 200 on the display 26 ends. Then, in a case where use of the time reduction function is set for the started expedition game, the time reduction animation screen 210 illustrated in FIG. 16C described below is displayed on the display 26 for a predetermined amount of time. In a case where use of the time reduction function is not set for the started expedition game, the dispatch destination selection screen 100 illustrated in FIG. 17A described below is displayed on the display 26.

FIG. 16C is a diagram for describing an example of the time reduction animation screen 210. As illustrated in FIG. 16C, a predetermined animation image for notifying the player that the time reduction function has been used for the started expedition game is displayed on the time reduction animation screen 210 for a predetermined amount of time (for example, 3 seconds).

When a predetermined amount of time (for example, 3 seconds) has elapsed, the display of the time reduction animation screen 210 on the display 26 ends. Then, the dispatch destination selection screen 100 illustrated in FIG. 17A described below is displayed on the display 26.

FIG. 17A is a diagram for describing an example of the dispatch destination selection screen 100 during execution of the expedition game. FIG. 17B is a diagram illustrating an example of the time reduction screen 180 during execution of the expedition game. As illustrated in FIG. 17A an in-expedition display 103 is displayed on the dispatch destination selection screen 100 during execution of the expedition game at a lower portion of the dispatch destination selection operation portion 101 corresponding to the dispatch destination during execution of the expedition game.

Also, as illustrated in FIG. 17A a representative character 100a is displayed on the dispatch destination selection screen 100 during execution of the expedition game in the dispatch destination selection operation portion 101 corresponding to the dispatch destination during execution of the expedition game. In the present embodiment, when the party to be dispatched to a dispatch destination is formed, an ally character D is displayed on the formation screen 170 as the representative character 100a. However, the present invention is not limited thereto, and when a party to be dispatched to a dispatch destination is formed, the ally character having the highest power from among the ally characters in the party may be displayed as the representative character 100a.

FIG. 17A illustrates a case where a party is dispatched to “Dispatch destination A-1” and an expedition game is executed. In this case, the in-expedition display 103 is displayed at a lower portion of the first dispatch destination selection operation portion 101a.

As illustrated in FIG. 17A, the remaining time until completion of the “Dispatch destination A-1” during execution of the expedition game is displayed in the in-expedition display 103. In the illustrated example, the remaining time displayed is 2 hours.

As addition, as illustrated in FIG. 17A, a time reduction operation portion 104 denoted by “Reduce time” and a withdraw operation portion 105 denoted by “Withdraw” are displayed in the in-expedition display 103. As described above, in the present embodiment, the player can reduce the remaining time of the required time by using the time reduction function when dispatching a party to the dispatch destination. Further, in the present embodiment, the time reduction function can be used even after the start of execution of the expedition game. When the time reduction operation portion 104 is tapped by the player, the time reduction screen 180 (FIG. 17B) is displayed on the display 26. The time reduction screen 180 of FIG. 17B has the same function as the time reduction screen 180 of FIG. 15B described above.

In other words, as illustrated in FIG. 17B, the reduction number display portion 181, the increase reduction number operation portion 181a, and the decrease reduction number operation portion 181b relating to the first time reduction function of reducing the remaining time of the required time of the expedition game after the start of execution using a time reduction ticket owned by the player are displayed on the time reduction screen 180.

The number of time reduction ticket to be spent is displayed in the reduction number display portion 181. When the player operates the increase reduction number operation portion 181a, the number of time reduction ticket to be spent increases by one, and the display of the reduction number display portion 181 is updated. When the player operates the decrease reduction number operation portion 181b, the number of time reduction ticket to be spent decreases by one, and the display of the reduction number display portion 181 is updated.

Also, as illustrated in FIG. 17B, the reduction number display portion 182, the increase reduction number operation portion 182a, and the decrease reduction number operation portion 182b relating to the second time reduction function of reducing the remaining time of the required time of the expedition game after the start of execution using jewels owned by the player are displayed on the time reduction screen 180.

The number of times a predetermined number of jewels is to be spent is displayed in the reduction number display portion 182. When the player operates the increase reduction number operation portion 182a, the number of times to spend a predetermined number of jewels increases by one, and the display of the reduction number display portion 182 is updated. When the player operates the decrease reduction number operation portion 182b, the number of times to spend a predetermined number of jewels decreases by one, and the display of the reduction number display portion 182 is updated.

A required time display portion 183 is displayed on the time reduction screen 180. As illustrated in FIG. 17B, when the player has input to spend a time reduction ticket and not spend the predetermined number of jewels, the remaining time of the pre-reduction required time (for example, 2 hours), the remaining time of the post-reduction required time (for example, 1 hour), and the amount of time reduced from the remaining time of the pre-reduction required time (for example, −1 hour) are displayed on the required time display portion 183.

Further, as illustrated in FIG. 17B, a reduction operation portion 184a denoted by “Reduce” and the cancel operation portion 185 denoted by “Cancel” are displayed in the time reduction screen 180.

When the cancel operation portion 185 of the time reduction screen 180 is operated by the player, the content displayed on the time reduction screen 180 immediately before the operation is discarded. In addition, the display of the time reduction screen 180 ends, and the dispatch destination selection screen 100 (FIG. 17A) is displayed on the display 26.

When the reduction operation portion 184a is operated by the player, the confirmation screen 220 (FIG. 18A) for the player to confirm use of the time reduction function is displayed with the content displayed on the time reduction screen 180 immediately before the operation. FIG. 18A is a diagram for describing an example of the confirmation screen 220 for the player to confirm use of the reduction function during execution of the expedition game.

As illustrated in FIG. 18A, on the confirmation screen 220, the player is notified that time reduction tickets and jewels will be spent by using the time reduction function.

Further, as illustrated in FIG. 18A, a reduction operation portion 221 denoted by “Reduce” and a cancel operation portion 222 denoted by “Cancel” are displayed in the confirmation screen 220. When the cancel operation portion 222 is operated by the player, the display of the confirmation screen 190 is finished, and time reduction screen 180 (FIG. 17B) displayed immediately before the operation of the reduction operation portion 184a is displayed on the display 26.

In addition, when the player operates the reduction operation portion 221, the reduction function is used, and the time reduction animation screen 210 illustrated in the above-described FIG. 16C is displayed on the display 26 for a predetermined amount of time. When a predetermined amount of time has elapsed, the display of the time reduction animation screen 210 on the display 26 ends. Then, the dispatch destination selection screen 100 illustrated in FIG. 18B described below is displayed on the display 26.

FIG. 18B is a diagram for describing an example of the dispatch destination selection screen 100 in a case where the reduction function is used during execution of the expedition game. As illustrated in FIG. 18B, the remaining time until completion of the “Dispatch destination A-1” during execution of the expedition game is displayed in the in-expedition display 103 of the dispatch destination selection screen 100. In the illustrated example, the remaining time is reduced by 1 hour by the reduction function and the remaining time displayed is 1 hour.

As described above, in the present embodiment, the same ally character cannot be put in a party for a plurality of dispatch destinations. That is, in a case where a predetermined ally character is dispatched to the expedition game being executed, the predetermined ally character cannot be dispatched to another dispatch destination. Thus, in the present embodiment, a withdraw function is provided that allows the player to withdraw the party from the expedition game being executed and cancel the expedition game being executed. By using the withdraw function, a predetermined ally character desired by the player can be dispatched to another dispatch destination.

As illustrated in FIG. 18B, the withdraw operation portion 105 denoted by “Withdraw” is displayed in the in-expedition display 103 of the dispatch destination selection screen 100. When the player operates the withdraw operation portion 105, the withdraw confirmation screen 230 (FIG. 19A) for the player to confirm use of the withdraw function is displayed on the display 26.

FIG. 19A is a diagram for describing an example of the withdraw confirmation screen 230. As illustrated in FIG. 19A, in the withdraw confirmation screen 230, the player is notified that the reward of the uncompleted expedition game cannot be obtained, the remaining time of the required time will be reset, and the time reduction ticket or jewels used for time reduction will not be returned, in a case where the withdraw function is used. In a case where the withdraw function is used when the repeat dispatch function has been used and a plurality of dispatches to the dispatch destination has been set, the player can receive a reward relating to the expedition game for the number of completed dispatches from among the plurality of dispatches.

As illustrated in FIG. 19A, on the withdraw confirmation screen 230, a cancel operation portion 231 denoted by “Cancel” and an OK operation portion 232 denoted by “OK” are displayed. When the cancel operation portion 231 is operated by the player, the withdraw function is not used and the display of the withdraw confirmation screen 230 is ended. Then, the dispatch destination selection screen 100 (FIG. 18B) is displayed again on the display 26.

When the OK operation portion 232 is operated by the player, the withdraw function is used. When the OK operation portion 232 is operated by the player, the expedition withdraw screen 240 (FIG. 19B) is displayed on the display 26.

FIG. 19B is a diagram for describing an example of the expedition withdraw screen 240. As illustrated in FIG. 19B the player is notified in the expedition withdraw screen 240 that the player has withdrawn from the dispatch destination of the type corresponding to the withdraw operation portion 105 (FIG. 18B) operated by the player. In FIG. 19B, the player is notified of the withdrawal from “Dispatch destination A-1”.

Further, as illustrated in FIG. 19B, a close operation portion 241 denoted by “Close” is displayed on the expedition withdraw screen 240. When the player operates the close operation portion 241, the display of the expedition withdraw screen 240 is ended, and the dispatch destination selection screen 100 (FIG. 7B) is displayed on the display 26. On the dispatch destination selection screen 100 displayed at this time, the in-expedition display 103 (FIG. 17A) corresponding to the withdrawn dispatch destination is not displayed.

In addition, when the required time elapses without use of the withdraw function, the expedition game is completed. FIG. 20A is a diagram for describing an example of the dispatch destination selection screen 100 when an expedition is completed. FIG. 20A illustrates a case where “Dispatch destination A-1” is completed.

As illustrated in FIG. 20A, on the dispatch destination selection screen 100, an expedition completion display 106 is displayed at the lower portion of the dispatch destination selection operation portion 101 corresponding to the completed dispatch destination. In addition, as illustrated in FIG. 20A, a result confirmation operation portion 107 denoted by “Check results” is displayed in the expedition completion display 106. When the result confirmation operation portion 107 is operated by the player, the expedition completion screen 250 (FIG. 20B) is displayed on the display 26.

FIG. 20B is a diagram for describing an example of the expedition completion screen 250. As illustrated in FIG. 20B, on the expedition completion screen 250, a list of rewards obtained at the dispatch destination of the type corresponding to the result confirmation operation portion 107 (FIG. 20A) operated by the player is displayed. In addition, when the expedition completion screen 250 is displayed, the player can complete reception of the reward obtained at the dispatch destination. FIG. 20B illustrates a case where a list of the rewards obtained by completion of “Dispatch destination A-1” are displayed.

In addition, as illustrated in FIG. 20B, a non-redispatch operation portion 251 denoted by “No redispatch” and a redispatch operation portion 252 denoted by “Redispatch” are displayed on the expedition completion screen 250. When the player taps the non-redispatch operation portion 251, the display of the expedition completion screen 250 is ended, and the dispatch destination selection screen 100 (FIG. 7B) is displayed on the display 26. That is, since the player has received the reward obtained by completing “Dispatch destination A-1”, the expedition completion display 106 (FIG. 20A) is hidden.

When the player operates the redispatch operation portion 252, the redispatch screen 260 (FIG. 21) for redispatching a party of the same formation to the same dispatch destination is displayed on the display 26.

FIG. 21 is a diagram for describing an example of the redispatch screen 260. As illustrated in FIG. 21, a dispatch destination display portion 261 is displayed on the redispatch screen 260. In the dispatch destination display portion 261, the type of dispatch destination (here, Dispatch destination A-1”) and the play conditions (required power, maximum number of characters, required time) corresponding to the type of dispatch destination are displayed.

As illustrated in FIG. 21, a party display portion 262 is displayed in the dispatch destination display portion 261. In the party display portion 262, the same formation of ally characters as the party previously dispatched to the dispatch destination is displayed. Note that the party display portion 262 may display at least a part of all of the ally characters put in the party.

Further, in the present embodiment, the repeat dispatch function can be used on the redispatch screen 260. In the present embodiment, in the case illustrated on the redispatch screen 260, the repeat dispatch function can be used but the time reduction function cannot be used. However, the present invention is not limited thereto, and both the repeat dispatch function and the time reduction function may be enabled on the redispatch screen 260.

As illustrated in FIG. 21, a number of repeated dispatches display portion 264, an increase number of repeated dispatches operation portion 264a, and a decrease number of repeated dispatches operation portion 264b are displayed in the dispatch destination display portion 261.

The currently set number of dispatches is displayed in the number of repeated dispatches display portion 264. When the player operates the increase number of repeated dispatches operation portion 264a, the number of dispatches is increased by one, and the display of the number of repeated dispatches display portion 264 is updated. When the player operates the decrease number of repeated dispatches operation portion 264b, the number of dispatches is decreased by one, and the display of the number of repeated dispatches display portion 264 is updated. In the present embodiment, the minimum value of the number of dispatches displayed in the number of repeated dispatches display portion 264 is one.

As illustrated in FIG. 21, on the redispatch screen 260, a cancel operation portion 265 denoted by “Cancel” and a dispatch operation portion 266 denoted by “Dispatch” are displayed. When the cancel operation portion 265 is operated by the player, the content displayed on the redispatch screen 260 immediately before the operation is discarded. In addition, the display of the redispatch screen 260 is ended, and the expedition completion screen 250 (FIG. 20B) displayed immediately before the operation of the redispatch operation portion 252 (FIG. 20B) is displayed on the display 26.

When the dispatch operation portion 266 is operated by the player, the expedition game is started. Then, the expedition start animation screen 200 (FIG. 16B) described above is displayed on the display 26 for a predetermined amount of time, and the player is notified of the start of the expedition game. When the predetermined amount of time has elapsed, the display of the expedition start animation screen 200 (FIG. 16B) on the display 26 ends, and the dispatch destination selection screen 100 (FIG. 17A) is displayed on the display 26.

FIG. 22A is a diagram for describing an example of the expedition top screen 90 when an expedition is completed. As illustrated in FIG. 22A, when there is an expedition game for which reception of a reward has not been completed or an expedition game that is being executed, the representative character 100a is displayed in the expedition stage selection operation portion 91 corresponding to the stage to which the dispatch destination belongs.

FIG. 22A illustrates a case where “Dispatch destination A-1” and “Dispatch destination A-2” is completed. When the expedition collective completion operation portion 95 is operated by the player, the expedition collective completion screen 270 (FIG. 22B) is displayed on the display 26. When there is one or more expedition games for which the reception of a reward has not been completed, an identification display indicating that there is one or more expedition games for which the reception of a reward has not been completed may be displayed in the in-expedition PT selection operation portion 94 or the expedition collective completion operation portion 95. Specifically, a number indicating the number of expedition games for which the reception of a reward has not been completed may be displayed as the identification display. Alternatively, specifically, a symbol indicating that there is an expedition game for which the reception of a reward has not been completed may be displayed as the identification display.

As described above, when the expedition collective completion operation portion 95 is operated by the player, the expedition collective completion screen 270 (FIG. 22B) is displayed on the display 26. FIG. 22B is a diagram for describing an example of the expedition collective completion screen 270. As illustrated in FIG. 22B, in the expedition collective completion screen 270, a list of rewards obtained at all dispatch destinations for which the required time has elapsed, the expedition game has been completed, and reception of a reward has not been completed is displayed.

In addition, when the expedition collective completion screen 270 is displayed, the player can complete reception of the rewards obtained at the dispatch destinations. FIG. 22B illustrates a case where a list of the rewards obtained by completion of “Dispatch destination A-1” and “Dispatch destination A-2” are displayed.

In addition, as illustrated in FIG. 22B, a non-redispatch operation portion 271 denoted by “No redispatch” and a redispatch operation portion 272 denoted by “Redispatch” are displayed on the expedition collective completion screen 270. When the player taps the non-redispatch operation portion 271, the display of the expedition completion screen 250 is ended, and the expedition top screen 90 (FIG. 7A) is displayed on the display 26. That is, since the player has received the reward obtained by completing “Dispatch destination A-1” and “Dispatch destination A-2”, the representative character 100a (FIG. 22A) is hidden.

When the player operates the redispatch operation portion 272, the redispatch screen 280 (FIG. 23) for redispatching a party of the same formation to the same dispatch destination is displayed on the display 26.

FIG. 23 is a diagram for describing an example of the redispatch screen 280. As illustrated in FIG. 23, a dispatch destination display portion 281 is displayed for each dispatch destination type on the redispatch screen 280. In the dispatch destination display portion 281, the type of dispatch destination and the play conditions (required power, maximum number of characters, required time) corresponding to the type of dispatch destination are displayed.

As illustrated in FIG. 23, a party display portion 282 is displayed in the dispatch destination display portion 281. In the party display portion 282, the same formation of ally characters as the party previously dispatched to the dispatch destination is displayed. Note that the party display portion 282 may display at least a part of all of the ally characters put in the party.

As illustrated in FIG. 23, a check box 283 is displayed in the dispatch destination display portion 281. By operating the check box 283, the player can switch whether to redispatch to the dispatch destination of the type corresponding to the check box 283.

Further, in the present embodiment, the repeat dispatch function can be used on the redispatch screen 280. In the present embodiment, in the case illustrated on the redispatch screen 280, the repeat dispatch function can be used but the time reduction function cannot be used. However, while not limited thereto, and both the repeat dispatch function and the time reduction function may be enabled on the redispatch screen 280.

As illustrated in FIG. 23, a number of repeated dispatches display portion 284, an increase number of repeated dispatches operation portion 284a, and a decrease number of repeated dispatches operation portion 284b are displayed in the dispatch destination display portion 281.

The currently set number of dispatches is displayed in the number of repeated dispatches display portion 284. When the player operates the increase number of repeated dispatches operation portion 284a, the number of dispatches is increased by one, and the display of the number of repeated dispatches display portion 284 is updated. When the player operates the decrease number of repeated dispatches operation portion 284b, the number of dispatches is decreased by one, and the display of the number of repeated dispatches display portion 284 is updated. In the present embodiment, the minimum value of the number of dispatches displayed in the number of repeated dispatches display portion 284 is one.

As illustrated in FIG. 23, on the redispatch screen 280, a cancel operation portion 285 denoted by “Cancel” and a dispatch operation portion 286 denoted by “Dispatch” are displayed. When the cancel operation portion 285 is operated by the player, the content displayed on the redispatch screen 280 immediately before the operation is discarded. In addition, the display of the redispatch screen 280 is ended, and the expedition collective completion screen 270 (FIG. 22B) displayed immediately before the operation of the redispatch operation portion 272 (FIG. 22B) is displayed on the display 26.

When the dispatch operation portion 286 is operated by the player, the expedition game is started. Then, the expedition start animation screen 200 (FIG. 16B) described above is displayed on the display 26 for a predetermined amount of time, and the player is notified of the start of the expedition game. When the predetermined amount of time has elapsed, the display of the expedition start animation screen 200 (FIG. 16B) on the display 26 ends, and the expedition top screen 90 (FIG. 22A) is displayed on the display 26.

As described above, in the present embodiment, parties can be dispatched to a plurality of dispatch destinations. Specifically, by repeating a series of operations including selecting a desired dispatch destination on the dispatch destination selection screen 100 (FIG. 7B), forming a party on the formation screen 170 (FIGS. 13A and 13B), and operating the dispatch operation portion 177, a party can be dispatched to each one of a plurality of dispatch destinations. However, with the above-described method, when dispatching a party to each one of a large number of dispatch destinations, the player operations become complicated. Thus, player-friendliness may be reduced.

In the present embodiment, a batch expedition function is provided as a function for facilitating the dispatch of parties to each one of a plurality of dispatch destinations. In the upper portion of the expedition top screen 90 (FIG. 7A), the batch expedition selection operation portion 93 is displayed. When the player operates the batch expedition selection operation portion 93, the batch expedition screen 290 (FIG. 24A) for using the batch expedition function is displayed on the display 26.

FIG. 24A is a first diagram for describing an example of the batch expedition screen 290. Also, FIG. 24B is a second diagram for describing an example of the batch expedition screen 290. As illustrated in FIG. 24A, one or more dispatch destination display portions 291 corresponding to the types of dispatch destinations are displayed in a central portion of the batch expedition screen 290. In the initial state, the dispatch destination display portions 291 corresponding to all the dispatch destination types are displayed on the batch expedition screen 290.

In the dispatch destination display portion 291, the player can form a party to be dispatched to each dispatch destination. A manual formation operation portion 292 denoted by “Form manually” and an automatic formation operation portion 293 denoted by “Form automatically” are displayed in the dispatch destination display portion 291. When the player operates the manual formation operation portion 292, a formation screen (not illustrated) for batch expedition is displayed on the display 26. On the formation screen (not illustrated) for the batch expedition, the party formation can be set based on a player operation. The displayed content and functions of the formation screen (not illustrated) for the batch expedition can be similar to those of the formation screen 170.

When the automatic formation operation portion 293 is operated by the player, the automatic formation function (the first automatic formation function or the second automatic formation function) of the type set by the player on the automatic formation setting screen 160 (FIGS. 12A and 12B) is used, and the party is automatically formed.

The dispatch destination display portion 291 is provided with a special drop item target display portion 294. When the party is formed as described above, the ally character set as the special item drop target that can obtain a special item is displayed in the special drop item target display portion 294 as illustrated in FIG. 24B.

Further, in the present embodiment, the repeat dispatch function can be used on the batch expedition screen 290. As illustrated in FIG. 24A, a number of repeated dispatches display portion 295, an increase number of repeated dispatches operation portion 295a, and a decrease number of repeated dispatches operation portion 295b are displayed in the dispatch destination display portion 291.

The currently set number of dispatches is displayed in the number of repeated dispatches display portion 295. When the player operates the increase number of repeated dispatches operation portion 295a, the number of dispatches is increased by one, and the display of the number of repeated dispatches display portion 295 is updated. When the player operates the decrease number of repeated dispatches operation portion 295b, the number of dispatches is decreased by one, and the display of the number of repeated dispatches display portion 295 is updated. In the present embodiment, the minimum value of the number of dispatches displayed in the number of repeated dispatches display portion 295 is one.

Further, in the present embodiment, the time reduction function can be used on the batch expedition screen 290. As illustrated in FIG. 24A, a time reduction operation portion 296 denoted by “Reduce time” is displayed in the dispatch destination display portion 291.

When the player operates (taps) the time reduction operation portion 296, a time reduction screen (not illustrated) for the batch expedition is displayed on the display 26. On the time reduction screen (not illustrated) for the batch expedition, it is possible to set the details of the time reduction function based on a player operation. The displayed content and functions of the time reduction screen (not illustrated) for the batch expedition can be similar to those of the time reduction screen 180.

As illustrated in FIG. 24A, a clear operation portion 297 denoted by “Clear” is displayed in the dispatch destination display portion 291. When the player operates the clear operation portion 297, the party content for the dispatch destination of the type corresponding to the operated clear operation portion 297 is discarded. Further, the ally characters displayed in the special drop item target display portion 294 are hidden.

As illustrated in FIG. 24A, a party clear operation portion 298 denoted by “Clear parties” is displayed in the batch expedition screen 290. When the party clear operation portion 298 is operated by the player, the party contents for all the dispatch destinations being displayed on the batch expedition screen 290 are discarded. Further, the ally characters displayed in the special drop item target display portion 294 are hidden.

As illustrated in FIG. 24A, a check box 299 is displayed in the dispatch destination display portion 291. By operating the check box 299, the player can switch whether to dispatch to the dispatch destination of the type corresponding to the check box 299.

As addition, as illustrated in FIG. 24A, a remove all checks operation portion 300 denoted by “Remove all checks” is displayed in the batch expedition screen 290. When the player operates the remove all checks operation portion 300, all the checks in the check boxes 299 displayed on the batch expedition screen 290 are removed.

Further, as illustrated in FIG. 24A, a priority setting operation portion 301 denoted by “Priority settings” is displayed on the batch expedition screen 290. When the priority setting operation portion 301 is operated by the player, the priority setting screen 130 (FIG. 9B) described above is displayed on the display 26. When the priority is set on the priority setting screen 130, the display of the priority setting screen 130 ends, and the batch expedition screen 290 is displayed on the display 26.

Further, as illustrated in FIG. 24A, a first filter display operation portion 302 for filtering the dispatch destination display portions 291 displayed on the batch expedition screen 290 is displayed on the batch expedition screen 290.

When the first filter display operation portion 302 is tapped by the player, filtering according to the type of dispatch destination can be performed. For example, a filtered display may be performed for each stage to which the dispatch destinations belong. Further, for example, the types of dispatch destinations include a normal dispatch destination which can be always selected by the player and a first special dispatch destination and a second special dispatch destination which can be selected only when a preset appearance condition is satisfied, as described above. For example, for the first special dispatch destination, when a predetermined item set in advance is used, the appearance condition is satisfied and the player can dispatch a party. In addition, for the second special dispatch destination, when the player completes the expedition game and receives a reward, a lottery is executed. If the lottery is a success, the appearance condition is satisfied and the player can dispatch a party. In addition, only the normal dispatch destinations being displayed after filtering, only the first special dispatch destinations being displayed after filtering, and only the second special dispatch destinations being displayed after filtering may be switchable.

Further, as illustrated in FIG. 24A, a second filter display operation portion 303 for filtering the dispatch destination display portions 291 displayed on the batch expedition screen 290 is displayed on the batch expedition screen 290.

By tapping the second filter display operation portion 303, the player can switch between a filtered display of displaying only the dispatch destinations with the check box 299 checked and a display of all types of dispatch destinations regardless of whether the check box 299 is checked.

In addition, as illustrated in FIG. 24A, a search tab 304 is displayed on the batch expedition screen 290. In the search tab 304, a search operation portion 304a denoted by “Search” and three item selection fields 304b are displayed. When any one of the item selection fields 304b is operated by the player, an item selection screen (not illustrated) is displayed on the display 26. On the item selection screen (not illustrated), the player can select up to three desired items (EX equipment and normal items).

In addition, for example, in the expedition game, when a campaign is active, only the dispatch destinations corresponding to the active campaign may be displayed via filtering. The campaign may be held over a preset period (for example, 10 days). In addition, a predetermined icon indicating that the dispatch destination is applicable to the campaign may be displayed on the dispatch destination display portion 291 of the dispatch destination applicable to the campaign. Note that the content of the campaign is not particularly limited. For example, the campaign may be a campaign that gives a bonus to the required time reduced when the party exceeds the required power or a campaign that increases the reward given to the player when the expedition game is completed. For example, in a case where a plurality of types of campaigns are held at the same time, a plurality of icons corresponding to the respective campaigns may be displayed in the dispatch destination display portions 291. Note that, in a case where the campaign was being held at the time when the expedition game is started but the campaign had ended at the time when the expedition game is completed, the campaign may be applied to the expedition game. Alternatively, in a case where the campaign was being held at the time when the expedition game is started but the campaign had ended at the time when the expedition game is completed, the campaign need not be applied to the expedition game.

On the item selection screen (not illustrated), the item selected by the player is displayed in the item selection field 304b. Then, when the player operates the search operation portion 304a in a state where an item is displayed in the item selection field 304b, the dispatch destination display portions 291 corresponding to the dispatch destinations where the item displayed in the item selection field 304b can be obtained are displayed in a list on the batch expedition screen 290.

Further, in the present embodiment, the content being displayed on the batch expedition screen 290 is stored in association with a preset. As illustrated in FIG. 24A, a preset switching operation portion 305 is displayed in an upper portion of the batch expedition screen 290. In the present embodiment, nine presets are prepared in total. When the preset switching operation portion 305 is operated by the player, the batch expedition screen 290 with the contents stored in association with the operated preset is displayed on the display 26. Thus, it is possible to improve player-friendliness.

In addition, as illustrated in FIG. 24A, a cancel operation portion 306 denoted by “Cancel” is displayed on the batch expedition screen 290. When the player operates the cancel operation portion 306, the display of the batch expedition screen 290 is ended, and the expedition top screen 90 (FIG. 7A) is displayed on the display 26.

In addition, as illustrated in FIGS. 24A and 24B, a batch expedition operation portion 307 denoted by “Batch expedition” is displayed on the batch expedition screen 290. As illustrated in FIG. 24A, in a case where none of the check boxes 299 of the dispatch destination display portions 291 displayed on the batch expedition screen 290 are checked, the batch expedition operation portion 307 is displayed in an inoperable state. Also, when the power of the party formed in the dispatch destination display portion 291 in which a check is input in the check box 299 is less than the required power set for the corresponding dispatch destination, the batch expedition operation portion 307 is displayed in an inoperable state.

On the other hand, when the power of the party formed in the dispatch destination display portion 291 in which a check is input in the check box 299 is equal to or greater than the required power set for the corresponding dispatch destination, the batch expedition operation portion 307 is displayed in an operable state as illustrated in FIG. 24B. Then, when the player operates the batch expedition operation portion 307 in an operable state, the batch expedition confirmation screen 310 (FIG. 25) is displayed on the display 26.

FIG. 25 is a diagram for describing an example of the batch expedition confirmation screen 310. On the batch expedition confirmation screen 310, when the use of the time reduction function is set on the batch expedition screen 290, the player is notified that the time reduction ticket or jewels will be spent. In addition, the batch expedition confirmation screen 310 notifies the player of various setting content for each dispatch destination for which a check is input in the check box 299 of the batch expedition screen 290. Note that in a case where the use of the time reduction function is not set, the batch expedition screen 290 notifies the player of only various setting content for each dispatch destination for which a check is input in the check box 299 of the batch expedition screen 290, since a time reduction ticket and jewels will not be spent.

In addition, as illustrated in FIG. 25, a cancel operation portion 311 denoted by “Cancel” is displayed on the batch expedition confirmation screen 310. When the cancel operation portion 311 is operated by the player, the display of the batch expedition confirmation screen 310 is ended, and the batch expedition screen 290 (FIG. 24B) displayed immediately before the batch expedition confirmation screen 310 is displayed on the display 26.

In addition, as illustrated in FIG. 25, a batch expedition operation portion 312 denoted by “Batch expedition” is displayed on the batch expedition confirmation screen 310. When the batch expedition operation portion 312 is operated by the player, the expedition game is started. Then, the expedition start animation screen 200 (FIG. 16B) is displayed on the display 26 for a predetermined amount of time, and the player is notified of the start of the expedition game. The ally characters to be dispatched in the expedition are displayed on the expedition start animation screen 200. Specifically, for example, all of the ally characters in the party or a predetermined number of ally characters from among the ally characters in the party are displayed on the expedition start animation screen 200. For example, in a case where a party is dispatched to each of five dispatch destinations using the batch expedition function, one or more or all of the ally characters belonging to the five parties are displayed on the expedition start animation screen 200. That is, it can be said that the number of predetermined characters displayed on the expedition start animation screen 200 increases as the number of dispatch destinations selected with the batch expedition function increases.

When a predetermined amount of time has elapsed, the display of the expedition start animation screen 200 on the display 26 ends.

Then, in a case where use of the time reduction function is set for the started expedition game, the time reduction animation screen 210 is displayed on the display 26 for a predetermined amount of time. In a case where use of the time reduction function is not set for the started expedition game, the expedition top screen 90 (FIG. 22A) is displayed on the display 26. Also, when a predetermined amount of time has elapsed, the display of the time reduction animation screen 210 on the display 26 ends. Then, the expedition top screen 90 (FIG. 22A) is displayed on the display 26.

In this manner, the player can comprehend the dispatch destination at which the item desired by the player can be obtained by simply selecting the desired item and operating the search operation portion 304a. For each displayed dispatch destination, by simply forming a party, selecting the number of dispatches, and checking the check box 299, it is possible to collectively start execution of the expedition game of the selected number of dispatches for the one or more checked dispatch destinations. Accordingly, it is possible to facilitate the collection of items and to save players trouble.

As described above, when the in-expedition PT selection operation portion 94 of the expedition top screen 90 (FIGS. 7A and 22A) is tapped (operated) by the player, the in-expedition party list screen 320 (FIG. 26A) is displayed on the display 26.

FIG. 26A is a diagram for describing an example of the in-expedition party list screen 320. Note that FIG. 26A illustrates a case in which the remaining time until the expedition game “Dispatch destination A-1” being executed is completed is 2 hours and “Dispatch destination A-2” is complete.

As illustrated in FIG. 26A, a dispatch destination display portion 321 is displayed on the in-expedition party list screen 320. In the dispatch destination display portion 321, the type of dispatch destination (in this example, “Dispatch destination A-1” and “Dispatch destination A-2”), whether the expedition game is in progress, and the remaining time of the required time for the expedition game from the start of execution are displayed. To be specific, in the dispatch destination display portion 321 corresponding to “Dispatch destination A-1”, it is displayed that the expedition game is in progress (expedition in progress) and that the remaining time until completion is two hours. Further, in the dispatch destination display portion 321 corresponding to “Dispatch destination A-2”, it is displayed that the expedition game has been completed (expedition complete).

As illustrated in FIG. 26A, a party display portion 322 is displayed in the dispatch destination display portion 321. In the party display portion 322, the same formation of ally characters as the party previously dispatched to the dispatch destination is displayed. Note that the party display portion 322 may display at least a portion of all of the ally characters put in the party.

As illustrated in FIG. 26A, a withdraw operation portion 323 denoted by “WITHDRAW” is displayed in the dispatch destination display portion 321. The function in a case where the withdraw operation portion 323 is operated by the player is similar to the function in a case where the withdraw operation portion 105 (FIG. 18B) described above is operated and thus will not be described.

As illustrated in FIG. 26A, a time reduction operation portion 324 denoted by “REDUCE TIME” is displayed in the dispatch destination display portion 321. The function in a case where the time reduction operation portion 324 is operated by the player is similar to the function in a case where the time reduction operation portion 104 (FIG. 17A) described above is operated and thus will not be described.

As illustrated in FIG. 26A, a result confirmation operation portion 325 denoted by “CHECK RESULTS” is displayed in the dispatch destination display portion 321. The function in a case where the result confirmation operation portion 325 is operated by the player is similar to the function in a case where the result confirmation operation portion 107 (FIG. 20A) described above is operated and thus will not be described.

As illustrated in FIG. 26A, in the present embodiment, the withdraw operation portion 323 and the time reduction operation portion 324 are displayed only in the dispatch destination display portion 321 corresponding to the expedition game (“Dispatch destination A-1”) being executed (expedition in progress). In other words, for an expedition game that has been completed (expedition complete), since there is no need to use the withdraw function and the time reduction function, the withdraw operation portion 323 and the time reduction operation portion 324 are not displayed in the dispatch destination display portion 321 corresponding to the completed (expedition complete) expedition game (“Dispatch destination A-2”). Accordingly, it is possible to reduce the possibility of unnecessary operation portions being displayed and of degrading animation.

Also, in the present embodiment, an add dispatch function is provided. The add dispatch function is a function for, after the fact, adding (summing) a number of dispatches to the number of dispatches set at the beginning of the execution of the expedition game in a period after the execution of the expedition game is started and before the completion of the expedition game. Accordingly, it is possible to start the expedition game without operating any of the dispatch destination selection operation portions 101 of the dispatch destination selection screen 100 (FIG. 7B) described above and setting the type of expedition game and party formation. This can improve player-friendliness. Further, as described above, the number of dispatches can be added (summed) after the fact more quickly than in the case where the repeat dispatch function is used on the redispatch screen 260 after waiting for the completion of the expedition game. In this case, it is possible to improve player-friendliness, since it is unnecessary to wait for the completion of the expedition game.

In the present embodiment, on the in-expedition party list screen 320, the add dispatch function can be used. As illustrated in FIG. 26A, in the dispatch destination display portion 321 corresponding to an in-progress (expedition in progress) expedition game (“Dispatch destination A-1”), an add number of dispatches display portion 326, an increase addition number of dispatches operation portion 326a, and a decrease addition number of dispatches operation portion 326b are displayed. In the dispatch destination display portion 321 corresponding to a completed (expedition complete) expedition game (“Dispatch destination A-2”), the add number of dispatches display portion 326, the increase addition number of dispatches operation portion 326a, and the decrease addition number of dispatches operation portion 326b are not displayed.

The add number of dispatches display portion 326 displays the number of dispatches to be added. When the player operates the increase addition number of dispatches operation portion 326a, the number of dispatches to be added is increased by one, and the display of the add number of dispatches display portion 326 is updated. When the player operates the decrease addition number of dispatches operation portion 326b, the number of dispatches to be added is decreased by one, and the display of the add number of dispatches display portion 326 is updated. In the present embodiment, the minimum value of the number of dispatches displayed in the add number of dispatches display portion 326 is one.

In addition, in the dispatch destination display portion 321 of the in-expedition party list screen 320, an add round operation portion 327 denoted by “ADD ROUND” and a close operation portion 328 denoted by “CLOSE” are displayed.

When the close operation portion 328 is operated by the player, the content displayed on the in-expedition party list screen 320 immediately before the operation is discarded. In addition, the display of the in-expedition party list screen 320 is ended, and the expedition top screen 90 (FIGS. 7A and 22A) displayed immediately before the operation of the in-expedition PT selection operation portion 94 (FIGS. 7A and 22A) is displayed on the display 26.

In addition, when the player operates the add round operation portion 327, the number of dispatches is added (summed) to the expedition game being executed. Then, an add round completion screen 330 (FIG. 26B) notifying the player that the number of dispatches has been added (summed) is displayed on the display 26. As described above, for example, in a case where a limit of ten times per day is placed on the execution of one type of expedition game, adding (summing) a number of dispatches can be performed with a number within a range that does not exceed that maximum number of times.

FIG. 26B is a diagram illustrating an example of the add round completion screen 330. As illustrated in FIG. 26B, in the add round completion screen 330, a message saying “a number of rounds has been added) is displayed to notify the player that a number of dispatches has been added (summed). As addition, as illustrated in FIG. 26B, in the add round completion screen 330, the type of dispatch destination that is the target of the addition (summation) of the number of dispatches, the number of dispatches added (summed), and the remaining time of the required time after the number of dispatches has been added (summed) are displayed.

In addition, as illustrated in FIG. 26B, in the add round completion screen 330, an OK operation portion 331 denoted by “OK” is displayed. When the OK operation portion 331 is operated by the player, the display of the add round completion screen 330 on the display 26 ends. Then, the in-expedition party list screen 320 is displayed on the display 26.

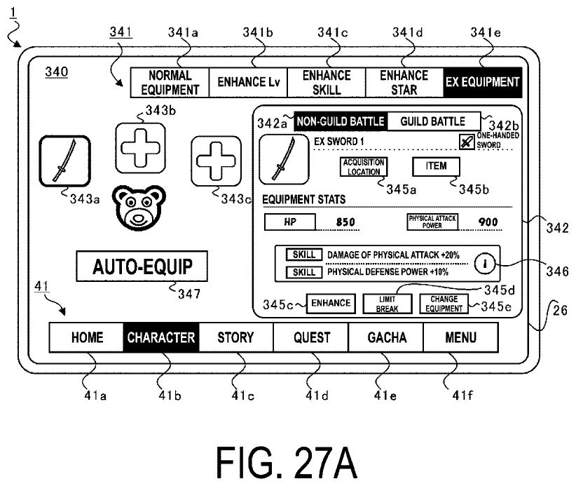

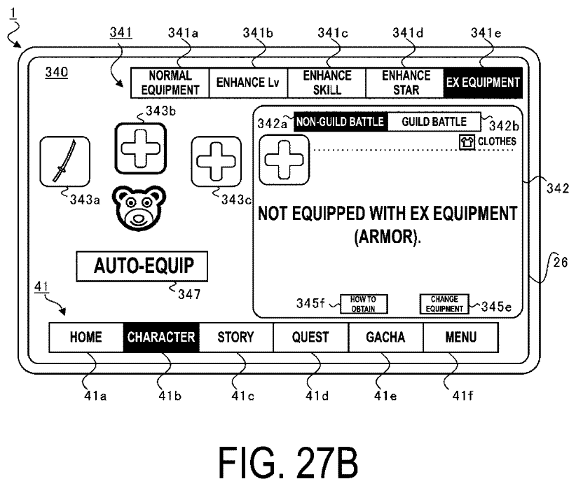

Next, the EX equipment described above according to the present embodiment will be described. When an image of an ally character displayed on the ally character confirmation screen 50 illustrated in FIG. 3B described above is tapped, an ally character details screen 340 corresponding to the tapped ally character is displayed on the display 26. FIG. 27A is a first diagram illustrating an example of the ally character details screen 340. FIG. 27B is a second diagram illustrating an example of the ally character details screen 340.

As illustrated in FIG. 27A, an enhance item selection operation portion 341 is displayed on the ally character details screen 340. The enhance item selection operation portion 341 is provided with a plurality of operation portions that can be operated by the player. The enhance item selection operation portion 341 is provided with a normal equipment selection operation portion 341a, an enhance Lv selection operation portion 341b, an enhance skill selection operation portion 341c, an enhance stars selection operation portion 341d, and an EX equipment selection operation portion 341e. When any one operation portion of the enhance item selection operation portion 341 is selected, the selected operation portion is highlighted. FIG. 27A illustrates a case where the EX equipment selection operation portion 341e has been operated.

As illustrated in FIG. 27A, a detailed display portion 342 is displayed on the ally character details screen 340. In the detailed display portion 342, a first operation portion 342a denoted by “NON-GUILD BATTLE” and a second operation portion 342b denoted by “GUILD BATTLE” are displayed.

In the present embodiment, it is possible to separately set the EX equipment (the EX equipment of a first setting frame) which is equipment that is enabled in battle games other than guild battles and the EX equipment (the EX equipment of a second setting frame) which is equipment that is enabled in battle games that are guild battles.

To be specific, when the first operation portion 342a of the detailed display portion 342 is operated by the player, it is possible to set the EX equipment (the EX equipment of the first setting frame) which is equipment that is enabled in battle games other than guild battles. That is, in battle games other than guild battles, the various parameters of the ally character are not changed (strengthened) based on the EX equipment set in the second setting frame, and the various parameters of the ally character are changed (strengthened) based on the EX equipment set in the first setting frame.

Also, when the second operation portion 342b of the detailed display portion 342 is operated by the player, it is possible to set the EX equipment (the EX equipment of the second setting frame) which is equipment that is enabled in battle games that are guild battles. FIG. 27A illustrates a case where the first operation portion 342a has been operated. That is, in battle games that are guild battles, the various parameters of the ally character are not changed (strengthened) based on the EX equipment set in the first setting frame, and the various parameters of the ally character are changed (strengthened) based on various EX equipment set in the second setting frame.

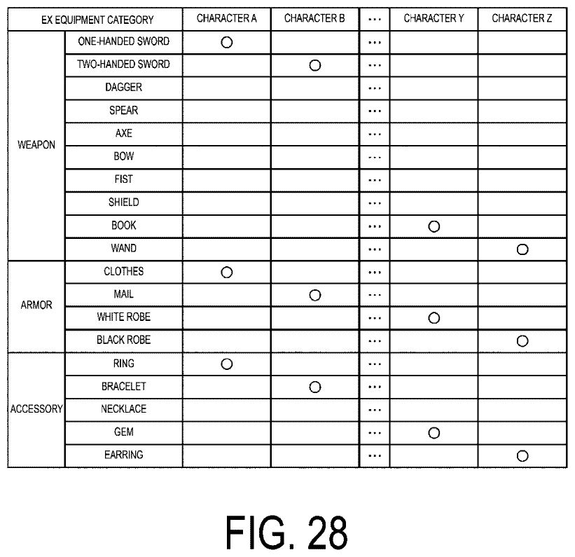

FIG. 28 is a diagram for describing categories of EX equipment. In the present embodiment, as illustrated in FIG. 28, the EX equipment is roughly classified into three major categories of “weapon”, “armor”, and “accessory”. Further, as illustrated in FIG. 28, each major category includes a plurality of minor categories of EX equipment.

Specifically, as illustrated in FIG. 28, EX equipment weapons are classified into a total of ten types of minor categories including “one-handed sword”, “two-handed sword”, “dagger”, “spear”, “axe”, “bow”, “fist”, “shield”, “book”, and “wand”.

Further, EX equipment armor is classified into a total of four types of minor categories including “clothes”, “mail”, “white robe”, and “black robe”.

Further, EX equipment accessories are classified into a total of five types of minor categories including “ring”, “bracelet”, “necklace”, “gem”, and “earring”.

Each of the minor categories includes a plurality of types having different rarities and various stats, that is, includes different types of EX equipment. It should be noted that different types of EX equipment refer to different pieces of ID information associated with the EX equipment. Further, as will be described in detail below, the EX equipment included in each minor category is classified into either normal EX equipment or special EX equipment. That is, the normal EX equipment and the special EX equipment are different from each other in terms of type and associated ID information.

In the present embodiment, for each type of character, that is, for each character ID, a piece of EX equipment from a minor category that can be equipped is set in advance for each main category.

Specifically, for example, as illustrated in FIG. 28, it is set that “Character A” can be equipped with EX equipment classified as “one-handed sword” for “weapon”, can be equipped with EX equipment classified as “clothes” for “armor”, and can be equipped with EX equipment classified as “ring” for “accessory”. That is, it is set that “Character A” cannot be equipped with EX equipment other than “one-handed sword” for “weapon”, cannot be equipped with EX equipment other than “clothes” for “armor”, and cannot be equipped with EX equipment other than “ring” for “accessory”.

Returning to FIG. 27A, an image of the ally character is displayed on the ally character details screen 340, and a first display frame 343a corresponding to “weapon”, a second display frame 343b corresponding to “armor”, and a third display frame 343c corresponding to “accessory” are displayed around the image of the ally character.

FIG. 27A illustrates a case where the ally character is equipped with an “EX sword 1” which is a “one-handed sword” as EX equipment for “weapon”. In this case, as illustrated in FIG. 27A, an icon image indicating the equipped EX equipment for “weapon” is displayed in the first display frame 343a.

In addition, FIG. 27A illustrates a case where the ally character is not equipped with EX equipment for “armor” and “accessory”. In this case, as illustrated in FIG. 27A, a mark indicated by “+” indicating that EX equipment is not equipped is displayed in the second display frame 343b and the third display frame 343c.

FIG. 27A illustrates a case where the first display frame 343a is operated by the player. In this case, various types of information related to the EX equipment in the first display frame 343a and various types of operation portions are displayed in the detailed display portion 342.

To be more specific, as illustrated in FIG. 27A, the detailed display portion 342 displays information such as the name of the equipped EX equipment in the first display frame 343a and the contents of various stats and skills set to the EX equipment.

As illustrated in FIG. 27A, the detailed display portion 342 displays, as operation portions, an acquisition location operation portion 345a denoted by “ACQUISITION LOCATION”, an item operation portion 345b denoted by “ITEM”, an enhance operation portion 345c denoted by “ENHANCE”, a limit break operation portion 345d denoted by “LIMIT BREAK”, and a change equipment operation portion 345e denoted by “CHANGE EQUIPMENT”.

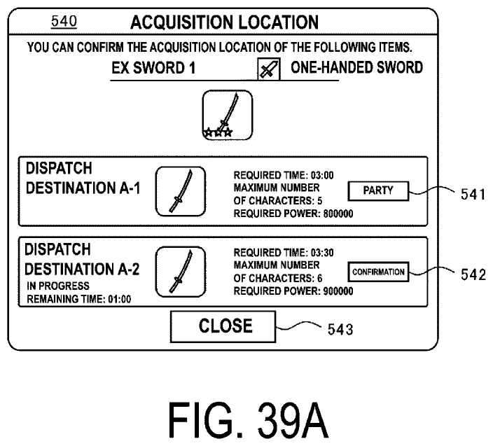

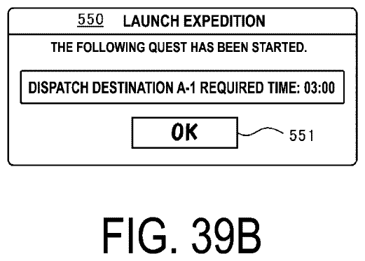

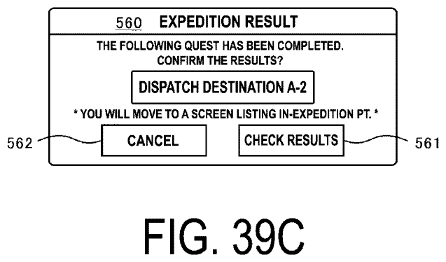

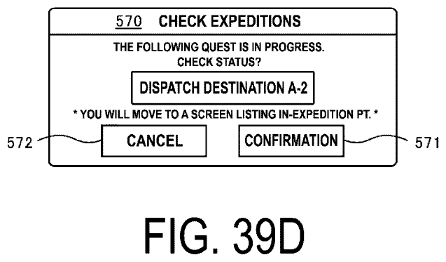

When the acquisition location operation portion 345a is operated by the player, an acquisition location screen 540 (FIG. 39A) described below is displayed on the display 26. Although details will be described below, on the acquisition location screen 540 (FIG. 39A), the type of expedition game where the EX equipment displayed in the detailed display portion 342 can be obtained is displayed.

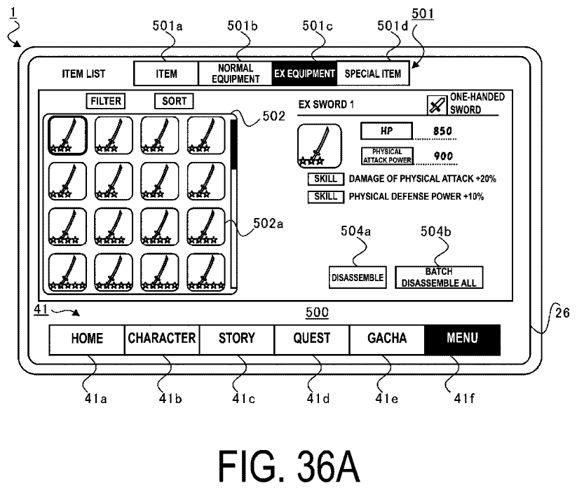

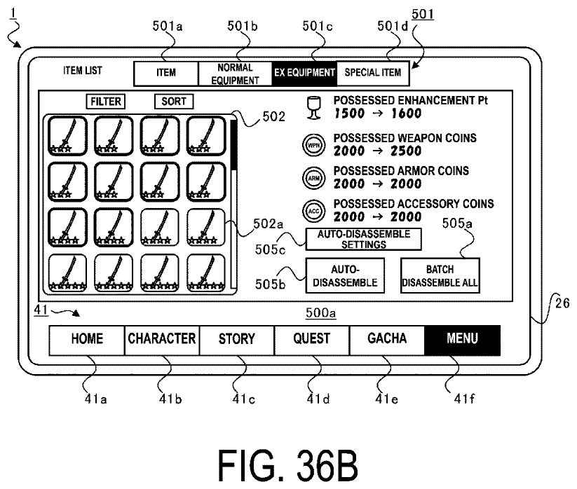

When the item operation portion 345b is operated by the player, an item list screen 500 (FIG. 36A) described below is displayed on the display 26. Although details will be described below, on the item list screen 500 (FIG. 36A), it is possible to disassemble (sell) EX equipment based on a player operation.

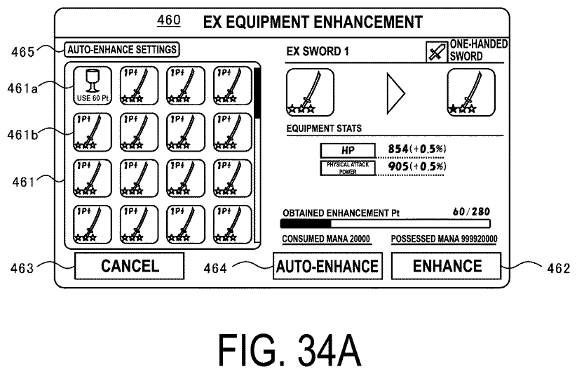

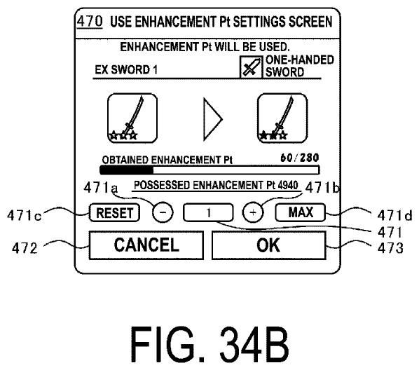

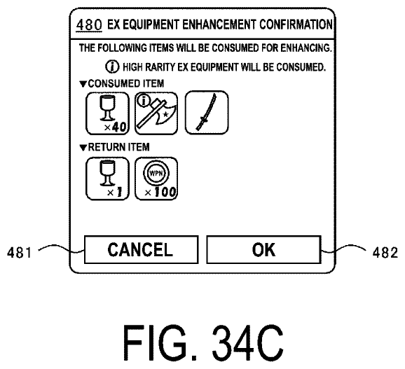

When the enhance operation portion 345c is operated by the player, an enhance EX equipment screen 460 (FIG. 34A) described below is displayed on the display 26. Although details will be described below, on the enhance EX equipment screen 460 (FIG. 34A), it is possible to enhance the EX equipment within a predetermined upper limit range by consuming a predetermined item based on a player operation.

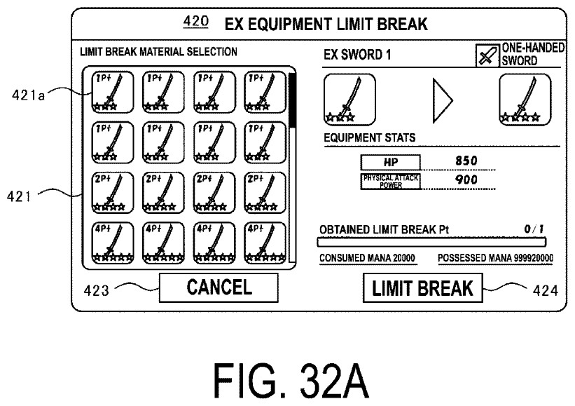

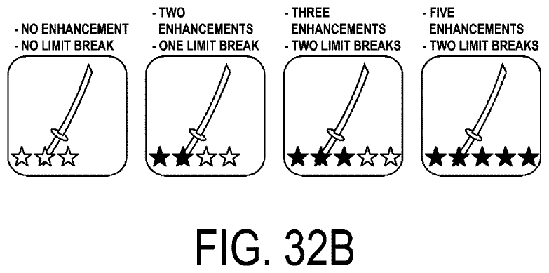

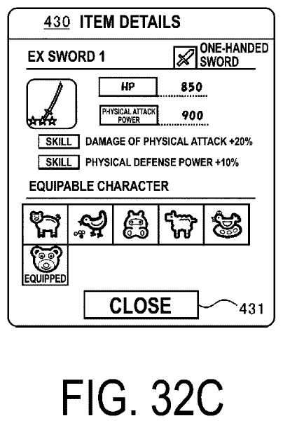

When the limit break operation portion 345d is operated by the player, an EX equipment limit break screen 420 (FIG. 32A) described below is displayed on the display 26. Although details will be described below, on the EX equipment limit break screen 420 (FIG. 32A), it is possible to incrementally break the upper limit when enhancing the EX equipment by consuming a predetermined item based on a player operation.

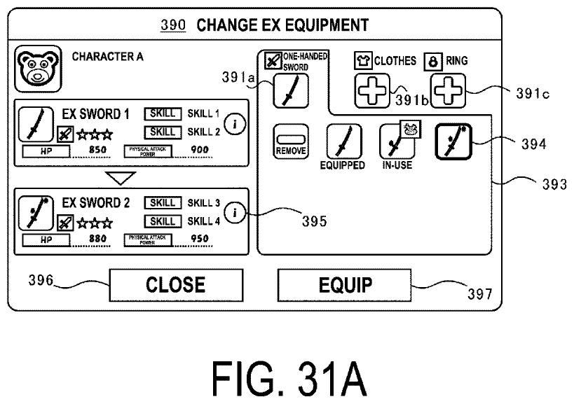

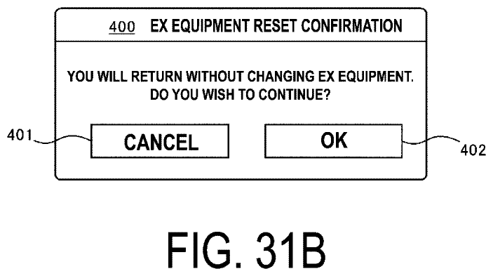

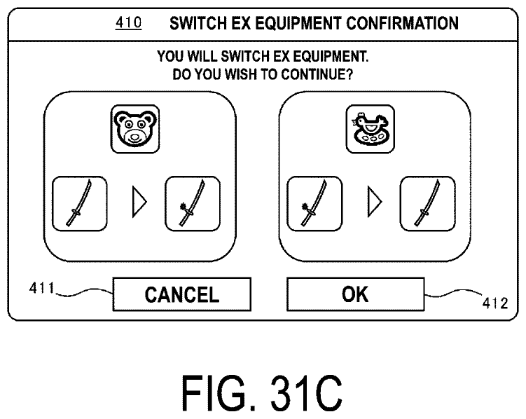

When the change equipment operation portion 345e is operated by the player, a change EX equipment screen 390 (FIG. 31A) described below is displayed on the display 26. Although the details will be described below, on the change EX equipment screen 390 (FIG. 31A), it is possible to manually set EX equipment to equip (manual equip function) based on a player operation.

As illustrated in FIG. 27A, a skill details operation portion 346 is displayed as an operation portion in the detailed display portion 342. When the skill details operation portion 346 is operated by the player, a skill details screen (not illustrated) is displayed on the display 26. On the skill details screen, the player can confirm more detailed information of the skill (ability) set to the equipped EX equipment among the pieces of equipment displayed in the detailed display portion 342.

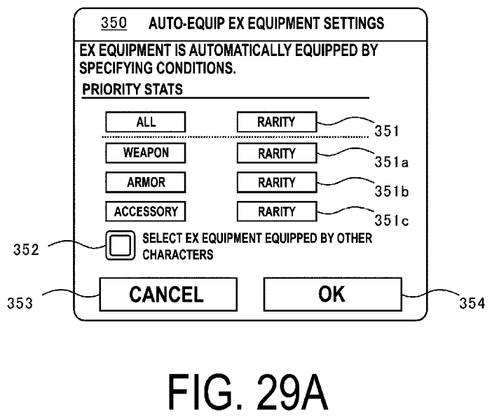

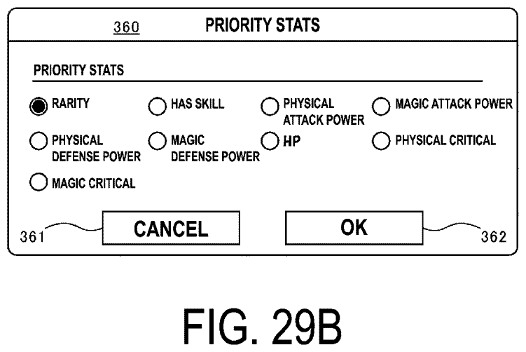

Further, as illustrated in FIG. 27A, an auto-equip operation portion 347 denoted by “AUTO-EQUIP” is displayed on the ally character details screen 340. When the auto-equip operation portion 347 is operated by the player, an auto-equip EX equipment settings screen 350 (FIG. 29A) described below is displayed as a pop-up on the display 26. Although details will be described below, in the auto-equip EX equipment settings screen 350 (FIG. 29A), it is possible to set the settings when using the automatic equip function to automatically equip EX equipment.

FIG. 27B illustrates a case where the second display frame 343b is operated by the player. The second display frame 343b is not equipped with EX equipment. In this case, a message saying “EX equipment (armor) is not equipped” is displayed in the detailed display portion 342. In this case, the detailed display portion 342 displays as operation portions only the first operation portion 342a, the second operation portion 342b, the change equipment operation portion 345e, and a how to obtain operation portion 345f and does not display other operation portions (the acquisition location operation portion 345a, the item operation portion 345b, the enhance operation portion 345c, the limit break operation portion 345d, and the skill details operation portion 346).

When the how to obtain operation portion 345f is operated by the player, a how to obtain screen (not illustrated) described below is displayed as a pop-up on the display 26.

In addition, as described above, in the present embodiment, each piece of EX equipment is classified as either normal EX equipment or special EX equipment. The EX equipment classified as the normal EX equipment type can be equipped only for battle games other than guild battles. That is, normal EX equipment can be set with respect to the first setting frame.

Further, the EX equipment classified as the special EX equipment type can be equipped in both battle games other than guild battles and guild battle battle games. That is, special EX equipment can be set with respect to the first setting frame and the second setting frame.

In addition, in the present embodiment, the additional value with respect to the attack power, the defense power, and the like is set to be relatively larger value for the EX equipment classified as the normal EX equipment type compared to the EX equipment classified as the special EX equipment type. In other words, it can be said that the EX equipment classified as the normal EX equipment type is equipment relatively advantageous to the player as compared to the EX equipment classified as the special EX equipment type. Thus, normally, the player equips EX equipment classified as the normal EX equipment type for battle games other than guild battles and equips EX equipment classified as the special EX equipment type for the guild battle battle games.

Further, in the present embodiment, in a case where a guild battle battle game is executed using an ally character equipped with special EX equipment for the guild battle battle game, a use restriction state is set for the special EX equipment for a predetermined period. The special EX equipment set with the use restriction state are restricted from being equipped by another ally character to perform the guild battle battle game for a period until the use restriction state is removed.

On the other hand, the special EX equipment set with the use restriction state are not restricted from being equipped by another ally character to perform battle games other than guild battles even during a period until the use restriction state is removed.

As described above, when the auto-equip operation portion 347 is operated by the player, an auto-equip EX equipment settings screen 350 (FIG. 29A) is displayed as a pop-up on the display 26. FIG. 29A is a diagram illustrating an example of the auto-equip EX equipment settings screen 350. As illustrated in FIG. 29A, on the auto-equip EX equipment settings screen 350, a priority stats selection operation portion 351 for setting stats of EX equipment to be prioritized when using the automatic equip function for automatically equipping EX equipment is displayed.

When the priority stats selection operation portion 351 is operated by the player, a priority stats screen 360 (FIG. 29B) is displayed as a pop-up on the display 26. FIG. 29B is a diagram illustrating an example of the priority stats screen 360. As illustrated in FIG. 29B, on the priority stats screen 360, stats for EX equipment to prioritize when using the automatic equip function can be selected. Specifically, in the present embodiment, the stats for EX equipment to prioritize when using the automatic equip function include “Rarity” for prioritizing EX equipment of high rarity, “Skill included” for prioritizing EX equipment with more set skills, “Physical attack power” for prioritizing EX equipment set with higher values for physical attack power, “Magic attack power” for prioritizing EX equipment set with higher values for magic attack power, “Physical defense power” for prioritizing EX equipment set with higher values for physical defense power, “Magic defense power” for prioritizing EX equipment set with higher values for magic defense power, “HP” for prioritizing EX equipment set with higher values for HP, “Physical critical” for prioritizing EX equipment set with higher values for physical critical, and “Magic critical” for prioritizing EX equipment set with higher values for magic critical.

As illustrated in FIG. 29B, on the priority stats screen 360, a cancel operation portion 361 denoted by “CANCEL” and an OK operation portion 362 denoted by “OK” are displayed. When the cancel operation portion 361 is operated by the player, the content displayed on the priority stats screen 360 immediately before the operation is discarded. In addition, the display of the priority stats screen 360 is ended, and the auto-equip EX equipment settings screen 350 (FIG. 29A) displayed immediately before the operation of the priority stats selection operation portion 351 (FIG. 29A) is displayed on the display 26. When the OK operation portion 362 is operated by the player, the content displayed on the priority stats screen 360 immediately before the operation is set as the stats for the EX equipment to prioritize.

As illustrated in FIG. 29A, on the auto-equip EX equipment settings screen 350, priority stats selection operation portions 351a, 351b, 351c for individually setting the item to prioritize when using the automatic equip function for each category are displayed. When the priority stats selection operation portion 351a is operated by the player, the priority stats screen 360 is displayed on the display 26, and the item to prioritize when automatically equipping an EX equipment for “weapon” can be individually set. When the priority stats selection operation portion 351b is operated by the player, the priority stats screen 360 is displayed on the display 26, and the item to prioritize when automatically equipping an EX equipment for “armor” can be individually set. When the priority stats selection operation portion 351c is operated by the player, the priority stats screen 360 is displayed on the display 26, and the item to prioritize when automatically equipping an EX equipment for “accessory” can be individually set.

When the player operates the priority stats selection operation portion 351, in a case where the settings as described above have been performed, the priority stats selection operation portions 351a, 351b, 351c are displayed grayed out. In this manner, the player is notified that the setting content displayed on the priority stats selection operation portion 351 is valid. On the other hand, when the player operates at least one of the priority stats selection operation portions 351a, 351b, 351c, in a case where the settings as described above have been performed, the priority stats selection operation portion 351 is displayed grayed out. In this manner, the player is notified that the setting content displayed on the priority stats selection operation portions 351a, 351b, 351c are valid.

In addition, as illustrated in FIG. 29A, a selection portion 352 denoted by “SELECT EX EQUIPMENT EQUIPPED BY ANOTHER CHARACTER” is displayed on the auto-equip EX equipment settings screen 350. When the automatic equip function is used with the selection portion 352 in a selected state, it is determined to equip the ally character with the EX equipment with the highest value for the set stats to prioritize from among the equipable EX equipment including the EX equipment equipped by other ally characters. When the automatic equip function is used with the selection portion 352 not in a selected state, it is determined to equip the ally character with the EX equipment with the highest value for the set stats to prioritize from among the equipable EX equipment excluding the EX equipment equipped by other ally characters.

As illustrated in FIG. 29A, on the auto-equip EX equipment settings screen 350, a cancel operation portion 353 denoted by “CANCEL” and an OK operation portion 354 denoted by “OK” are displayed. When the cancel operation portion 353 is operated by the player, the content displayed on the auto-equip EX equipment settings screen 350 immediately before the operation is discarded. Further, the auto-equip EX equipment settings screen 350 is hidden, and the screen displayed on the display 26 immediately before the display of the auto-equip EX equipment settings screen 350 is displayed.

When the OK operation portion 354 is operated by the player, EX equipment to equip the ally character with is extracted based on the content displayed on the auto-equip EX equipment settings screen 350 immediately before the operation. Then, based on the extraction result, an auto-equip EX equipment confirmation screen 370 is displayed as a pop-up on the display 26.

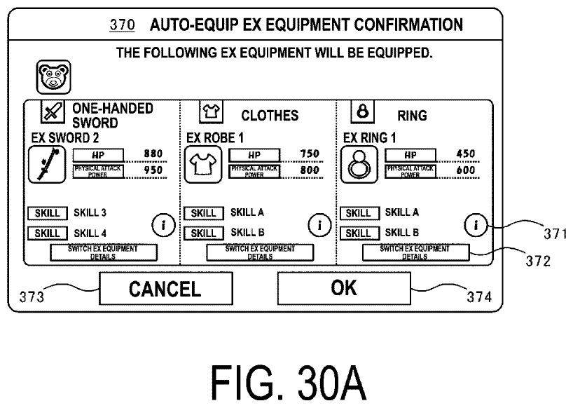

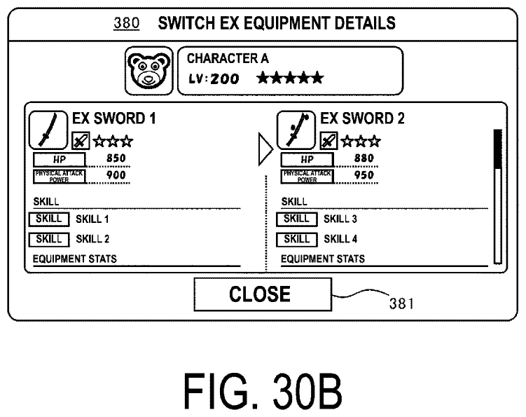

FIG. 30A is a diagram illustrating an example of the auto-equip EX equipment confirmation screen 370. As illustrated in FIG. 30A, on the auto-equip EX equipment confirmation screen 370, the EX equipment to equip to the ally character extracted as described above is displayed per category.

In addition, on the auto-equip EX equipment confirmation screen 370, information such as the contents of various stats and skills set to the EX equipment is displayed.

As illustrated in FIG. 30A, on the auto-equip EX equipment confirmation screen 370, a skill details operation portion 371 is displayed. When the skill details operation portion 371 is operated by the player, a skill details screen (not illustrated) is displayed on the display 26. On the skill details screen, the player can confirm more detailed information of the skill (ability) set to the EX equipment displayed on the auto-equip EX equipment confirmation screen 370.

As illustrated in FIG. 30A, on the auto-equip EX equipment confirmation screen 370, a switch EX equipment details operation portion 372 is displayed. When the switch EX equipment details operation portion 372 is operated by the player, a switch EX equipment details screen 380 is displayed as a pop-up on the display 26.

In a case where the EX equipment operation portion 77x is tapped on the party selection screen 77, the auto-equip EX equipment settings screen 350 (FIG. 29A) is displayed as a pop-up on the display 26. Then, when the OK operation portion 354 of the auto-equip EX equipment settings screen 350 is operated by the player, the EX equipment to equip is extracted for each ally character displayed in the selected ally character display area 78. Then, based on the extraction result, an auto-equip EX equipment confirmation screen 370 is displayed as a pop-up on the display 26. In this case, on the auto-equip EX equipment confirmation screen 370, the extracted EX equipment to equip the ally character with is displayed per category for each ally character displayed in the selected ally character display area 78.

FIG. 30B is a diagram illustrating an example of the switch EX equipment details screen 380. As illustrated in FIG. 30B, on the switch EX equipment details screen 380, information such as the set contents of various stats and skills are displayed for each equipped EX equipment and EX equipment to be equipped. In this manner, the player can compare and examine the set contents of various stats and skills for the equipped EX equipment and the EX equipment to be equipped.

Further, as illustrated in FIG. 30B, a close operation portion 381 denoted by “CLOSE” is displayed on the switch EX equipment details screen 380. When the close operation portion 381 is operated by the player, display of the switch EX equipment details screen 380 is ended and the auto-equip EX equipment confirmation screen 370 is displayed on the display 26.

As illustrated in FIG. 30A, on the auto-equip EX equipment confirmation screen 370, a cancel operation portion 373 denoted by “CANCEL” and an OK operation portion 374 denoted by “OK” are displayed. When the cancel operation portion 373 is operated by the player, the display of the auto-equip EX equipment confirmation screen 370 is ended, and the priority stats screen 360 is displayed on the display 26.

When the OK operation portion 374 is operated by the player, EX equipment is equipped to the ally character using the automatic equip function based on the contents displayed on the auto-equip EX equipment confirmation screen 370 immediately before the operation. Then, the ally character details screen 340 (FIG. 27A) relating to an ally character with equipped EX equipment changed based on the automatic equip function being used is displayed on the display 26. As described above, in the present embodiment, by providing the automatic equip function, the burden on the player is reduced compared to a case where the manual equip function is used with the player themselves determining the type of EX equipment to equip. That is, the number of times that the player performs various operations when setting the EX equipment is reduced compared to a case where the manual equip function is used. Thus, it is possible to improve player-friendliness.

As described above, when the change equipment operation portion 345e of the ally character details screen 340 (FIG. 27A) is operated by the player, the change EX equipment screen 390 is displayed as a pop-up on the display 26. FIG. 31A is a diagram illustrating an example of the change EX equipment screen 390. As illustrated in FIG. 31A, on the change EX equipment screen 390, it is possible to manually set EX equipment to equip based on a player operation.

As illustrated in FIG. 31A, on the change EX equipment screen 390, a first display frame 391a corresponding to “weapon”, a second display frame 391b corresponding to “armor”, and a third display frame 391c corresponding to “accessory” are displayed.

FIG. 31A illustrates a case where the ally character is equipped with an “EX sword 1” which is a “one-handed sword” as EX equipment for “weapon”. In this case, as illustrated in FIG. 31A, an icon image indicating the equipped EX equipment for “weapon” is displayed in the first display frame 391a.

FIG. 31A illustrates a case where the first display frame 391a is operated by the player. In this case, as illustrated in FIG. 31A, a detailed display portion 393 corresponding to the operated display frame is displayed. The detailed display portion 393 displays a list of icons 394 indicating the EX equipment that can be equipped by the ally character among the EX equipment of the category corresponding to the operated display frame.

Note that as illustrated in FIG. 31A, the icon 394 corresponding to the EX equipment equipped to the ally character displays a message indicating “equipped”.

Also, as illustrated in FIG. 31A, the icon 394 corresponding to the EX equipment equipped to another ally character displays a message indicating “in use”. Also, as illustrated in FIG. 31A, at the icon 394 corresponding to the EX equipment equipped to another ally character, there is an additional display of a notification image indicating the other ally character equipped with the EX equipment.

When the player operates any one of the icons 394 displayed in the detailed display portion 393, the operated EX equipment is provisionally selected as the EX equipment to be equipped.

Also, as illustrated in FIG. 31A, on the change EX equipment screen 390, information such as the set contents of various stats and skills are displayed for each equipped EX equipment and EX equipment to be equipped. In this manner, the player can compare and examine the set contents of various stats and skills for the equipped EX equipment and the EX equipment to be equipped.

As illustrated in FIG. 31A, on the change EX equipment screen 390, a skill details operation portion 395 is displayed. When the skill details operation portion 395 is operated by the player, a skill details screen (not illustrated) is displayed on the display 26. On the skill details screen, the player can confirm more detailed information of the set skill (ability) for equipped EX equipment displayed on the change EX equipment screen 390 and EX equipment to be equipped.

Similarly, by operating the second display frame 391b corresponding to “armor”, the player can provisionally select the EX equipment to be equipped for the EX equipment of “armor”. Also, by operating the third display frame 391c corresponding to “accessory”, the player can provisionally select the EX equipment to be equipped for the EX equipment of “accessory”.

Further, as illustrated in FIG. 31A, a close operation portion 396 denoted by “CLOSE” and an equip operation portion 397 denoted by “EQUIP” is displayed on the change EX equipment screen 390.

When the close operation portion 396 is operated by the player, the display of the change EX equipment screen 390 is ended. At this time, in a case where provisional selection of EX equipment to be equipped is performed, a reset EX equipment confirmation screen 400 illustrated in FIG. 31B is displayed as a pop-up on the display 26. FIG. 31B is a diagram illustrating an example of the reset EX equipment confirmation screen 400. As illustrated in FIG. 31B, on the reset EX equipment confirmation screen 400, a confirmation message of “Are you sure you want to return without changing EX equipment?” is displayed.

As illustrated in FIG. 31B, on the reset EX equipment confirmation screen 400, a cancel operation portion 401 denoted by “CANCEL” and an OK operation portion 402 denoted by “OK” are displayed.

When the cancel operation portion 401 of the reset EX equipment confirmation screen 400 is operated by the player, the display of the reset EX equipment confirmation screen 400 is ended and the change EX equipment screen 390 is displayed again on the display 26 with the content that was displayed on the change EX equipment screen 390 immediately before the operation of the close operation portion 396 of the change EX equipment screen 390.

On the other hand, when the OK operation portion 402 of the reset EX equipment confirmation screen 400 is operated, the content that was displayed on the change EX equipment screen 390 immediately before the operation of the close operation portion 396 of the change EX equipment screen 390 is discarded.

Returning to FIG. 31A, when the equip operation portion 397 of the change EX equipment screen 390 is operated by the player, the EX equipment is equipped to the ally character based on the content that was displayed on the change EX equipment screen 390 immediately before the operation of the equip operation portion 397. At this time, in a case where the EX equipment equipped to another ally character is provisionally selected as EX equipment to be equipped, a switch EX confirmation screen 410 illustrated in FIG. 31C is displayed as a pop-up on the display 26. FIG. 31C is a diagram illustrating an example of the switch EX confirmation screen 410. As illustrated in FIG. 31C, on the switch EX confirmation screen 410, a confirmation message of “Are you sure you want to switch EX equipment?” is displayed.

As illustrated in FIG. 31C, on the switch EX confirmation screen 410, content of the EX equipment to be switched, the ally character targeted for EX equipment switching, and information about the other ally character are displayed.

As illustrated in FIG. 31C, on the switch EX confirmation screen 410, a cancel operation portion 411 denoted by “CANCEL” and an OK operation portion 412 denoted by “OK” are displayed.

When the cancel operation portion 411 of the switch EX confirmation screen 410 is operated by the player, the display of the switch EX confirmation screen 410 is ended and the change EX equipment screen 390 is displayed again on the display 26 with the content that was displayed on the change EX equipment screen 390 immediately before the operation of the equip operation portion 397 of the change EX equipment screen 390.

On the other hand, when the OK operation portion 412 of the switch EX confirmation screen 410 is operated, the EX equipment is equipped to the ally character based on the content that was displayed on the change EX equipment screen 390 immediately before the operation of the equip operation portion 397 of the change EX equipment screen 390.

As described above, when the limit break operation portion 345d of the ally character details screen 340 (FIG. 27A) is operated by the player, the EX equipment limit break screen 420 is displayed as a pop-up on the display 26. FIG. 32A is a diagram illustrating an example of the EX equipment limit break screen 420. As illustrated in FIG. 32A, on the EX equipment limit break screen 420, it is possible to incrementally break the upper limit when enhancing the EX equipment by consuming a predetermined item based on a player operation.

FIG. 32B is a diagram for describing enhancing and limit breaking of EX equipment. As described above, the player can break the upper limit and/or enhance each EX equipment. In the present embodiment, the number of times (levels) that EX equipment can be enhanced is limited by the rarity of the EX equipment, that is, to the number of stars. Specifically, when the rarity of EX equipment is three stars, the number of times (levels) that the EX equipment can be enhanced is limited to three times. In a similar manner, when the rarity of EX equipment is four stars, the number of times (levels) that the EX equipment can be enhanced is limited to four times, and when the rarity of EX equipment is five stars, the number of times (levels) that the EX equipment can be enhanced is limited to five times. In the present embodiment, when EX equipment is enhanced, various parameters of the EX equipment are increased and/or preset skills are added. On the other hand, merely breaking the upper limit of the EX equipment increases the number of times (levels) that the EX equipment can be enhanced, and the various parameters of the EX equipment are not increased. Then, by equipping the ally character with the enhanced EX equipment, it is possible to further increase the power of the ally character in the battle game. That is, when the EX equipment is enhanced, it is possible to increase the value of the above-described additional values with respect to the attack power, the defense power, and the like.

In addition, in the present embodiment, a display for making it possible to identify the execution status of the upper limit breaking and enhancing is performed for each EX equipment. Specifically, as illustrated in FIG. 32B, the execution status of the upper limit breaking is indicated by the number of stars, and the execution status of the enhancing is indicated by the number of colored stars.

For example, in a case where the initial rarity of the EX equipment is three stars and limit breaking and enhancing are not executed, three colorless stars are displayed. In this case, since the total number of displayed stars is three, it means that the rarity of the EX equipment is three stars. In addition, since the number of colored stars is zero, it means that the EX equipment has not been enhanced.

Further, when limit breaking is executed once and enhancing is executed twice, two colored stars and two colorless stars are displayed. In this case, since the total number of displayed stars is four, it means that the rarity of the EX equipment is four stars. In addition, since the number of colored stars is two, it means that the EX equipment has been enhanced two times.

Further, when limit breaking is executed twice and enhancing is executed three times, three colored stars and two colorless stars are displayed. In this case, since the total number of displayed stars is five, it means that the rarity of the EX equipment is five stars. In addition, since the number of colored stars is three, it means that the EX equipment has been enhanced three times.

Further, when limit breaking is executed twice and enhancing is executed five times, five colored stars are displayed. In this case, since the total number of displayed stars is five, it means that the rarity of the EX equipment is five stars. In addition, since the number of colored stars is five, it means that the EX equipment has been enhanced five times.

Note that the color of the star indicating the initial rarity and the color of the star indicating the rarity increased by limit breaking may be different from each other so that the player can identify the stars.

As described above, in order to limit break, it is necessary to consume a predetermined item. Specifically, in the present embodiment, the limit break can be performed once by consuming EX equipment of the same type as the EX equipment targeted for limit breaking and consuming a predetermined amount of in-game currency.

In the present embodiment, the points necessary for limit breaking are displayed so that the number of materials (EX equipment of the same type) necessary for performing the limit break can be easily understood. In the present embodiment, when a limit break of EX equipment with a rarity of three stars is performed, one point is required, and when a limit break of EX equipment with a rarity of four stars is performed, two points are required. Further, as illustrated in FIG. 32A, display is performed to identify that EX equipment with a rarity of three stars is one point, EX equipment with a rarity of four stars is two points, and EX equipment with a rarity of five stars is eight points.

For example, in the case illustrated in FIG. 32A, limit breaking can be performed once on predetermined EX equipment with a rarity of three stars by consuming one piece of EX equipment of the same type with a rarity of three stars or more and a predetermined amount of in-game currency (mana). Note that in a case where EX equipment of the same type with a rarity of four stars or more is consumed, an item (EX equipment) corresponding to the surplus number of the points is returned due to two points or more being consumed for a limit break requiring one point.

As illustrated in FIG. 32A, on the EX equipment limit break screen 420, a list display portion 421 is displayed displaying a list of icons 421a indicating EX equipment of the same type as the EX equipment targeted for limit breaking.

Further, on the EX equipment limit break screen 420, the required number (in this example, one point) of limit breaking points indicating the number of materials (same type of EX equipment) required to perform limit breaking. Then, when the icon 421a is operated by the player, the EX equipment corresponding to the operated icon 421a is provisionally selected as material for limit breaking.

On the EX equipment limit break screen 420, the amount of in-game currency and the amount of in-game currency possessed by the player that are required for limit breaking are displayed.

Further, when the icon 421a is long-pressed by the player, an item details screen 430 illustrated in FIG. 32C is displayed as a pop-up on the display 26. As illustrated in FIG. 32C, on the item details screen, details of the various stats of the EX equipment and a list of ally characters that can equip the EX equipment are displayed.

When a close operation portion 431 of the item details screen 430 is operated by the player, the display of the item details screen 430 is ended and the EX equipment limit break screen 420 is displayed on the display 26.

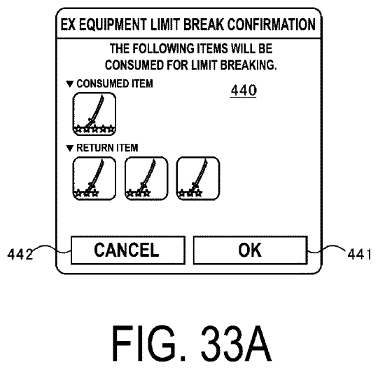

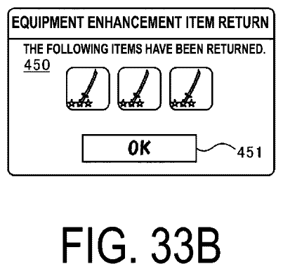

Returning to FIG. 32A, when the player operates a limit break operation portion 424 of the EX equipment limit break screen 420 in a state in which the icon 421a is operated on the EX equipment limit break screen 420 so that the necessary limit break points or more are reached, an EX equipment limit break confirmation screen 440 illustrated in FIG. 33A is displayed as a pop-up. On the other hand, when a cancel operation portion 423 of the EX equipment limit break screen 420 is operated by the player, limit breaking is not performed and the display of the EX equipment limit break screen 420 is ended.

FIG. 33A is a diagram illustrating the EX equipment limit break confirmation screen 440. As illustrated in FIG. 33A, on the EX equipment limit break confirmation screen 440, the player is notified of the EX equipment corresponding to the icon 421a selected (provisionally selected) by the player as a consumable item on the EX equipment limit break screen 420 (FIG. 32A). When an item is returned, the player is notified of the returned item (EX equipment). As described above, for example, in a case where two or more points are consumed for a limit break requiring one point, EX equipment corresponding to the surplus points is returned.

Then, when an OK operation portion 441 of the EX equipment limit break confirmation screen 440 is operated by the player, limit breaking is executed. Also, when an OK operation portion 441 of the EX equipment limit break confirmation screen 440 is operated by the player, the display of the EX equipment limit break confirmation screen 440 is ended. If there is a return item, an enhance equipment item return screen 450 is displayed as a pop-up on the display 26 as illustrated in FIG. 33B. On the other hand, if there is no return item, the enhance equipment item return screen 450 is not displayed and the EX equipment limit break screen 420 is again displayed on the display 26. At this time, on the EX equipment limit break screen 420, a message notifying the player that limit breaking has been performed is displayed. Although a case where limit breaking of EX equipment is performed once has been described above, a plurality of limit breaks may be collectively performed at one time.

FIG. 33B is a diagram illustrating an example of the enhance equipment item return screen 450. As illustrated in FIG. 33B, a list of return items is displayed on the enhance equipment item return screen 450. When an OK operation portion 451 of the enhance equipment item return screen 450 is operated by the player, the display of the enhance equipment item return screen 450 is ended and the EX equipment limit break screen 420 is displayed again on the display 26. At this time, on the EX equipment limit break screen 420, a message notifying the player that limit breaking has been performed is displayed.

As described above, when the enhance operation portion 345c of the ally character details screen 340 (FIG. 27A) is operated by the player, the enhance EX equipment screen 460 is displayed as a pop-up on the display 26. FIG. 34A is a diagram illustrating an example of the enhance EX equipment screen 460. As illustrated in FIG. 34A, on the enhance EX equipment screen 460, it is possible to enhance the EX equipment within a predetermined upper limit range by consuming a predetermined item based on a player operation. In the present embodiment, specifically, the EX equipment can be enhanced once by consuming a predetermined enhancement point and in-game currency (mana). As described above, in the present embodiment, when EX equipment is enhanced, various parameters of the EX equipment are increased and/or preset skills are added. Then, by equipping the ally character with the enhanced EX equipment, it is possible to further increase the power of the ally character in the battle game. That is, when the EX equipment is enhanced, it is possible to increase the value of the above-described additional values with respect to the attack power, the defense power, and the like.

An enhancement point is a type of in-game currency that can be obtained by disassembling (selling) EX equipment as described below. In addition, it is possible to enhance the EX equipment by consuming EX equipment owned by the player instead of enhancement points. When the player consumes the EX equipment owned by the player instead of enhancement points, the enhancement points are set at a conversion rate corresponding to the rarity and the enhancement status of the EX equipment to be consumed. In the present embodiment, it is also possible to enhance the EX equipment by both consuming enhancement points and consuming EX equipment.

FIG. 34A illustrates a case of enhancing a predetermined EX equipment with a rarity of three stars that has not been enhanced. In this case, the EX equipment can be enhanced once by consuming 280 enhancement points. Note that, for example, in a case where enhancement points more than 280 points are consumed for one enhancement requiring 280 enhancement points, return items such as enhancement points and predetermined in-game currency are returned in accordance with the surplus points.

For example, in a case where an EX equipment classified as “weapon” is enhanced and a return item is produced, enhancement points and a weapon coin are returned. A weapon coin is a type of in-game currency that can be obtained by disassembling (selling) EX equipment as described below. For example, the player can purchase predetermined EX equipment classified as “weapon” by consuming a weapon coin possessed by the player.

Also, for example, in a case where an EX equipment classified as “armor” is enhanced and a return item is produced, enhancement points and an armor coin are returned. An armor coin is a type of in-game currency that can be obtained by disassembling (selling) EX equipment as described below. For example, the player can purchase predetermined EX equipment classified as “armor” by consuming an armor coin possessed by the player.

Also, for example, in a case where an EX equipment classified as “accessory” is enhanced and a return item is produced, enhancement points and an accessory coin are returned. An accessory coin is a type of in-game currency that can be obtained by disassembling (selling) EX equipment as described below. For example, the player can purchase predetermined EX equipment classified as “accessory” by consuming an accessory coin possessed by the player.

As illustrated in FIG. 34A, a list display portion 461 is displayed on the enhance EX equipment screen 460. As illustrated in FIG. 34A, for enhancing the EX equipment, the list display portion 461 displays a list including a first icon 461a for setting the number of enhancement points to be consumed and a plurality of second icons 461b indicating EX equipment that can be consumed in place of the enhancement points.

Further, on the enhance EX equipment screen 460, a required number of enhancement points (here, 280 points) required for performing enhancement once is displayed. When the first icon 461a is operated by the player, a use enhancement points settings screen 470 illustrated in FIG. 34B is displayed as a pop-up on the display 26. Also, when the second icon 461b is operated by the player, the EX equipment corresponding to the operated second icon 461b is provisionally selected as material for enhancement.

FIG. 34B is a diagram illustrating an example of the use enhancement points settings screen 470. As illustrated in FIG. 34B, on the use enhancement points settings screen 470, the required number of enhancement points (here, 280 points) required for performing enhancement once and the total number of enhancement points owned by the player are displayed.

Further, as illustrated in FIG. 34B, on the use enhancement points settings screen 470, a use enhancement points display portion 471, an increase enhancement points used operation portion 471a, a decrease enhancement points used operation portion 471b, a reset operation portion 471c, and a MAX operation portion 471d are displayed.

The enhancement points to be used being set are displayed in the use enhancement points display portion 471. When the increase enhancement points used operation portion 471a is operated by the player, the enhancement points to be used being set are increased by one, and the display of the use enhancement points display portion 471 is updated. When the decrease enhancement points used operation portion 471b is operated by the player, the enhancement points to be used being set are decreased by one, and the display of the use enhancement points display portion 471 is updated. When the reset operation portion 471c is operated by the player, the enhancement points to be used being set are reset to zero, and the display of the use enhancement points display portion 471 is updated. When the MAX operation portion 471d is operated by the player, the enhancement points to be used being set are updated to the required number of enhancement points (here, 280 points) required for performing enhancement one time, and the display of the use enhancement points display portion 471 is updated.

As illustrated in FIG. 34B, on the use enhancement points settings screen 470, a cancel operation portion 472 denoted by “CANCEL” and an OK operation portion 473 denoted by “OK” are displayed. When the cancel operation portion 472 is operated by the player, the content displayed on the use enhancement points settings screen 470 immediately before the operation is discarded. In addition, the display of the use enhancement points settings screen 470 is ended, and the enhance EX equipment screen 460 (FIG. 34A) displayed immediately before the operation of the first icon 461a (FIG. 34A) is displayed on the display 26.

When the OK operation portion 473 is operated by the player, the use of the number of enhancement points displayed in the use enhancement points display portion 471 immediately before the operation is provisionally selected. Then, the display of the use enhancement points settings screen 470 is ended, the enhance EX equipment screen 460 (FIG. 34A) is displayed on the display 26, and the number of points displayed on the first icon 461a (FIG. 34A) is updated to the number of enhancement points displayed on the use enhancement points display portion 471.

Returning to FIG. 34A, on the enhance EX equipment screen 460, when an enhance operation portion 462 of the enhance EX equipment screen 460 is operated by the player with the enhancement points or EX equipment to be consumed provisionally selected to reach the required enhancement points or more for one enhancement, an enhance EX equipment confirmation screen 480 illustrated in FIG. 34C is displayed as a pop-up on the display 26. On the other hand, when the cancel operation portion 463 of the enhance EX equipment screen 460 is operated by the player, enhancement of the EX equipment is not performed, and the display of the enhance EX equipment screen 460 is ended.

FIG. 34C is a diagram illustrating the enhance EX equipment confirmation screen 480. As illustrated in FIG. 34C, on the enhance EX equipment confirmation screen 480, the enhancement points or EX equipment to be consumed provisionally selected by the player on the enhance EX equipment screen 460 (FIG. 34A) are notified to the player as consumable items. When an item is returned, the player is notified of the returned item. Here, a case is illustrated in which one enhancement point and 100 weapon coins are being returned.

Also, when the OK operation portion 482 of the enhance EX equipment confirmation screen 480 is operated by the player, enhancement of the EX equipment is performed, and the display of the enhance EX equipment confirmation screen 480 is ended. If there is a return item, a return screen (not illustrated) is displayed on the display 26. On the other hand, if there is no return item, the return screen is not displayed and the enhance EX equipment screen 460 is again displayed on the display 26. At this time, on the enhance EX equipment screen 460, a message notifying the player that enhancement has been performed on the EX equipment once is displayed. Note that, although a case where enhancement has been performed once on the EX equipment has been described above, a plurality of times of enhancement can be collectively performed at one time.

Further, in the present embodiment, an auto-enhance function is provided for automatically setting the enhancement points or EX equipment to be consumed for enhancing the EX equipment as described above. The auto-enhance function can be used by an auto-enhance operation portion 464 of the enhance EX equipment screen 460 being operated by the player. That is, when the auto-enhance operation portion 464 is tapped by the player, the enhance EX equipment confirmation screen 480 is immediately displayed on the display 26. Thus, it is possible to improve player-friendliness. In the present embodiment, by providing the auto-enhance function, the number of times various operations are performed by the player are decreased when using the auto-enhance function with respect to the content of the enhancement points and EX equipment to be consumed when enhancing EX equipment compared to when manually set by the player. Thus, it is possible to improve player-friendliness.

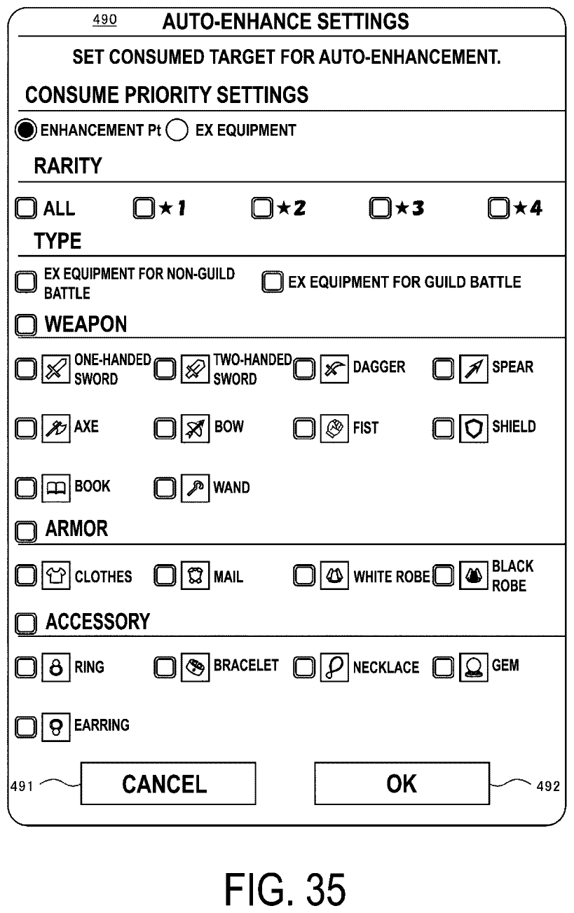

In addition, in the present embodiment, the settings of the above-described auto-enhance function can be set. When an auto-enhance setting operation portion 465 of the enhance EX equipment screen 460 is operated by the player, an auto-enhance settings screen 490 illustrated in FIG. 35 is displayed as a pop-up on the display 26.

FIG. 35 is a diagram illustrating an example of the auto-enhance settings screen 490. As illustrated in FIG. 35, on the auto-enhance settings screen 490, whether to prioritize consuming enhancement points or whether to prioritize consuming EX equipment for enhancing EX equipment can be selected.

Further, as illustrated in FIG. 35, in a case where EX equipment is consumed for enhancing EX equipment, consumable EX equipment can be set. In the present embodiment, as illustrated in FIG. 35, the player can set the settings as desired from among rarity of consumable EX equipment, type of consumable EX equipment, major category of consumable EX equipment, and minor category of consumable EX equipment. Accordingly, it is possible to prevent EX equipment from being consumed contrary to the intention of the player in order to enhance EX equipment. For example, it is possible to avoid a situation in which EX equipment with high rarity that the player does not want to be consumed is consumed without permission. In this manner, the player can feel comfortable proactively using the auto-enhance function, so that the number of times the player performs various operations can be reduced, improving player-friendliness.

When a cancel operation portion 491 of the auto-enhance settings screen 490 is operated by the player, the content displayed on the auto-enhance settings screen 490 immediately before the operation is discarded. In addition, the display of the auto-enhance settings screen 490 is ended, and the enhance EX equipment screen 460 (FIG. 34A) is displayed on the display 26.

When an OK operation portion 492 of the auto-enhance settings screen 490 is operated by the player, the content displayed on the auto-enhance settings screen 490 immediately before the operation is stored as the auto-enhance settings. In addition, the display of the auto-enhance settings screen 490 is ended, and the enhance EX equipment screen 460 (FIG. 34A) is displayed on the display 26.

As described above, when the item operation portion 345b of the ally character details screen 340 (FIG. 27A) is operated by the player, the item list screen 500 illustrated in FIG. 36A is displayed on the display 26. FIG. 36A is a first diagram illustrating an example of the item list screen 500. As illustrated in FIG. 36A, on the item list screen 500, it is possible to disassemble (sell) EX equipment based on a player operation.

As illustrated in FIG. 36A, a list display item selection operation portion 501 is displayed on the item list screen 500. The list display item selection operation portion 501 is provided with a plurality of operation portions that can be operated by the player. The list display item selection operation portion 501 is provided with an item selection operation portion 501a, a normal equipment selection operation portion 501b, an EX equipment selection operation portion 501c, and a special item selection operation portion 501d. When any one of the list display item selection operation portions 501 is selected, the selected operation portion is highlighted. FIG. 36A illustrates a case where the EX equipment selection operation portion 501c has been selected.

Note that the item list screen 500 can also be displayed in a case where a predetermined operation portion is operated on a menu screen (not illustrated) displayed when the menu screen selection operation portion 41f is tapped. However, in a case where a predetermined operation portion is operated on the menu screen (not illustrated), a selection needs to be made of the EX equipment the player wants to disassemble. On the other hand, in a case where the item operation portion 345b is operated and the item list screen 500 is displayed, the item list screen 500 is displayed in a state with an icon 502a corresponding to the EX equipment displayed in the detailed display portion 342 immediately before the operation of the item operation portion 345b of the ally character details screen 340 (FIG. 27A). Accordingly, the number of times the player performs various operations can be reduced in the case where the item operation portion 345b is operated and the item list screen 500 is displayed as compared to the case where a predetermined operation portion is operated and the item list screen 500 is displayed on the menu screen. Thus, player-friendliness can be improved.

As illustrated in FIG. 36A, a list display portion 502 is displayed on the item list screen 500. The icon 502a corresponding to the EX equipment owned by the player is displayed in the list display portion 502. As illustrated in FIG. 36A, in the item list screen 500, when any one of the icons 502a is tapped, an EX equipment targeted for disassembly can be selected. Then, information such as various stats related to the EX equipment corresponding to the selected icon 502a is displayed on the item list screen 500.

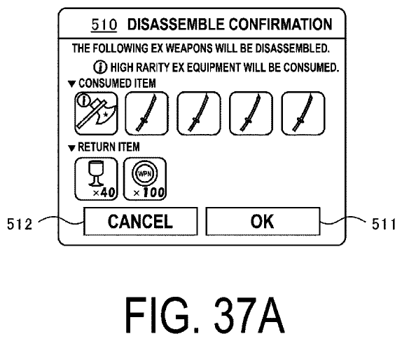

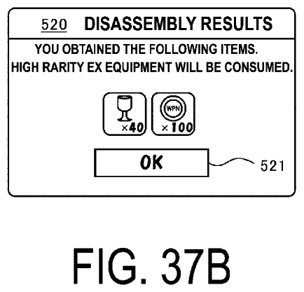

When a disassemble operation portion 504a of the item list screen 500 is operated with any one of the icons 502a being selected, a disassemble confirmation screen 510 (FIG. 37A) described below is displayed as a pop-up on the display 26.

In addition, when a batch disassemble operation portion 504b of the item list screen 500 is operated, an item list screen 500a illustrated in FIG. 36B is displayed. FIG. 36B is a second diagram illustrating an example of the item list screen 500a. The list display portion 502 is displayed on the item list screen 500a. The icon 502a corresponding to the EX equipment owned by the player is displayed in the list display portion 502. As illustrated in FIG. 36B, in the item list screen 500, when any one or a plurality of the icons 502a is tapped, an EX equipment targeted for disassembly can be selected. Then, information such as various items the player can obtain by disassembling EX equipment corresponding to the selected icon 502a is displayed on the item list screen 500a.

When a batch disassemble operation portion 505a of the item list screen 500a is operated with any one or more of the icons 502a being selected, the disassemble confirmation screen 510 (FIG. 37A) described below is displayed on the display 26.

FIG. 37A is a diagram illustrating an example of the disassemble confirmation screen 510. As illustrated in FIG. 37A, on the disassemble confirmation screen 510, the EX equipment corresponding to the icon 502a selected (provisionally selected) by the player on the item list screen 500 or the item list screen 500a is transmitted to the player through notification as a consumable item to be disassembled. In addition, return items (enhancement points and various coins) obtained by the player as a result of the disassembly are transmitted to the player through notification.

Also, when an OK operation portion 511 of the disassemble confirmation screen 510 is operated by the player, disassembly of the EX equipment is executed, and the display of the disassemble confirmation screen 510 is ended. Then, a disassembly results screen 520 illustrated in FIG. 37B is displayed as a pop-up on the display 26. Further, when a cancel operation portion 512 of the disassemble confirmation screen 510 is operated by the player, display of the disassemble confirmation screen 510 is ended, and the screen (item list screen 500 or item list screen 500a) displayed immediately before the display of the disassemble confirmation screen 510 is displayed on the display 26.

FIG. 37B is a diagram illustrating an example of the disassembly results screen 520. As illustrated in FIG. 37B, on the disassembly results screen 520, a list of the return items is displayed. Also, when an OK operation portion 521 of the disassembly results screen 520 is operated by the player, display of the disassembly results screen 520 is ended, and the item list screen 500 is again displayed on the display 26.

Returning to FIG. 36B, on the item list screen 500a, an auto-disassemble operation portion 505b is displayed. In the present embodiment, an auto-disassemble function is provided for automatically selecting the EX equipment to target for disassembly of EX equipment as described above. The auto-disassemble function can be used by the auto-disassemble operation portion 505b of the item list screen 500a being operated by the player. That is, when the auto-disassemble operation portion 505b is tapped by the player, as illustrated in FIG. 36B, the icon 502a corresponding to the EX equipment targeted for disassembly is automatically selected. In this manner, when the batch disassemble operation portion 505a is operated with the auto-disassemble function used and the icon 502a selected, as described above, the disassemble confirmation screen 510 is displayed on the display 26. In the present embodiment, by providing the auto-disassemble function, the number of times various operations are performed by the player are decreased when using the auto-disassemble function compared to when the EX equipment targeted for disassembly is manually set by the player. Thus, it is possible to improve player-friendliness.

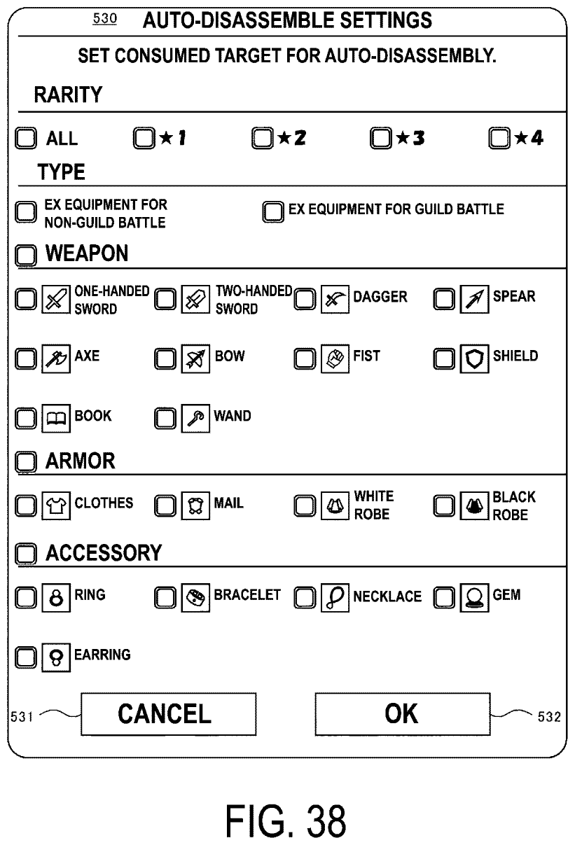

In addition, in the present embodiment, the settings of the above-described auto-disassemble function can be set. When an auto-disassemble setting operation portion 505c of the item list screen 500a is operated by the player, an auto-disassemble settings screen 530 illustrated in FIG. 38 is displayed as a pop-up on the display 26.

FIG. 38 is a diagram illustrating an example of the auto-disassemble settings screen 530. As illustrated in FIG. 38, on the auto-disassemble settings screen 530, EX equipment to be disassembled can be set. In the present embodiment, as illustrated in FIG. 38, the player can set the settings as desired from among the rarity of EX equipment desired to be set for disassembly, the type of EX equipment desired to be set for disassembly, the major category of EX equipment desired to be set for disassembly, and the minor category of EX equipment desired to be set for disassembly. Accordingly, it is possible to prevent EX equipment from being set as EX equipment to be disassembled contrary to the intention of the player when performing disassembly of EX equipment. For example, it is possible to avoid a situation in which EX equipment with high rarity that the player does not want to be disassembled is set to be disassembled without permission. In this manner, the player can feel comfortable proactively using the auto-disassemble function, so that the number of times the player performs various operations can be reduced, improving player-friendliness.

When a cancel operation portion 531 of the auto-disassemble settings screen 530 is operated by the player, the content displayed on the auto-disassemble settings screen 530 immediately before the operation is discarded. In addition, the display of the auto-disassemble settings screen 530 is ended, and the item list screen 500a is displayed on the display 26.

When an OK operation portion 532 of the auto-disassemble settings screen 530 is operated by the player, the content displayed on the auto-disassemble settings screen 530 immediately before the operation is stored as the auto-disassemble settings. In addition, the display of the auto-disassemble settings screen 530 is ended, and the item list screen 500a is displayed on the display 26.

As described above, when the acquisition location operation portion 345a of the ally character details screen 340 (FIG. 27A) is operated by the player, the acquisition location screen 540 (FIG. 39A) is displayed as a pop-up on the display 26. FIG. 39A is a diagram illustrating an example of the acquisition location screen 540.

As illustrated in FIG. 39A, on the acquisition location screen 540, the type of expedition game where the EX equipment displayed in the detailed display portion 342 can be obtained is displayed. As illustrated in FIG. 39A, on the acquisition location screen 540, the type of expedition game where the EX equipment displayed in the detailed display portion 342 (FIG. 27A) can be obtained is identifiably displayed. FIG. 39A illustrates a case where “Dispatch destination A-1” and “Dispatch destination A-2” are displayed. As illustrated in FIG. 39A, on the acquisition location screen 540, for each displayed expedition game, the required start conditions for starting execution and the required end conditions for ending execution are displayed. The required power corresponds to a start condition (minimum condition), and the required time corresponds to an end condition.

In addition, illustrated here is a case where an expedition game has not been executed for “Dispatch destination A-1” and an expedition game is in progress or execution has been completed for “Dispatch destination A-2”.

As illustrated in FIG. 39A, on the acquisition location screen 540, a formation operation portion 541 denoted by “FORMATION” is displayed for the expedition game which is not currently being executed. When the formation operation portion 541 is operated, on the display 26, the formation screen 170 (FIG. 13A) described above is displayed on the display 26, and a party to dispatch to the dispatch destination can be formed as described above. That is, when the formation operation portion 541 is operated, the formation screen 170 (FIG. 13A) is displayed as a pop-up on the display 26 bypassing display of the dispatch destination selection screen 100 (FIG. 7B) and an operation of the first dispatch destination selection operation portion 101a to the fourth dispatch destination selection operation portion 101d. Thus, it is possible to improve player-friendliness by reducing the number of times various operations are performed by the player. Further, in this case, since the dispatch destination selection screen 100 (FIG. 7B) is not displayed, that is, a screen transition to the dispatch destination selection screen 100 (FIG. 7B) is not performed, naturally, the loading of data and the like for displaying the dispatch destination selection screen 100 (FIG. 7B) is also not performed. Thus, it is also possible to suppress an increase in processing load.

Then, when the dispatch operation portion 177 of the formation screen 170 is operated by the player, the expedition game is executed.

However, in a case where the formation screen 170 (FIG. 13A) is displayed via an operation of the formation operation portion 541 of the acquisition location screen 540, when the dispatch operation portion 177 is operated by the player, a launch expedition screen 550 illustrated in FIG. 39B is displayed as a pop-up on the display 26 bypassing a display of the expedition start animation screen 200 (FIG. 16B), and the player is notified of the start of the expedition game. Accordingly, it is possible to prevent the player from feeling annoyed.

When an OK operation portion 551 of the launch expedition screen 550 is operated by the player, the display of the launch expedition screen 550 is ended, and the acquisition location screen 540 is displayed on the display 26.

Also, as illustrated in FIG. 39A, on the acquisition location screen 540, a confirm operation portion 542 denoted by “CONFIRM” is displayed for an expedition game currently being executed or an expedition game that has finished being executed. When the confirm operation portion 542 is operated, if the expedition game is completed, an expedition results screen 560 illustrated in FIG. 39C is displayed as a pop-up on the display 26. Also, when the confirm operation portion 542 is operated, if the expedition game is in progress, an expedition confirmation screen 570 illustrated in FIG. 39D is displayed as a pop-up on the display 26. When a close operation portion 543 of the acquisition location screen 540 is operated by the player, the ally character details screen 340 (FIG. 27A) is displayed on the display 26.

FIG. 39C is a diagram illustrating an example of the expedition results screen 560. FIG. 39D is a diagram illustrating an example of the expedition confirmation screen 570. As illustrated in FIG. 39C, on the expedition results screen 560, the player is notified that execution of the expedition game is complete. Also, as illustrated in FIG. 39D, on the expedition confirmation screen 570, the player is notified that the expedition game is in progress. Then, when a result confirmation operation portion 561 of the expedition results screen 560 or a confirmation operation portion 571 of the expedition confirmation screen 570 is operated by the player, the in-expedition party list screen 320 (FIG. 26A) is displayed on the display 26.

When a cancel operation portion 562 of the expedition results screen 560 or a cancel operation portion 572 of the expedition confirmation screen 570 is operated by the player, the acquisition location screen 540 is displayed on the display 26.

Further, on the ally character details screen 340 (FIG. 27B), when the ally character is not equipped with EX equipment (here, “armor” EX equipment) and the how to obtain operation portion 345f is operated by the player, as described above, a how to obtain screen (not illustrated) is displayed as a pop-up on the display 26. In this case, the type of the expedition game in which the player can obtain the EX equipment of the minor category (here, “clothes” EX equipment) that can be equipped by the ally character is displayed. Note that other displays and functions on the how to obtain screen (not illustrated) are the same as those on the acquisition location screen 540 (FIG. 39A), and thus description thereof will be omitted.

As described above, when the automatic disassembly setting operation portion 114 of the menu screen 110 (FIG. 8A) is operated by the player, an automatic disassembly settings screen 580 illustrated in FIG. 40 is displayed as a pop-up on the display 26.

As described above, in the present embodiment, the player can disassemble EX equipment owned by the player and obtain enhancement points and various coins. As described above, by using the auto-disassemble function, the player can efficiently perform disassembly. In the present embodiment, in order to further improve player-friendliness, an automatic disassembly function is provided so that, in a case where EX equipment is obtained as a reward for an expedition game, before receiving the obtained EX equipment, the obtained EX equipment is automatically disassembled. Accordingly, disassembly is already performed at the stage when the reward for the expedition game is received, which saves players trouble.

FIG. 40 is a diagram illustrating an example of the automatic disassembly settings screen 580. As illustrated in FIG. 40, on the automatic disassembly settings screen 580, EX equipment targeted for the automatic disassembly function can be set. In the present embodiment, as illustrated in FIG. 40, the player can set the settings as desired from among the rarity of EX equipment desired to be set for the automatic disassembly function, the type of EX equipment desired to be set for the automatic disassembly function, the major category of EX equipment desired to be set for the automatic disassembly function, and the minor category of EX equipment desired to be set for the automatic disassembly function. Accordingly, it is possible to prevent EX equipment from being automatically disassembled contrary to the intention of the player when performing automatic disassembly of EX equipment. For example, it is possible to avoid a situation in which EX equipment with high rarity that the player does not want to be disassembled is disassembled without permission. In this manner, the player can feel comfortable proactively using the automatic disassembly function, so that the number of times the player performs various operations can be reduced, improving player-friendliness.

When a cancel operation portion 581 of the automatic disassembly settings screen 580 is operated by the player, the content displayed on the automatic disassembly settings screen 580 immediately before the operation is discarded. In addition, the display of the automatic disassembly settings screen 580 is ended, and the menu screen 110 (FIG. 8A) is displayed on the display 26.

When an OK operation portion 582 of the automatic disassembly settings screen 580 is operated by the player, the content displayed on the automatic disassembly settings screen 580 immediately before the operation is stored as the automatic disassembly settings. In addition, the display of the automatic disassembly settings screen 580 is ended, and the menu screen 110 (FIG. 8A) is displayed on the display 26.

Next, the functional configuration of the player terminal 1 and the server 1000 for executing the above-described expedition game will be described. The functional configuration of the player terminal 1 and the server 1000 relating to the battle game will not be described.

### Control Processing in Player Terminal 1 and Server 1000

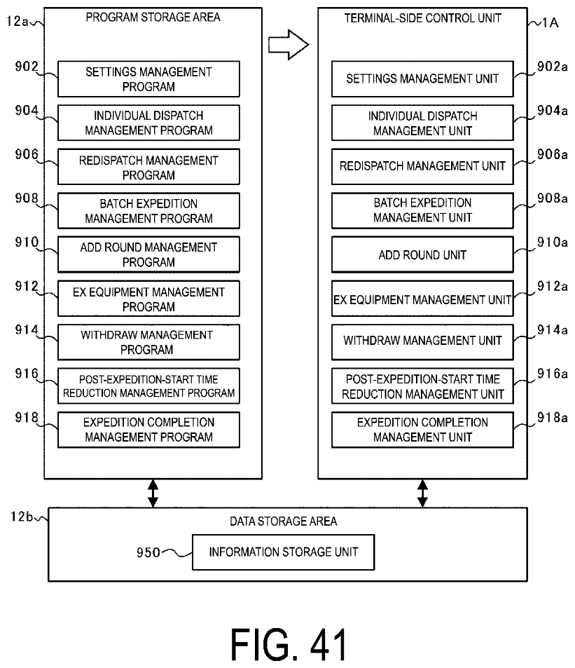

FIG. 41 is a diagram for describing a configuration of the memory 12 in the player terminal 1 and a function thereof as a computer. The program storage area 12a stores a settings management program 902, an individual dispatch management program 904, a redispatch management program 906, a batch expedition management program 908, an add round management program 910, an EX equipment management program 912, a withdraw management program 914, a post-expedition-start time reduction management program 916, and an expedition completion management program 918. The above-described program stored in the program storage area 12a is merely an example, and many other programs are also provided in the program storage area 12a.

The data storage area 12b is provided with an information storage unit 950 for storing various types of information for the expedition game. The above-described storage unit provided in the data storage area 12b is merely an example, and many other storage units may be provided in the data storage area 12b.

The CPU 10 runs each program stored in the program storage area 12a and updates the data in each storage unit of the data storage area 12b. The CPU 10 causes the player terminal 1 (computer) to function as a terminal-side control unit 1A by operating each program stored in the program storage area 12a. The terminal-side control unit 1A includes a settings management unit 902a, an individual dispatch management unit 904a, a redispatch management unit 906a, a batch expedition management unit 908a, an add round management unit 910a, an EX equipment management unit 912a, a withdraw management unit 914a, a post-expedition-start time reduction management unit 916a, and an expedition completion management unit 918a.

Specifically, the CPU 10 operates the settings management program 902 to cause the computer to function as the settings management unit 902a. In the settings management unit 902a, processing of setting various settings is executed based on a player operation. Specifically, the following processing is executed.

In a case where an operation has been performed on the setting operation portion 123 of the notification setting screen 120 (FIG. 8B) by a player, the settings management unit 902a executes processing of storing the execution trigger of the expedition completion notification set by the player in the information storage unit 950 as setting information.

Also, in a case where an operation has been performed on the setting operation portion 135 of the priority setting screen 130 (FIG. 9A) by a player, the settings management unit 902a executes processing of storing the content of the priority settings set by the player in the information storage unit 950 as setting information.

Also, the settings management unit 902a, in a case where an operation has been performed on the setting operation portion 163 of the automatic formation setting screen 160 (FIG. 12A) by a player, executes, as the automatic formation function, processing of storing the setting information indicating whether the first automatic formation function or the second automatic formation function is set in the information storage unit 950.

Also, in a case where an operation has been performed on the OK operation portion 492 of the auto-enhance settings screen 490 (FIG. 35) by a player, the settings management unit 902a executes processing of storing the content of the auto-enhance settings set by the player in the information storage unit 950 as setting information.

Also, in a case where an operation has been performed on the OK operation portion 532 of the auto-disassemble settings screen 530 (FIG. 39) by a player, the settings management unit 902a executes processing of storing the content of the auto-disassemble settings set by the player in the information storage unit 950 as setting information.

Also, in a case where an operation has been performed on the OK operation portion 582 of the automatic disassembly settings screen 580 (FIG. 40) by a player, the settings management unit 902a executes processing of storing the content of the automatic disassembly setting set by the player in the information storage unit 950 as setting information.

Also, the CPU 10 operates the individual dispatch management program 904 to cause the computer to function as the individual dispatch management unit 904a. In the individual dispatch management unit 904a, processing is executed in which the player selects a desired dispatch destination on the dispatch destination selection screen 100 (FIG. 7B), dispatches a party to the dispatch destination, and starts execution of an expedition game (allows execution of an expedition game). Specifically, the following processing is executed.

In a case where the automatic formation operation portion 174 has been operated (tapped) on the formation screen 170 (FIG. 13A), the individual dispatch management unit 904a executes processing of confirming the setting information relating to the automatic formation function stored in the information storage unit 950.

Further, the individual dispatch management unit 904a executes processing of automatically forming a party by using the automatic formation function (the first automatic formation function or the second automatic formation function) of the type set by the player based on the setting information relating to the confirmed automatic formation function.

Specifically, when the first automatic formation function is used, first, the individual dispatch management unit 904a executes processing of forming a party prioritizing three ally characters with high priority and excluding unavailable characters.

In a case where the total power of the three ally characters is equal to or greater the required power, the individual dispatch management unit 904a executes processing of ending party formation.

On the other hand, in a case where the total power of the three ally characters is less than the required power, the individual dispatch management unit 904a executes processing of further putting an ally character not set as a priority target into the party.

Specifically, the individual dispatch management unit 904a executes processing of, from among the ally characters that are not set as priority targets and that are available, putting the ally characters having a high power into the party in order until the power of the party satisfies the required power.

Also, when the second automatic formation function is used, the individual dispatch management unit 904a executes processing of forming a party prioritizing three ally characters with high priority and excluding unavailable characters.

Further, the individual dispatch management unit 904a executes processing of, from among the ally characters that are not set as priority targets and that are available, putting ally characters having a high power into the party until the maximum number of characters that can fit in the party is reached.

In addition, in a case where an ally character has not been set as a priority target, when the first automatic formation function is used, the individual dispatch management unit 904a executes processing of sequentially putting the ally characters having the higher power from among the available ally characters into the party until the power of the party satisfies the required power.

In addition, in a case where an ally character has not been set as a priority target, when the second automatic formation function is used, the individual dispatch management unit 904a executes processing of putting ally characters, from among the available ally characters, into the party until the maximum number of characters that can be put into the party is reached.

In addition, the individual dispatch management unit 904a executes processing of deriving the power of the formed party according to the party formation manually formed by the player or the party formation automatically formed using the automatic formation function.

Further, the individual dispatch management unit 904a executes processing of deriving the reduced required time based on the derived power of the party. Here, the higher the power of the formed party, the larger the value of the reduction in the required time.

In addition, in a case where the increase number of repeated dispatches operation portion 175a or the decrease number of repeated dispatches operation portion 175b of the formation screen 170 is operated (tapped), the individual dispatch management unit 904a executes processing of deriving the required time based on the number of dispatches displayed in the number of repeated dispatches display portion 175. Here, for example, in the case where the required time required for one dispatch is 1 hour and 30 minutes and the number of dispatches is set to 4, the individual dispatch management unit 904a derives a required time of 6 hours.

In addition, in a case where the time reduction operation portion 176 of the time reduction screen 180 is operated (tapped), the individual dispatch management unit 904a executes processing of deriving the required time based on the reduction number displayed in the reduction number display portion 181 or the reduction number display portion 182. Here, for example, in a case where the required time is 6 hours and the total of the reduction times displayed in the reduction number display portion 181 or the reduction number display portion 182 is 4, the individual dispatch management unit 904a reduces the required time by 4 hours and derives a required time of 2 hours.

In a case where the setting operation portion 184 of the time reduction screen 180 is operated (tapped), the individual dispatch management unit 904a executes processing of storing the content displayed on the time reduction screen 180 in the information storage unit 950 as time reduction information relating to the time reduction function. For example, the time reduction information includes the number of spent time reduction tickets and the number of times the predetermined number of jewels have been spent.

In a case where the dispatch operation portion 177 of the formation screen 170 is operated (tapped), the individual dispatch management unit 904a executes processing of checking whether the time reduction function is used, that is, whether time reduction information relating to the time reduction function has been stored. The dispatch operation portion 177 of the formation screen 170 can be operated when the power of the party exceeds the required power. That is, when the power of the party exceeds the required power and the start of the execution of the expedition game is allowed, the dispatch operation portion 177 becomes operable.

In a case where the time reduction function is used, the individual dispatch management unit 904a executes processing of displaying the confirmation screen 190 on the display 26.

Further, in a case where the time reduction function is not used, the individual dispatch management unit 904a executes processing of transmitting the expedition start information to the server 1000. In a case where the OK operation portion 191 of the confirmation screen 190 is operated (tapped), the individual dispatch management unit 904a executes processing of transmitting the expedition start information to the server 1000.

The expedition start information includes, for example, dispatch destination information relating to dispatch destinations, repetition number information relating to the number of repetitions, party formation information relating to the type of ally characters in the party, whether the time reduction function has been used, time reduction information when the use of the time reduction function is set, and the like.

In addition, when the expedition start information is transmitted to the server 1000, the individual dispatch management unit 904a executes processing of displaying the expedition start animation screen 200 (FIG. 16B) on the display 26 for a predetermined amount of time. In a case where use of the time reduction function is set, the individual dispatch management unit 904a executes processing of displaying the time reduction animation screen 210 (FIG. 16C) on the display 26 for a predetermined amount of time after the display of the expedition start animation screen 200 is ended. Thereafter, the individual dispatch management unit 904a executes processing of displaying the dispatch destination selection screen 100 (FIG. 17A) on the display 26.

Also, the CPU 10 operates the redispatch management program 906 to cause the computer to function as the redispatch management unit 906a. In the redispatch management unit 906a, processing is executed of redispatching a party of the same formation to the same dispatch destination for the completed (cleared) expedition game on the redispatch screen 260 (FIG. 21) or the redispatch screen 280 (FIG. 23). Specifically, the following processing is executed.

In a case where the increase number of repeated dispatches operation portion 264a or the decrease number of repeated dispatches operation portion 264b of the redispatch screen 260 or the increase number of repeated dispatches operation portion 284a or the decrease number of repeated dispatches operation portion 284b of the redispatch screen 280 has been operated (tapped), the redispatch management unit 906a executes processing of deriving the required time based on the number of dispatches displayed in the number of repeated dispatches display portion 264 of the redispatch screen 260 or the number of repeated dispatches display portion 284 of the redispatch screen 280.

In addition, the redispatch management unit 906a executes processing of transmitting the expedition start information to the server 1000 in a case where the dispatch operation portion 266 of the redispatch screen 260 or the dispatch operation portion 286 of the redispatch screen 280 is tapped.

In addition, when the expedition start information is transmitted to the server 1000, the redispatch management unit 906a executes processing of displaying the expedition start animation screen 200 (FIG. 16B) on the display 26 for a predetermined amount of time.

Also, the CPU 10 operates the batch expeditions management program 908 to cause the computer to function as the batch expedition management unit 908a. In the batch expedition management unit 908a, processing for using the batch expedition function is executed. Specifically, the following processing is executed.

In a case where the automatic formation operation portion 293 of the batch expedition screen 290 has been operated (tapped), the batch expedition management unit 908a executes processing of checking the setting information relating to the automatic formation function stored in the information storage unit 950.

Further, the batch expedition management unit 908a executes processing of automatically forming a party by using the automatic formation function (the first automatic formation function or the second automatic formation function) of the type set by the player based on the setting information relating to the confirmed automatic formation function.

In a case where the batch expedition operation portion 307 of the batch expedition screen 290 is operated (tapped), the batch expedition management unit 908a executes processing of transmitting the expedition start information to the server 1000. The expedition start information includes, for example, dispatch destination information relating to each dispatch destination, repetition number information relating to the number of repetitions for each dispatch destination, party formation information relating to the type of ally characters in the party for each dispatch destination, whether the time reduction function has been used relating to each dispatch destination, time reduction information when the use of the time reduction function is set for each dispatch destination, and the like.

In addition, when the expedition start information is transmitted to the server 1000, the batch expedition management unit 908a executes processing of displaying the expedition start animation screen 200 (FIG. 16B) on the display 26 for a predetermined amount of time. In a case where use of the time reduction function is set, the batch expedition management unit 908a executes processing of, after the display of the expedition start animation screen 200 is ended, displaying the time reduction animation screen 210 (FIG. 16C) on the display 26 for a predetermined amount of time. Thereafter, the batch expedition management unit 908a executes processing of displaying the expedition top screen 90 (FIG. 7A) on the display 26.

Also, the CPU 10 operates the add round management program 910 to cause the computer to function as the add round management unit 910a. In the add round management unit 910a, processing for using the add dispatch function is executed. Specifically, the following processing is executed.

When the add round operation portion 327 of the in-expedition party list screen 320 (FIG. 26) is operated by the player, the add round management unit 910a executes processing of transmitting the expedition start information to the server 1000. The expedition start information includes, for example, dispatch destination information relating to dispatch destinations, additional times information relating to the number of dispatches to add, party formation information relating to the type of ally characters in the party, whether the time reduction function is used, time reduction information when the use of the time reduction function is set, and the like.

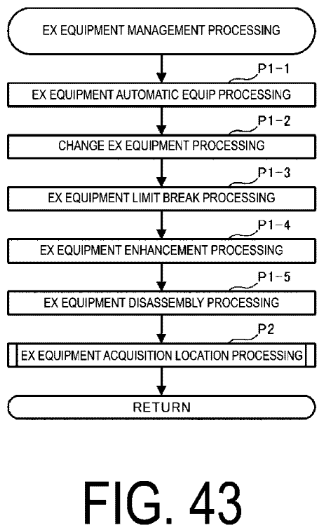

Also, the CPU 10 operates the EX equipment management program 912 to cause the computer to function as the EX equipment management unit 912a. The EX equipment management unit 912a executes EX equipment management processing of managing the various functions relating to EX equipment. FIG. 43 is a flowchart for describing the EX equipment management processing in the player terminal 1. Note that the order of the processing executed in the EX equipment management unit 912a described below may be in no particular order or may be replaced with the order described below. Alternatively, some of the items of processing executed in the EX equipment management unit 912a described below need not be executed.

As illustrated in FIG. 43, the EX equipment management unit 912a executes EX equipment automatic equip processing (P1-1). In the EX equipment automatic equip processing, the following processing is executed. When the OK operation portion 354 of the auto-equip EX equipment settings screen 350 (FIG. 29A) is operated by the player, the EX equipment management unit 912a executes processing of extracting EX equipment to equip the ally character with based on the content displayed on the auto-equip EX equipment settings screen 350 immediately before the operation. Specifically, the EX equipment management unit 912a references the player information (EX equipment identification information) stored in the information storage unit 950 and confirms the EX equipment possessed by the player and the various parameters set for each EX equipment. In addition, the EX equipment management unit 912a confirms the type of EX equipment that can be equipped to the ally character targeted for auto-equip. Then, the EX equipment management unit 912a extracts the EX equipment to equip the ally character with based on these pieces of confirmed information and the priority stats set by the player. Then, the EX equipment management unit 912a executes processing of displaying the auto-equip EX equipment confirmation screen 370 (FIG. 30A) on the display 26 based on the extraction result.

Further, when the OK operation portion 374 of the auto-equip EX equipment confirmation screen 370 is operated by the player, the EX equipment management unit 912a executes processing of equipping the EX equipment to the ally character based on the content displayed on the auto-equip EX equipment confirmation screen 370 immediately before the operation. Specifically, the player information stored in the information storage unit 950 is updated. The player information includes ally character identification information indicating the type of ally character and EX equipment identification information indicating the type of EX equipment equipped to the ally character.

Returning to FIG. 43, the EX equipment management unit 912a executes change EX equipment processing (P1-2). In the change EX equipment processing, the following processing is executed. In a case where the equip operation portion 397 of the change EX equipment screen 390 (FIG. 31A) is operated by the player, the EX equipment management unit 912a executes processing of equipping the EX equipment to the ally character based on the content that was displayed on the change EX equipment screen 390 immediately before the operation of the equip operation portion 397. Specifically, the player information stored in the information storage unit 950 is updated. Note that on the change EX equipment screen 390, in a case where the EX equipment equipped to another ally character is provisionally selected as EX equipment to be equipped, the EX equipment management unit 912a executes processing of displaying the switch EX confirmation screen 410 (FIG. 31C) on the display 26.

Also, in a case where the OK operation portion 412 of the switch EX confirmation screen 410 is operated by the player, the EX equipment management unit 912a executes processing of equipping the EX equipment to the ally character based on the content that was displayed on the change EX equipment screen 390 immediately before the operation of the equip operation portion 397. Specifically, the player information stored in the information storage unit 950 is updated.

Returning to FIG. 43, the EX equipment management unit 912a executes EX equipment limit break processing (P1-3). In the EX equipment limit break processing, the following processing is executed. When the limit break operation portion 424 of the EX equipment limit break screen 420 (FIG. 32A) is operated by the player, the EX equipment management unit 912a executes processing of deriving whether there is a return item. In a case where there is a return item, the EX equipment management unit 912a executes processing of deriving the difference between the points required for limit break and the points to be consumed and the content of the return item, in other words, the type and number of EX equipment to return based on the EX equipment provisionally selected on the EX equipment limit break screen 420.

Then, the EX equipment management unit 912a executes processing of displaying the EX equipment limit break confirmation screen 440 (FIG. 33A) on the display 26 based on the derived result described above.

In a case where the OK operation portion 441 of the EX equipment limit break confirmation screen 440 is operated by the player, the EX equipment management unit 912a executes processing of consuming a predetermined amount of in-game currency (mana) and the EX equipment provisionally selected on the EX equipment limit break screen 420 to execute limit breaking. Further, in a case where there is a return item, the EX equipment management unit 912a executes processing of granting the return item to the player. Specifically, the EX equipment identification information included in the player information stored in the information storage unit 950 and the in-game currency information are updated.

Returning to FIG. 43, the EX equipment management unit 912a executes EX equipment enhancement processing (P1-4). In the EX equipment enhancement processing, the following processing is executed. When the enhance operation portion 462 of the enhance EX equipment screen 460 (FIG. 34A) is operated by the player, the EX equipment management unit 912a executes processing of deriving whether there is a return item. In a case where there is a return item, the EX equipment management unit 912a executes processing of deriving the difference between the points required for enhancement and the points to be consumed and the content of the return item, in other words, the enhancement points and various coins to return based on the EX equipment provisionally selected on the enhance EX equipment screen 460.

When the auto-enhance operation portion 464 of the enhance EX equipment screen 460 is tapped by the player, the EX equipment management unit 912a executes processing of determining the number of enhancement points to consume and the content of the EX equipment to consume based on the setting information relating to the auto-enhance settings stored in the information storage unit 950. Specifically, the EX equipment management unit 912a references the player information (EX equipment identification information and in-game currency information) stored in the information storage unit 950 and confirms the EX equipment possessed by the player, the various parameters set for each EX equipment, and the amount of in-game currency possessed by the player. Then, the EX equipment management unit 912a determines the number of enhancement points to consume and the content of the EX equipment to consume based on the pieces of confirmed information and the content of the auto-enhance settings set by the player. Further, in a case where there is a return item, the EX equipment management unit 912a executes processing of deriving the content of the return item, that is, the number of enhancement points and various coins to return.

Then, the EX equipment management unit 912a executes processing of displaying the enhance EX equipment confirmation screen 480 (FIG. 34C) on the display 26 based on the derived result described above.

In a case where the OK operation portion 482 of the enhance EX equipment confirmation screen 480 is operated by the player, the EX equipment management unit 912a executes processing of consuming a predetermined amount of in-game currency (mana) and EX equipment and enhancement points provisionally selected on the enhance EX equipment screen 460 to perform enhancement. Further, in a case where there is a return item, the EX equipment management unit 912a executes processing of granting the return item to the player. Specifically, the EX equipment identification information included in the player information stored in the information storage unit 950 and the in-game currency information are updated.

Returning to FIG. 43, the EX equipment management unit 912a executes EX equipment disassembly processing (P1-5). In the EX equipment disassembly processing, the following processing is executed. When the disassemble operation portion 504a of the item list screen 500 (FIG. 36A) is operated, the EX equipment management unit 912a executes processing of deriving the number of return items (enhancement points and various coins) to return to the player based on the EX equipment corresponding to the selected icon 502a.

When the auto-disassemble operation portion 505b of the item list screen 500a is operated by the player, the EX equipment management unit 912a executes processing of automatically selecting EX equipment to be targeted for EX equipment disassembly based on the setting information relating to the auto-disassemble settings stored in the information storage unit 950. Specifically, the EX equipment management unit 912a references the player information (EX equipment identification information) stored in the information storage unit 950 and confirms the EX equipment possessed by the player and the various parameters set for each EX equipment. Then, the EX equipment management unit 912a determines the EX equipment to be targeted for EX equipment disassembly based on each piece of confirmed information and the content of the auto-disassemble settings set by the player.

When the batch disassemble operation portion 505a of the item list screen 500a (FIG. 36B) is operated, the EX equipment management unit 912a executes processing of deriving the number of return items (enhancement points and various coins) to return to the player based on the EX equipment corresponding to the selected icon 502a.

Then, the EX equipment management unit 912a executes processing of displaying the disassemble confirmation screen 510 (FIG. 37A) on the display 26 based on the derived result described above.

When the OK operation portion 511 of the disassemble confirmation screen 510 is operated by the player, the EX equipment management unit 912a executes processing of disassembling the EX equipment. Further, the EX equipment management unit 912a executes processing of granting the return item to the player. Specifically, the EX equipment identification information included in the player information stored in the information storage unit 950 and the in-game currency information are updated.

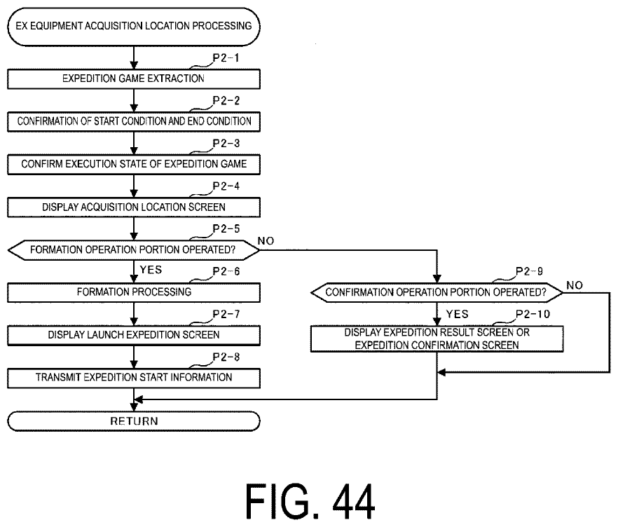

Returning to FIG. 43, the EX equipment management unit 912a executes EX equipment acquisition location processing (P2). FIG. 44 is a flowchart for describing the EX equipment acquisition location processing (P2) in the player terminal. In the EX equipment acquisition location processing, the following processing is executed.

When the acquisition location operation portion 345a of the ally character details screen 340 (FIG. 27A) is operated by the player, the EX equipment management unit 912a executes processing of deriving an expedition game of a type in which the EX equipment displayed on the detailed display portion 342 can be obtained (P2-1). Specifically, the EX equipment management unit 912a references the player information (expedition game setting information) stored in the information storage unit 950 and confirms the information of the EX equipment set as obtainable in each expedition game. Then, the EX equipment management unit 912a extracts an expedition game of the type in which the EX equipment displayed on the detailed display portion 342 can be obtained based on each piece of confirmed information and the EX equipment displayed in the detailed display portion 342.

In addition, the EX equipment management unit 912a executes processing of obtaining the required start condition for starting execution and the required end condition for ending the execution for each extracted type of expedition game (P2-2). Specifically, the EX equipment management unit 912a references the player information (expedition game setting information) stored in the information storage unit 950 and obtains play conditions including the required power, maximum number of characters, and required time.

In addition, the EX equipment management unit 912a executes processing of confirming the execution status based on each extracted type of expedition game (P2-3). Specifically, the EX equipment management unit 912a obtains the expedition game information including the expedition game execution status from the server, references the obtained expedition game information, and confirms the progress status of each expedition game.

Also, the EX equipment management unit 912a executes processing of displaying the acquisition location screen 540 on the display 26 based on each piece of information obtained as described above (P2-4).

In a case where the formation operation portion 541 of the acquisition location screen 540 is operated by the player (YES in P2-5), the EX equipment management unit 912a executes processing of displaying the formation screen 170 (FIG. 13A) described above on the display 26 and forming a party to dispatch to the dispatch destination (P2-6). That is, in a case where the formation operation portion 541 is operated, the EX equipment management unit 912a displays the formation screen 170 (FIG. 13A) on the display 26 without displaying the dispatch destination selection screen 100 (FIG. 7B). Thus, it is possible to improve player-friendliness.

Also, in a case where the formation screen 170 (FIG. 13A) is displayed via an operation of the formation operation portion 541 of the acquisition location screen 540, when the dispatch operation portion 177 is operated by the player, the EX equipment management unit 912a executes processing of displaying the launch expedition screen 550 (FIG. 39B) on the display 26 without displaying the expedition start animation screen 200 (FIG. 16B) (P2-7). As described above, the dispatch operation portion 177 of the formation screen 170 can be operated when the power of the party exceeds the required power. That is, when the power of the party exceeds the required power and the start of the execution of the expedition game is allowed, the dispatch operation portion 177 becomes operable.

Further, the EX equipment management unit 912a executes processing of transmitting the expedition start information to the server 1000 (P2-8). The expedition start information includes, for example, dispatch destination information relating to dispatch destinations, additional times information relating to the number of dispatches to add, party formation information relating to the type of ally characters in the party, whether the time reduction function is used, time reduction information when the use of the time reduction function is set, and the like.

In a case where the confirm operation portion 542 of the acquisition location screen 540 is operated (NO in P2-5, YES in P2-9), the EX equipment management unit 912a executes processing of obtaining the expedition game information including the expedition game execution status from the server and display the expedition results screen 560 (FIG. 39C) or the expedition confirmation screen 570 (FIG. 39D) on the display 26 based on the obtained expedition game information (P2-10). Specifically, in a case where the expedition game is complete, the EX equipment management unit 912a executes processing of displaying the expedition results screen 560 on the display 26 and displaying the expedition confirmation screen 570 on the display 26 if the expedition game is in progress.

Also, the CPU 10 operates the withdraw management program 914 to cause the computer to function as the withdraw management unit 914a. In the withdraw management unit 914a, processing for using the withdraw function is executed. Specifically, the following processing is executed.

In a case where the OK operation portion 232 of the withdraw confirmation screen 230 is operated (tapped), the withdraw management unit 914a executes processing of transmitting the withdraw information to the server 1000. The withdraw information includes, for example, dispatch destination information relating to the dispatch destination to be withdrawn from.

When the withdraw information is transmitted to the server 1000, the withdraw management unit 914a executes processing of displaying the expedition withdraw screen 240 on the display 26.

Also, the CPU 10 operates the post-expedition-start time reduction management program 916 to cause the computer to function as the post-expedition-start time reduction management unit 916a. In the post-expedition-start time reduction management unit 916a, processing is executed for using the time reduction function after the start of execution of the expedition game. Specifically, the following processing is executed.

In a case where the increase reduction number operation portion 181a, the decrease reduction number operation portion 181b, the increase reduction number operation portion 182a, or the decrease reduction number operation portion 182b of the time reduction screen 180 (FIG. 17B) is operated (tapped), the post-expedition-start time reduction management unit 916a executes processing of deriving the required time based on the reduction number displayed in the reduction number display portion 181 or the reduction number display portion 182.

In a case where the reduction operation portion 221 of the confirmation screen 220 (FIG. 18A) is operated (tapped), the post-expedition-start time reduction management unit 916a executes processing of transmitting the post-expedition-start time reduction information to the server 1000. For example, the post-expedition-start time reduction information includes, for example, the dispatch destination information relating to the dispatch destination, the time reduction information including the number of spent time reduction tickets and the number of times the predetermined number of jewels have been spent, and the like.

Also, the CPU 10 operates the expedition completion management program 918 to cause the computer to function as the expedition completion management unit 918a. In the expedition completion management unit 918a, processing is executed of obtaining the reward for the completed (cleared) expedition game after the required time has elapsed. Specifically, the following processing is executed.

In a case where the expedition completion information set in the server 1000 has been newly obtained, the expedition completion management unit 918a executes processing of storing the obtained expedition completion information in the information storage unit 950.

In addition, the expedition completion management unit 918a executes processing of confirming the setting information relating to the execution trigger of the expedition completion notification stored in the information storage unit 950.

In addition, in a case where it is determined that it is the notification timing based on the setting information relating to the confirmed expedition completion notification execution trigger, the expedition completion management unit 918a executes processing of displaying the message M (FIG. 9A) on the upper portion of the display 26 as the expedition completion notification.

In addition, in a case where the result confirmation operation portion 107 of the dispatch destination selection screen 100 (FIG. 20A) is operated (tapped), the expedition completion management unit 918a executes processing of transmitting the reward request information to the server 1000. In a case where the result confirmation operation portion 107 has been operated, the reward request information includes dispatch destination information relating to a dispatch destination corresponding to the result confirmation operation portion 107, formation information set for the dispatch destination, and the like.

In addition, in a case where the expedition collective completion operation portion 95 of the expedition top screen 90 (FIG. 22A) is operated (tapped), the expedition completion management unit 918a executes processing of transmitting the reward request information to the server 1000. Note that, in a case where the expedition collective completion operation portion 95 has been operated, the reward request information includes dispatch destination information regarding each dispatch destination for which reception of a reward is not completed, formation information set for each dispatch destination, and the like.

In a case where the reward determination information set in the server 1000 has been newly obtained, the expedition completion management unit 918a executes processing of storing the obtained reward determination information in the information storage unit 950 and obtaining the reward.

In addition, the expedition completion management unit 918a executes processing of determining EX equipment to be disassembled from among EX equipment included in the obtained reward based on the setting information relating to the automatic disassembly settings stored in the information storage unit 950. The expedition completion management unit 918a executes processing of executing disassembly of the EX equipment determined to be disassembled. Specifically, the EX equipment identification information included in the player information stored in the information storage unit 950 and the in-game currency information are updated.

In addition, the expedition completion management unit 918a executes processing of displaying a list of the obtained rewards and the return items obtained as a result of disassembly as described above on the expedition completion screen 250 or the expedition collective completion screen 270.

In a case where the redispatch operation portion 252 of the expedition completion screen 250 or the redispatch operation portion 272 of the expedition collective completion screen 270 has been operated (tapped), the expedition completion management unit 918a executes processing of displaying the redispatch screen 260 (FIG. 21) or the redispatch screen 280 (FIG. 23) on the display 26 based on the dispatch destination information included in the expedition completion information.

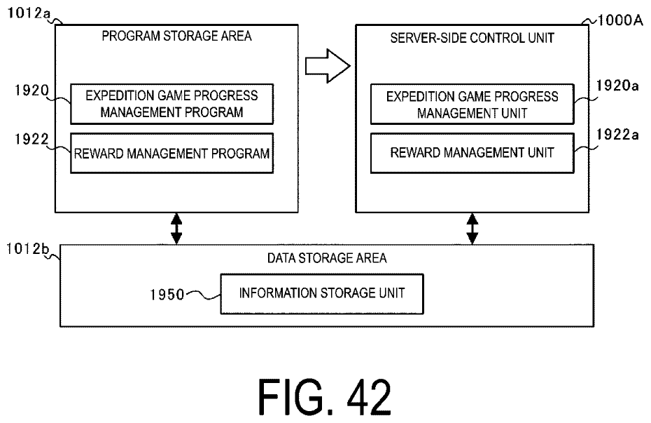

FIG. 42 is a diagram for describing a configuration of the memory 1012 in the server 1000 and a function thereof as a computer. In the program storage area 1012a, an expedition game progress management program 1920 and a reward management program 1922 are stored. The above-described program stored in the program storage area 1012a is merely an example, and many other programs are also provided in the program storage area 1012a.

A data storage area 1012b is provided with an information storage unit 1550 for storing various types of information for the expedition game. The above-described storage unit provided in the data storage area 1012b is merely an example, and many other storage units may be provided in the data storage area 1012b.

The CPU 1010 runs each program stored in the program storage area 1012a and updates the data in each storage unit of the data storage area 1012b. The CPU 1010 causes the server 1000 (computer) to function as a server-side control unit 1000A by operating each program stored in the program storage area 1012a. The server-side control unit 1000A includes an expedition game progress management unit 1920a and a reward management unit 1922a.

Specifically, the CPU 1010 operates the expedition game progress management program 1920 to cause the computer to function as the expedition game progress management unit 1920a. In the expedition game progress management unit 1920a, processing is executed for managing expedition game progress. Specifically, the following processing is executed.

In addition, when the expedition start information is received from the player terminal 1, the expedition game progress management unit 1920a executes processing of deriving the required time corresponding to the dispatch destination for each dispatch destination designated by the received expedition start information and reset to expedition timer.

That is, the expedition game progress management unit 1920a derives the required time corresponding to the dispatch destination based on the power of the party set for the dispatch destination and the required power set for the dispatch destination.

In a case where a plurality of dispatch destinations are designated by the expedition start information, the expedition game progress management unit 1920a executes processing of setting an expedition timer for each of the designated plurality of dispatch destinations.

In addition, in a case where a plurality of repetition numbers are designated for the dispatch destination by the repetition number information included in the expedition start information, the expedition game progress management unit 1920a executes processing of storing the repetition number information in the information storage unit 1550 of the server 1000 in association with the dispatch destination.

Note that the expedition game progress management unit 1920a subtracts the repetition number set in the repetition number information every time the expedition game relating to the dispatch destination ends.

In a case where the use of the time reduction function is designated for the dispatch destination for which progress of the expedition game has started, the expedition game progress management unit 1920a executes processing of reducing the timer value of the expedition timer corresponding to the dispatch destination based on the time reduction information included in the expedition start information. In a case where a time reduction ticket is used, the expedition game progress management unit 1920a executes processing of spending the number of time reduction tickets to be used.

In a case where the post-expedition-start time reduction information is received from the player terminal 1, the expedition game progress management unit 1920a executes processing of reducing the timer value of the expedition timer corresponding to the dispatch destination designated based on the dispatch destination information included in the received post-expedition-start time reduction information based on the time reduction information included in the post-expedition-start time reduction information.

In addition, in a case where there is an expedition timer for which the timer value has reached zero, in other words, in a case where there is an expedition game that has satisfied a preset predetermined end condition, the expedition game progress management unit 1920a executes processing of setting the expedition completion information corresponding to the expedition game with the satisfied end condition to be obtainable by the player terminal 1.

The expedition completion information includes dispatch destination information relating to the dispatch destination of the expedition game completed (cleared) when the end condition is satisfied, final expedition information indicating whether the expedition game is the final expedition game of the designated number of repetitions in a case where a plurality of repetition numbers are designated for the dispatch destination, party formation information relating to the type of ally character in the party dispatched to the dispatch destination, and the like.

Also, in a case where the repetition number information for the dispatch destination with the satisfied end condition is stored, the expedition game progress management unit 1920a executes processing of starting the progress of the expedition game for the dispatch destination. Also, the expedition game progress management unit 1920a executes processing of subtracting the repetition number set in the repetition number information in conjunction with the start of the progress of the expedition game relating to the dispatch destination.

In a case where the withdraw information is received from the player terminal 1, the expedition game progress management unit 1920a executes processing of discarding the expedition timer corresponding to the dispatch destination designated by the dispatch destination information included in the withdraw information. Accordingly, the expedition game being executed is canceled.

Also, the CPU 1010 operates the reward management program 1922 to cause the computer to function as the reward management unit 1922a. In the reward management unit 1922a, processing is executed for determining the content of the reward to be given to the player for completing (clearing) the expedition game. Specifically, the following processing is executed.

When the reward request information is received from the player terminal 1, the reward management unit 1922a executes processing of confirming the formation information included in the received reward request information.

The reward management unit 1922a executes processing of confirming the ally character set as the special item drop target based on the confirmed formation information.

The reward management unit 1922a executes processing of determining through a lottery whether to give a special item corresponding to each of the ally characters set as the special item drop target confirmed as described above based on a predetermined lottery table set in advance.

The reward management unit 1922a determines through a lottery whether to give EX equipment based on a predetermined lottery table set in advance.

The reward management unit 1922a executes processing of determining through a lottery whether to give special items and normal items other than EX equipment based on a predetermined lottery table set in advance.

The reward management unit 1922a executes processing of setting the reward request information including at least the execution result of all lottery processing to be obtainable by the player terminal 1 when all lottery processing is completed for all of the dispatch destinations (processing targets) designated by the dispatch destination information including the received reward request information.

Here, one aspect of an embodiment has been described with reference to the accompanying drawings. However, it goes without saying that the present invention is not limited to the above-described embodiment. It should be apparent that one skilled in the art can arrive at various modifications and corrections within the scope described in the claims, and it should be understood that the modifications and corrections also naturally belong in the technical scope of the present invention.

The game properties and the processing in the player terminal 1 and the server 1000 described in the above embodiment are merely examples. In any case, the information processing program causes a computer (in the embodiment, the player terminal 1 and/or the server 1000) to execute the following processing.

### Processing Executed by Computer

Processing (in this embodiment, for example, the processing executed by the expedition game progress management unit 1920a) of executing a piece of specific content with a satisfied start condition (in this embodiment, for example, required power) from among a plurality of the pieces of specific content (in this embodiment, for example, expedition games) with an elapsed time set as an end condition for clearing a game without requiring an operation by a player for game progress and activation of the game.

Processing (in this embodiment, for example, the processing executed by the reward management unit 1922a) of granting the player a reward predetermined for each of the pieces of specific content based on satisfying the end condition of the piece of specific content (in this embodiment, for example, passing of the required time).

Processing (in this embodiment, for example, P2) of displaying a specific screen (in this embodiment, for example, the acquisition location screen 540) that enables identification of a type of the piece of specific content in which a predetermined reward (in this embodiment, for example, EX equipment) can be obtained by the player as the reward and that enables identification of at least one of the start condition or the end condition set for the type of the piece of specific content.

Processing (in this embodiment, for example, the processing executed by the individual dispatch management unit 904a) of allowing a start of execution of the piece of specific content based on an operation of a first operation portion by the player on a start screen (in this embodiment, for example, the dispatch destination selection screen 100 (FIG. 7B) displaying the first operation portion (in this embodiment, for example, the first dispatch destination selection operation portion 101a to the fourth dispatch destination selection operation portion 101d (FIG. 7B)) for starting execution of the piece of specific content.

Processing (in this embodiment, for example, P2) of displaying a second operation portion (in this embodiment, for example, the formation operation portion 541 of the acquisition location screen 540) for starting execution of the piece of specific content on the specific screen (in this embodiment, for example, the acquisition location screen 540).

Processing (in this embodiment, for example, P2) of allowing a start of execution of the piece of specific content without displaying the start screen based on an operation of the second operation portion by the player.

In the above-described embodiment, the degree of advantage for the player is increased by the required time being reduced as the power of the party dispatched to the dispatch destination increases, but the present invention is not limited thereto. For example, when the power of the party dispatched to the dispatch destination exceeds the required power, the reward obtained by the player may be increased. Also, for example, the reward obtained by the player may be increased in accordance with a degree of the power of the party dispatched to the dispatch destination exceeding the required power. In addition, both a reduction of the required time and an increase of the reward may be implemented in accordance with the power of the party. Alternatively, either a reduction of the required time or an increase of the reward may be implemented in accordance with the power of the party.

Also, an upper limit may be placed on the number of parties that can be dispatched to a dispatch destination at the same time. For example, in a case where the total number of the number of parties corresponding to an expedition game for which reception of a reward has not been completed and the number of parties corresponding to an expedition game that is being executed reaches a preset upper limit number, a new party may be made unable to be dispatched. In this case, by using the withdraw function or completing the reception of the reward, a new party is made able to be dispatched.

In addition, in the embodiment described above, the required time for the expedition game can be reduced by spending time reduction tickets, but the time reduction tickets may be able to be used for the battle game. For example, in the main quest selection screen 74 (FIG. 5B), the player is allowed to set whether to use the time reduction tickets and the number of tickets to be used. In this case, when one time reduction ticket is used, execution of one battle game is omitted (skipped). Specifically, on the main quest selection screen 74 (FIG. 5B), when use of a time reduction ticket is set, the display of the party selection screen 77 (FIG. 5C), the battle game screen 80 (FIG. 6A), and the first result screen 83 (FIG. 6B) may be omitted (reduced), and the second result screen 85 (FIG. 6C) may be displayed on the display 26.

Note that the game application may use, for example, a notification mechanism (for example, Notification API) provided by the operating system (OS) of the smartphone to perform a push notification and display the message M stating “Expedition completed” on a notification screen of the smartphone.

Specifically, similar to setting the execution trigger of the expedition completion notification in the embodiment described above, the execution trigger of the push notification can be set at the discretion of the player. That is, the player can freely set, as the execution trigger of the push notification, either an execution trigger of an expedition completion notification of one expedition game being completed (first execution trigger) regardless of the designated number of dispatches or an execution trigger of an expedition completion notification of all of the expedition games of the designated number of dispatches being completed (second execution trigger).

In the above-described embodiment, the acquisition location operation portion 345a corresponding to an icon on a screen including this screen displaying an EX equipment icon is displayed on the ally character details screen 340 (FIG. 27A). However, the acquisition location operation portion 345a may be displayed on a screen other than the ally character details screen 340. For example, the screen where the acquisition location operation portion 345a is displayed can be, for example, the auto-equip EX equipment confirmation screen 370 (FIG. 30A), the switch EX equipment details screen 380 (FIG. 30B), the change EX equipment screen 390 (FIG. 31A), the switch EX confirmation screen 410 (FIG. 31C), the EX equipment limit break screen 420 (FIG. 32A), the item details screen 430 (FIG. 32C), the EX equipment limit break confirmation screen 440 (FIG. 33A), the enhance equipment item return screen 450 (FIG. 33B), the enhance EX equipment screen 460 (FIG. 34A), the use enhancement points settings screen 470 (FIG. 34B), the enhance EX equipment confirmation screen 480 (FIG. 34C), the item list screen 500 (FIG. 36A), the item list screen 500a (FIG. 36B), or the disassemble confirmation screen 510 (FIG. 37A). The acquisition location operation portion 345a can be displayed so that it corresponds to an icon image indicating the EX equipment displayed in each of these screens. In this case, on the acquisition location screen 540, the type of expedition game in which the EX equipment of the icon image displayed corresponding to the acquisition location operation portion 345a on a screen where the acquisition location operation portion 345a is operated can be obtained is displayed.

In addition, on the item list screen 500 (FIG. 36A), the enhance operation portion 345c, the limit break operation portion 345d, and the change equipment operation portion 345e may be displayed so that enhancing EX equipment, limit breaking, and equipping ally characters can be executed. On the item list screen 500 (FIG. 36A), when the change equipment operation portion 345e is operated by the player, an ally character selection screen (not illustrated) displaying a list of ally characters that the selected EX equipment can be equipped to is displayed as a pop-up on the display 26. Then, when the player selects one of the ally characters on the ally character selection screen (not illustrated) and a predetermined determination operation is performed, the change EX equipment screen 390 (FIG. 31A) is displayed as a pop-up on the display 26.

Further, on the change EX equipment screen 390 (FIG. 31A), the first operation portion 342a (FIG. 27A) and the second operation portion 342b (FIG. 27A) may be displayed. When the first operation portion 342a is operated on the change EX equipment screen 390, the EX equipment (the EX equipment of the first setting frame) which is equipment that is enabled in battle games other than guild battles can be set (changed). Also, when the second operation portion 342b is operated on the change EX equipment screen 390, the EX equipment (the EX equipment of the second setting frame) which is equipment that is enabled in guild battle battle games can be set (changed).

On screens displaying a list of the ally characters such as the ally character confirmation screen 50 (FIG. 3B), the party selection screen 77 (FIG. 5C), the priority setting screen 130 (FIG. 9B and the like), and the formation screen 170 (FIG. 13A and the like), an equipped icon (not illustrated) may be superimposed on an ally character icon. The equipped icon enables identification of whether EX equipment is equipped and of the category (major category or minor category) of the equipped EX equipment when EX equipment is equipped. For example, an equipped icon indicating “weapon”, an equipped icon indicating “armor”, and an equipped icon indicating “accessory” can be superimposed on an icon of an ally character fully equipped with EX equipment for “weapon”, “armor”, and “accessory”.

In addition, an icon enabling identification of a campaign being executed may be displayed on the in-expedition party list screen 320 (FIG. 26A). In addition, in the dispatch destination display portion 321 (FIG. 26A) displaying “expedition in progress” indicating that the expedition game is in progress, a round details operation portion (not illustrated) may be displayed. When the round details operation portion is operated, for example, in a case where the expedition is being executed five times, the scheduled time for the end of each of the first to fifth expedition game is displayed. Further, for each of the first to fifth expedition game, an icon for identifying whether the campaign is applicable may be displayed.

In the embodiment described above, as an example of a game, a case has been described in which an expedition game is provided in which a party of ally characters is dispatched to a dispatch destination desired by a player. However, specific content of the game and the game genre are not limited to the embodiment described above. For example, the present invention can be applied to any game genre such as a role-playing game, a shooting game, a puzzle game, and a rhythm game.

For example, in a case where the game is applied to a role-playing game, the expedition game described above may correspond to a predetermined quest provided in the role-playing game in which a battle game with a predetermined enemy character is executed. In this case, a minimum condition (a minimum power of the party) is provided to accept a predetermined quest, and the degree of advantage for the player in the predetermined quest is increased the more the power of the player's party exceeds the minimum power. Specific methods for increasing the degree of advantage may include the ally characters being powered up, the enemy character being weakened, the reward when the quest is cleared being increased, and the like.

An information processing program for executing the processing in the above-described embodiment and various modifications may be stored in a non-transitory computer-readable storage medium and provided as a storage medium. Furthermore, a game terminal apparatus including the storage medium may be provided. In addition, the above-described embodiment and various modifications may correspond to an information processing method for implementing each function and the steps illustrated in the flowcharts.

What is claimed is:

1. A non-transitory computer readable medium storing a program causing a computer to execute:
processing of executing a piece of specific content with a satisfied start condition from among a plurality of pieces of specific content with a set elapsed time as an end condition for clearing a game without requiring an operation by a player for game progress and activation of the game;
processing of granting the player a reward predetermined for each of the pieces of specific content based on satisfying the end condition of the piece of specific content; and
processing of displaying a specific screen that enables identification of a type of the piece of specific content in which a predetermined reward can be obtained by the player as the reward and that enables identification of at least one of the start condition or the end condition set for the type of the piece of specific content.

2. The non-transitory computer readable medium according to claim 1, wherein the program further causes the computer to execute:
processing of allowing a start of execution of the piece of specific content based on an operation of a first operation portion by the player on a start screen displaying the first operation portion for starting execution of the piece of specific content;
processing of displaying a second operation portion for starting execution of the piece of specific content on the specific screen; and
processing of allowing a start of execution of the piece of specific content without displaying the start screen, based on an operation of the second operation portion by the player.

3. An information processing method executed by one or more computers, the information processing method comprising:
processing, by the one or more computers, of executing a piece of specific content with a satisfied start condition from among a plurality of pieces of specific content with a set elapsed time as an end condition for clearing a game without requiring an operation by a player for game progress and activation of the game;
processing, by the one or more computers, of granting the player a reward predetermined for each of the pieces of specific content based on satisfying the end condition of the piece of specific content; and
processing, by the one or more computers, of displaying a specific screen that enables identification of a type of the piece of specific content in which a predetermined reward can be obtained by the player as the reward and that enables identification of at least one of the start condition or the end condition set for the type of the piece of specific content.

4. A game apparatus comprising one or more computers, the game apparatus executing:
processing, by the one or more computers, of executing a piece of specific content with a satisfied start condition from among a plurality of pieces of specific content with a set elapsed time as an end condition for clearing a game without requiring an operation by a player for game progress and activation of the game;
processing, by the one or more computers, of granting the player a reward predetermined for each of the pieces of specific content based on satisfying the end condition of the piece of specific content; and
processing, by the one or more computers, of displaying a specific screen that enables identification of a type of the piece of specific content in which a predetermined reward can be obtained by the player as the reward and that enables identification of at least one of the start condition or the end condition set for the type of the piece of specific content.
